(19) United States
(12) Patent Application Publication
(10) Pub. No.: US 2026/0049245 A1
(43) Pub. Date: Feb. 19, 2026

(54) LIQUID CRYSTAL COMPOSITION, OPTICALLY ANISOTROPIC LAYER, OPTICAL FILM, POLARIZING PLATE, AND IMAGE DISPLAY DEVICE

(71) Applicant: FUJIFILM Corporation, Tokyo (JP)

(72) Inventors: Ayako MURAMATSU, Minamiashigara-shi (JP); Hiroki KUWAHARA, Minamiashigara-shi (JP); Tomonori MIMURA, Minamiashigara-shi (JP); Yuki HIRAI, Minamiashigara-shi (JP); Mayumi NOJIRI, Minamiashigara-shi (JP); Mika AKINO, Minamiashigara-shi (JP)

(73) Assignee: FUJIFILM Corporation, Tokyo (JP)

(21) Appl. No.: 19/370,840

(22) Filed: Oct. 28, 2025

Related U.S. Application Data
(63) Continuation of application No. PCT/JP2024/018281, filed on May 17, 2024.

(30) Foreign Application Priority Data
May 19, 2023 (JP) 2023-083356
May 14, 2024 (JP) 2024-078698

(51) Int. Cl. C09K 19/38; C09K 19/02; C09K 19/52

(52) U.S. Cl. CPC C09K 19/3833; C09K 19/02; C09K 19/52; C09K 2019/525; C09K 2019/528; C09K 2219/03

(57) ABSTRACT

An object of the present invention is to provide a liquid crystal composition, which can form an optically anisotropic layer in which cissing and wind marks are suppressed in formation of a liquid crystal cured layer having reverse dispersibility, without using a compound having a polyfluoro group; and an optically anisotropic layer, an optical film, a polarizing plate, and an image display device. The optically anisotropic layer of the present invention is an optically anisotropic layer consisting of a liquid crystal cured layer obtained by fixing an alignment state of a liquid crystal composition which contains a reverse dispersion compound (I) represented by Formula (1), at least one liquid crystal compound, and a surfactant (II) having a structure represented by Formula (2) in a molecule, in which the optically anisotropic layer satisfies a relationship of Expression (3).

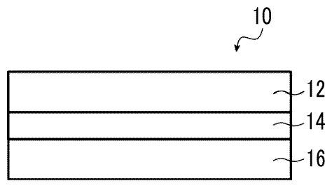

### CROSS-REFERENCE TO RELATED APPLICATIONS

This application is a Continuation of PCT International Application No. PCT/JP2024/018281 filed on May 17, 2024, which claims priority under 35 U.S.C. § 119(a) to Japanese Patent Application No. 2023-083356 filed on May 19, 2023 and Japanese Patent Application No. 2024-078698 filed on May 14, 2024. The above applications are hereby expressly incorporated by reference, in their entirety, into the present application.

### BACKGROUND OF THE INVENTION

### 1. Field of the Invention

The present invention relates to a liquid crystal composition, an optically anisotropic layer, an optical film, a polarizing plate, and an image display device.

### 2. Description of the Related Art

In the related art, a circularly polarizing plate consisting of a λ/4 plate and a linearly polarizing plate has been used in a display device in order to suppress adverse effects caused by external light reflection. Examples of the display device include an organic electroluminescence (EL) display device. As the circularly polarizing plate, an aspect in which an optically anisotropic layer having reverse wavelength dispersibility is used is disclosed in JP2015-200861A.

In order to produce the optically anisotropic layer having reverse wavelength dispersibility, a method using a polymerizable compound exhibiting reverse wavelength dispersibility has features such as being able to accurately convert a ray wavelength over a wide wavelength range and being able to make the optically anisotropic layer into a thin film because of having a high refractive index, and thus is widely used.

A change in thickness of the optically anisotropic layer is accompanied by a change in retardation, and in a case where the circularly polarizing plate is used in the display device, tint of reflected light is changed. Therefore, it is required that these optically anisotropic layers have particularly uniform thickness in a plane.

In order to achieve such a uniform thickness, in a case where a substrate is coated with a liquid crystal composition having reverse dispersibility, it is required that the coating is performed uniformly. It is known that a liquid crystal composition containing a surfactant which contains a polyfluoro group [—(CF₂)ₙ—; n is an integer of 1 or more] is used in order to perform the uniform coating. For example, JP2020-052327A discloses an aspect in which a liquid crystal composition which contains a liquid crystal compound having reverse dispersibility, a polymer surfactant having a repeating unit containing the polyfluoro group, and a solvent is used.

Since a compound having the polyfluoro group has low biodegradability, is accumulated in a living body and an environment, and may adversely affect the human body and the ecosystem for a long time, it is preferable to avoid using the compound. JP2021-152641A discloses an aspect in which a liquid crystal composition which contains a liquid crystal compound having reverse dispersibility, a polyacrylate-based surfactant, and a solvent is used.

### SUMMARY OF THE INVENTION

As a result of studying the liquid crystal composition and the liquid crystal cured layer (optically anisotropic layer) disclosed in JP2021-152641A and the like, the present inventors have found that, depending on a structure of the surfactant contained in the liquid crystal composition, cissing and wind marks occur in formation of the optically anisotropic layer.

Therefore, an object of the present invention is to provide a liquid crystal composition, which can form an optically anisotropic layer in which cissing and wind marks are suppressed in formation of a liquid crystal cured layer having reverse dispersibility, without using a compound having a polyfluoro group; and an optically anisotropic layer, an optical film, a polarizing plate, and an image display device.

As a result of intensive studies in order to achieve the above-described object, the present inventors have found that, by blending a predetermined surfactant in a liquid crystal composition for forming the liquid crystal cured layer having reverse dispersibility, the optically anisotropic layer in which cissing and wind marks are suppressed in the formation of the liquid crystal cured layer having reverse dispersibility can be formed, and thus have completed the present invention.

In other words, it has been found that the above-described object can be achieved by adopting the following configurations.
[1] An optically anisotropic layer consisting of a liquid crystal cured layer obtained by fixing an alignment state of a liquid crystal composition which contains a reverse dispersion compound (I) represented by Formula (1) described later, at least one liquid crystal compound, and a surfactant (II) having a structure represented by Formula (2) described later in a molecule,
in which the optically anisotropic layer satisfies a relationship of Expression (3) described later.
[2] The optically anisotropic layer according to [1], in which the reverse dispersion compound (I) is a liquid crystal compound.
[3] The optically anisotropic layer according to [1] or [2], in which a surface free energy is 35 mN/m or less.
[4] The optically anisotropic layer according to any one of [1] to [3], in which a surface free energy is 24 mN/m or more.
[5] The optically anisotropic layer according to any one of [1] to [4],
in which, in a case where a solution containing 0.08% by mass of the surfactant (II) and containing cyclopentanone and methyl ethyl ketone with a mass ratio of 4:1 is prepared, the surfactant (II) is a surfactant with which a surface tension of the solution is 22 mN/m or more.
[6] The optically anisotropic layer according to [5], in which the surfactant (II) is a surfactant with which the surface tension of the solution is 30 mN/m or less.
[7] The optically anisotropic layer according to [6], in which the surfactant (II) is a surfactant with which the surface tension of the solution is 27 mN/m or less.
[8] The optically anisotropic layer according to any one of [1] to [7], in which the surfactant (II) has a structure represented by Formula (4) described later.
[9] The optically anisotropic layer according to any one of [1] to [7], in which the surfactant (II) has a structure represented by Formula (5) described later.
[10] The optically anisotropic layer according to any one of [1] to [9],
in which, in a case where a value obtained by multiplying a solubility parameter of each liquid crystal compound by a content of each liquid crystal compound, and performing a weighted average of all liquid crystal compounds contained in the liquid crystal composition is defined as a solubility parameter of a liquid crystal mixture,
a relative energy difference of a solubility parameter of the surfactant (II) with respect to the solubility parameter of the liquid crystal mixture is 6 or more and 12 or less, here, the relative energy difference means a distance between the solubility parameter of the surfactant (II) and the solubility parameter of the liquid crystal mixture.
[11] The optically anisotropic layer according to any one of [1] to [7] and [10],
in which the surfactant (II) is a polymer which contains a repeating unit A having the structure of Formula (2) described later.
[12] The optically anisotropic layer according to [11],
in which the repeating unit A is a repeating unit having a structure represented by Formula (6) described later.
[13] The optically anisotropic layer according to [11] or [12],
in which the surfactant (II) is a polymer which contains the repeating unit A at a proportion of 40% by mass or more and 90% by mass or less.
[14] The optically anisotropic layer according to any one of [11] to [13],
in which the surfactant (II) is a polymer having a weight-average molecular weight of 15,000 or less.
[15] The optically anisotropic layer according to [10], in which the surfactant (II) is a polymer which contains a repeating unit A having the structure of Formula (2) described later and a repeating unit B not having the structure of Formula (2) described later, and
a relative energy difference of a solubility parameter of a monomer of the repeating unit B with respect to the solubility parameter of the liquid crystal mixture is 3 or more and 7 or less, here, the relative energy difference means a difference between the solubility parameter of the monomer of the repeating unit B and the solubility parameter of the liquid crystal mixture.
[16] The optically anisotropic layer according to any one of [11] to [14],
in which the surfactant (II) is a polymer which contains the repeating unit A and a repeating unit B not having the structure of Formula (2) described later, and the repeating unit B is a repeating unit containing a functional group which reacts with light or heat to form a crosslink.
[17] The optically anisotropic layer according to any one of [11] to [16],
in which the surfactant (II) is a polymer containing two or more kinds of the repeating units A having different structures.
[18] The optically anisotropic layer according to [1],
in which the optically anisotropic layer contains two or more kinds of the surfactants (II) having different structures.
[19] The optically anisotropic layer according to any one of [1] to [18],
in which a content of the surfactant (II) is 0.1 parts by mass or less with respect to 100 parts by mass of the liquid crystal compound,
here, in a case where the reverse dispersion compound (I) is a liquid crystal compound, the “100 parts by mass of the liquid crystal compound” as a reference of the content of the surfactant (II) is 100 parts by mass of a total amount of liquid crystal compounds including the reverse dispersion compound (I).
[20] The optically anisotropic layer according to any one of [1] to [19],
in which Ar¹ and Ar² in Formula (1) described later each independently represent any aromatic ring selected from the group consisting of the groups represented by Formulae (Ar-1), (Ar-2), and (Ar-4) to (Ar-8) described later.
[21] The optically anisotropic layer according to [11],
in which Ar¹ and Ar² in Formula (1) described later each independently represent any aromatic ring selected from the group consisting of the groups represented by Formulae (Ar-1), (Ar-2), and (Ar-4) to (Ar-8) described later.
[22] The optically anisotropic layer according to [11],
in which the surfactant (II) is a polymer which contains the repeating unit A and a repeating unit B not having the structure of Formula (2), and
the repeating unit B is a repeating unit having a structure represented by Formula (7) described later.
[23] The optically anisotropic layer according to any one of [1] to [22],
in which the liquid crystal composition further contains a solvent,
the solvent includes a high-boiling point solvent having a boiling point of 130° C. or higher, and
a content of the high-boiling point solvent is 150 parts by mass or more with respect to 100 parts by mass of the liquid crystal compound,
here, in a case where the reverse dispersion compound (I) is a liquid crystal compound, the “100 parts by mass of the liquid crystal compound” as a reference of the content of the high-boiling point solvent is 100 parts by mass of a total amount of liquid crystal compounds including the reverse dispersion compound (I).
[24] The optically anisotropic layer according to [11],
in which the liquid crystal composition further contains a solvent,
the solvent includes a high-boiling point solvent having a boiling point of 130° C. or higher, and
a content of the high-boiling point solvent is 150 parts by mass or more with respect to 100 parts by mass of the liquid crystal compound,
here, in a case where the reverse dispersion compound (I) is a liquid crystal compound, the “100 parts by mass of the liquid crystal compound” as a reference of the content of the high-boiling point solvent is 100 parts by mass of a total amount of liquid crystal compounds including the reverse dispersion compound (I).
[25] An optical film comprising:
the optically anisotropic layer according to any one of [1] to [24].
[26] A polarizing plate comprising:
the optically anisotropic layer according to any one of [1] to [24]; and
a polarizer.
[27] The polarizing plate according to [26], further comprising:
a positive C-plate.
[28] An image display device comprising:
the optically anisotropic layer according to any one of [1] to [24].
[29] A liquid crystal composition comprising:
[30] a reverse dispersion compound (I) represented by Formula (1) described later;
at least one liquid crystal compound; and
a surfactant (II) having a structure represented by Formula (2) described later in a molecule.
[30] The liquid crystal composition according to [29],
in which a content of the surfactant (II) is 0.1 parts by mass or less with respect to 100 parts by mass of the liquid crystal compound,
here, in a case where the reverse dispersion compound (I) is a liquid crystal compound, the “100 parts by mass of the liquid crystal compound” as a reference of the content of the surfactant (II) is 100 parts by mass of a total amount of liquid crystal compounds including the reverse dispersion compound (I).
[31] The liquid crystal composition according to [29] or [30],
in which Ar¹ and Ar² in Formula (1) described later each independently represent any aromatic ring selected from the group consisting of the groups represented by Formulae (Ar-1), (Ar-2), and (Ar-4) to (Ar-8) described later.
[32] The liquid crystal composition according to any one of [29] to [31],
in which the surfactant (II) is a polymer which contains the repeating unit A and a repeating unit B not having the structure of Formula (2) described later, and
the repeating unit B is a repeating unit having a structure represented by Formula (7) described later.
[33] The liquid crystal composition according to any one of [29] to [32], further comprising:
a solvent,
in which the solvent includes a high-boiling point solvent having a boiling point of 130° C. or higher, and
a content of the high-boiling point solvent is 150 parts by mass or more with respect to 100 parts by mass of the liquid crystal compound,
here, in a case where the reverse dispersion compound (I) is a liquid crystal compound, the “100 parts by mass of the liquid crystal compound” as a reference of the content of the high-boiling point solvent is 100 parts by mass of a total amount of liquid crystal compounds including the reverse dispersion compound (I).

According to the present invention, it is possible to provide a liquid crystal composition, which can form an optically anisotropic layer in which cissing and wind marks are suppressed in formation of a liquid crystal cured layer having reverse dispersibility; and an optically anisotropic layer, an optical film, a polarizing plate, and an image display device.

### BRIEF DESCRIPTION OF THE DRAWINGS

The FIGURE is a schematic cross-sectional view showing an example of an optical film.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

Any numerical range expressed using “to” in the present specification refers to a range including the numerical values before and after the “to” as a lower limit value and an upper limit value, respectively.

In addition, in a range of numerical values described in stages in the present specification, the upper limit value or the lower limit value described in a certain range of numerical values may be replaced with an upper limit value or a lower limit value of the range of numerical values described in other stages. In addition, regarding the numerical range described in the present specification, an upper limit value or a lower limit value described in a numerical value may be replaced with a value described in Examples.

In addition, in the present specification, substances corresponding to respective components may be used alone or in combination of two or more kinds thereof. Here, in a case where two or more kinds of substances are used in combination for each component, the content of the component indicates the total content of the substances used in combination, unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In addition, in the present specification, a bonding direction of a divalent group (for example, —O—CO—) described is not particularly limited, and for example, in a case where L² in an “L¹-L²-L³” bond is —O—CO—, and a bonding position on the L¹ side is represented by *1 and a bonding position on the L³ side is represented by *2, L² may be *1-O—CO—*2 or * 1-CO—O—*2.

In addition, in the present specification, Re(λ) and Rth(λ) respectively represent an in-plane retardation at a wavelength λ and a thickness-direction retardation at a wavelength λ. Unless otherwise specified, the wavelength λ refers to 550 nm.
Re(λ) and Rth(λ) are values measured at the wavelength λ in AxoScan OPMF-1 (manufactured by Opto Science, Inc.).

Specifically, by inputting an average refractive index ((nx+ny+nz)/3) and a film thickness (d (μm)) to AxoScan OPMF-1, it is possible to calculate:
a slow axis direction (°),
Re (λ)=R0 (λ), and
“Rth (λ)=((nx+ny)/2−nz)×d” are calculated.

In addition, R0(k) is expressed in a numerical value calculated with AxoScan OPMF-1, and means Re(λ).

In addition, in the present specification, examples of a substituent (monovalent substituent) include substituents described in the following substituent group A.

In the present specification, “may have a substituent” includes not only an aspect of not having a substituent but also an aspect of having one or more substituents.

### <Substituent Group A>

Examples of the substituent include:
a halogen atom (for example, a fluorine atom, a chlorine atom, a bromine atom, or an iodine atom);
an alkyl group (a linear, branched, or cyclic alkyl group having preferably 1 to 48 carbon atoms, more preferably 1 to 24 carbon atoms, and particularly preferably 1 to 8 carbon atoms, such as a linear alkyl group having 1 to 6 carbon atoms (for example, a methyl group, an ethyl group, a n-propyl group, a n-butyl group, a n-pentyl group, and a n-hexyl group), a branched alkyl group having 3 to 6 carbon atoms (for example, an isopropyl group, an isobutyl group, a tert-butyl group, a sec-butyl group, a neopentyl group, an isohexyl group, and a 3-methylpentyl group), and a cyclic alkyl group having 3 to 12 carbon atoms (for example, a cyclopropyl group, a cyclopentyl group, a cyclohexyl group, a 1-norbornyl group, and a 1-adamantyl group));
an alkenyl group (an alkenyl group having preferably 2 to 48 carbon atoms and more preferably 2 to 18 carbon atoms, such as a vinyl group, an allyl group, a 1-butene group, and a 2-butene group);
an alkynyl group (an alkynyl group having preferably 2 to 6 carbon atoms and more preferably 2 to 4 carbon atoms, such as an ethynyl group, a 1-propynyl group, a propargyl group, a 1-butynyl group, and a 2-butynyl group);
an aryl group (an aryl group having preferably 6 to 48 carbon atoms and more preferably 6 to 24 carbon atoms, such as a phenyl group, an oligoaryl group (a naphthyl group or an anthryl group), a phenanthrenyl group, a fluorenyl group, a pyrenyl group, a triphenylenyl group, and a biphenyl group);
a heteroaryl group (a heterocyclic group having preferably 1 to 32 carbon atoms and more preferably 1 to 18 carbon atoms, such as a 2-thienyl group, a 4-pyridyl group, a 2-furyl group, a 2-pyrimidinyl group, a 1-pyridyl group, a 2-benzothiazolyl group, a 1-imidazolyl group, a 1-pyrazolyl group, and a benzotriazol-1-yl group);
an arylalkyl group (an arylalkyl group having preferably 7 to 15 carbon atoms, such as a benzyl group, a phenethyl group, a methylbenzyl group, a phenylpropyl group, a 1-methylphenylethyl group, a phenylbutyl group, a 2-methylphenylpropyl group, a tetrahydronaphthyl group, a naphthylmethyl group, a naphthylethyl group, an indenyl group, a fluorenyl group, an anthracenylmethyl group (an anthrylmethyl group), and a phenanthrenylmethyl group (a phenanthrylmethyl group));
a silyl group (a silyl group having preferably 3 to 38 carbon atoms and more preferably 3 to 18 carbon atoms, such as a trimethylsilyl group, a triethylsilyl group, a tributylsilyl group, a t-butyldimethylsilyl group, and a t-hexyldimethylsilyl group);
a hydroxy group; a cyano group; a nitro group; a morpholino group;
an alkoxy group (an alkoxy group having preferably 1 to 48 carbon atoms and more preferably 1 to 24 carbon atoms, such as a methoxy group, an ethoxy group, a 1-butoxy group, a 2-butoxy group, an isopropoxy group, a t-butoxy group, a dodecyloxy group, and a cycloalkyloxy group (for example, a cyclopentyloxy group or a cyclohexyloxy group));
an aryloxy group (an aryloxy group having preferably 6 to 48 carbon atoms and more preferably 6 to 24 carbon atoms, such as a phenoxy group and a 1-naphthoxy group);
an alkenyloxy group (an alkenyloxy group having preferably 2 to 6 carbon atoms, such as a vinyloxy group, a 1-propenyloxy group, a 2-n-propenyloxy group (an allyloxy group), a 1-n-butenyloxy group, and a prenyloxy group);
a heterocyclic oxy group (a heterocyclic oxy group having preferably 1 to 32 carbon atoms and more preferably 1 to 18 carbon atoms, such as a 1-phenyltetrazole-5-oxy group and a 2-tetrahydropyranyloxy group);
a silyloxy group (a silyloxy group having preferably 1 to 32 carbon atoms and more preferably 1 to 18 carbon atoms, such as a trimethylsilyloxy group, a t-butyldimethylsilyloxy group, and a diphenylmethylsilyloxy group);
an acyloxy group (an acyloxy group having preferably 2 to 48 carbon atoms and more preferably 2 to 24 carbon atoms, such as an acetoxy group, a pivaloyloxy group, a benzoyloxy group, a dodecanoyloxy group, an acryloyloxy group, and a methacryloyloxy group);
a hydroxyalkyleneoxy group (a hydroxyalkyleneoxy group having preferably 2 to 10 carbon atoms, such as a hydroxyethyleneoxy group);
an alkoxycarbonyloxy group (an alkoxycarbonyloxy group having preferably 2 to 48 carbon atoms and more preferably 2 to 24 carbon atoms, such as an ethoxycarbonyloxy group, a t-butoxycarbonyloxy group, and a cycloalkyloxycarbonyloxy group (for example, a cyclohexyloxycarbonyloxy group));
an aryloxycarbonyloxy group (an aryloxycarbonyloxy group having preferably 7 to 32 carbon atoms and more preferably 7 to 24 carbon atoms, such as a phenoxycarbonyloxy group);
a carbamoyloxy group (a carbamoyloxy group having preferably 1 to 48 carbon atoms and more preferably 1 to 24 carbon atoms, such as an N,N-dimethylcarbamoyloxy group, an N-butylcarbamoyloxy group, an N-phenylcarbamoyloxy group, and an N-ethyl-N-phenylcarbamoyloxy group);
a sulfamoyloxy group (a sulfamoyloxy group having preferably 1 to 32 carbon atoms and more preferably 1 to 24 carbon atoms, such as an N,N-diethylsulfamoyloxy group and an N-propylsulfamoyloxy group);
an alkylsulfonyloxy group (an alkylsulfonyloxy group having preferably 1 to 38 carbon atoms and more preferably 1 to 24 carbon atoms, such as a methylsulfonyloxy group, a hexadecylsulfonyloxy group, and a cyclohexylsulfonyloxy group);
an arylsulfonyloxy group (an arylsulfonyloxy group having preferably 6 to 32 carbon atoms and more preferably 6 to 24 carbon atoms, such as a phenylsulfonyloxy group);
an acyl group (an acyl group having preferably 1 to 48 carbon atoms and more preferably 1 to 24 carbon atoms, such as a formyl group, an acetyl group, an acryloyl group, a methacryloyl group, a pivaloyl group, a benzoyl group, a tetradecanoyl group, and a cyclohexanoyl group);
an alkoxycarbonyl group (an alkoxycarbonyl group having preferably 2 to 48 carbon atoms and more preferably 2 to 24 carbon atoms, such as a methoxycarbonyl group, an ethoxycarbonyl group, an octadecyloxycarbonyl group, a cyclohexyloxycarbonyl group, and a 2,6-di-tert-butyl-4-methylcyclohexyloxycarbonyl group);
an aryloxycarbonyl group (an aryloxycarbonyl group having preferably 7 to 32 carbon atoms and more preferably 7 to 24 carbon atoms, such as a phenoxycarbonyl group);
a carbamoyl group (a carbamoyl group having preferably 1 to 48 carbon atoms and more preferably 1 to 24 carbon atoms, such as a carbamoyl group, an N,N-diethylcarbamoyl group, an N-ethyl-N-octylcarbamoyl group, an N,N-dibutylcarbamoyl group, an N-propylcarbamoyl group, an N-phenylcarbamoyl group, an N-methyl-N-phenylcarbamoyl group, and an N,N-dicyclohexylcarbamoyl group);
an amino group (an amino group having preferably 32 or less carbon atoms and more preferably 24 or less carbon atoms, such as an amino group, a methylamino group, an N,N-dibutylamino group, a tetradecylamino group, a 2-ethylhexylamino group, and a cyclohexylamino group);
an anilino group (an anilino group having preferably 6 to 32 carbon atoms and more preferably 6 to 24 carbon atoms, such as an anilino group and an N-methylanilino group);
a heterocyclic amino group (a heterocyclic amino group having preferably 1 to 32 carbon atoms and more preferably 1 to 18 carbon atoms, such as a 4-pyridylamino group);
a carbonamide group (a carbonamide group having preferably 2 to 48 carbon atoms and more preferably 2 to 24 carbon atoms, such as an acetamide group, a benzamide group, a tetradecaneamide group, a pivaloylamide group, and a cyclohexaneamide group); a ureido group (a ureido group having preferably 1 to 32 carbon atoms and more preferably 1 to 24 carbon atoms, such as a ureido group, an N,N-dimethylureido group, and an N-phenylureido group);
an imide group (an imide group having preferably 36 or less carbon atoms and more preferably 24 or less carbon atoms, such as an N-succinimide group and an N-phthalimide group);
an alkoxycarbonylamino group (an alkoxycarbonylamino group having preferably 2 to 48 carbon atoms and more preferably 2 to 24 carbon atoms, such as a methoxycarbonylamino group, an ethoxycarbonylamino group, a t-butoxycarbonylamino group, an octadecyloxycarbonylamino group, and a cyclohexyloxycarbonylamino group);
an aryloxycarbonylamino group (an aryloxycarbonylamino group having preferably 7 to 32 carbon atoms and more preferably 7 to 24 carbon atoms, such as a phenoxycarbonylamino group);
a sulfonamide group (a sulfonamide group having preferably 1 to 48 carbon atoms and more preferably 1 to 24 carbon atoms, such as a methanesulfonamide group, a butanesulfonamide group, a benzenesulfonamide group, a hexadecanesulfonamide group, and a cyclohexanesulfonamide group);
a sulfamoylamino group (a sulfamoylamino group having preferably 1 to 48 carbon atoms and more preferably 1 to 24 carbon atoms, such as an N,N-dipropylsulfamoylamino group and an N-ethyl-N-dodecylsulfamoylamino group);
an azo group (an azo group having preferably 1 to 32 carbon atoms and more preferably 1 to 24 carbon atoms, such as a phenylazo group and a 3-pyrazolylazo group);
an alkylthio group (an alkylthio group having preferably 1 to 48 carbon atoms and more preferably 1 to 24 carbon atoms, such as a methylthio group, an ethylthio group, an octylthio group, and a cyclohexylthio group);
an arylthio group (an arylthio group having preferably 6 to 48 carbon atoms and more preferably 6 to 24 carbon atoms, such as a phenylthio group);
a heterocyclic thio group (a heterocyclic thio group having preferably 1 to 32 carbon atoms and more preferably 1 to 18 carbon atoms, such as a 2-benzothiazolylthio group, a 2-pyridylthio group, and a 1-phenyltetrazolylthio group);
an alkylsulfinyl group (an alkylsulfinyl group having preferably 1 to 32 carbon atoms and more preferably 1 to 24 carbon atoms, such as a dodecanesulfinyl group);
an arylsulfinyl group (an arylsulfinyl group having preferably 6 to 32 carbon atoms and more preferably 6 to 24 carbon atoms, such as a phenylsulfinyl group);
an alkylsulfonyl group (an alkylsulfonyl group having preferably 1 to 48 carbon atoms and more preferably 1 to 24 carbon atoms, such as a methylsulfonyl group, an ethylsulfonyl group, a propylsulfonyl group, a butylsulfonyl group, an isopropylsulfonyl group, a 2-ethylhexylsulfonyl group, a hexadecylsulfonyl group, an octylsulfonyl group, and a cyclohexylsulfonyl group);
an arylsulfonyl group (an arylsulfonyl group having preferably 6 to 48 carbon atoms and more preferably 6 to 24 carbon atoms, such as a phenylsulfonyl group and a 1-naphthylsulfonyl group);
a sulfamoyl group (a sulfamoyl group having preferably 32 or less carbon atoms and more preferably 24 or less carbon atoms, such as a sulfamoyl group, an N,N-dipropylsulfamoyl group, an N-ethyl-N-dodecylsulfamoyl group, an N-ethyl-N-phenylsulfamoyl group, an N-cyclohexylsulfamoyl group, and an N-(2-ethylhexyl)sulfamoyl group);
a phosphonyl group (a phosphonyl group having preferably 1 to 32 carbon atoms and more preferably 1 to 24 carbon atoms, such as a phenoxyphosphonyl group, an octyloxyphosphonyl group, and a phenylphosphonyl group);
a phosphinoylamino group (a phosphinoylamino group having preferably 1 to 32 carbon atoms and more preferably 1 to 24 carbon atoms, such as a diethoxyphosphinoylamino group and a dioctyloxyphosphinoylamino group);
epoxy group; —NHCOCH₃; —SO₂NHC₂H₄OCH₃; and —NHSO₂CH₃,
in which two or more thereof may be combined.

These substituents may be further substituted with these substituents. In addition, in a case of having two or more of the substituents, the substituents may be the same or different from each other. Furthermore, if possible, these substituents may be bonded to each other to form a ring.

### [Liquid Crystal Composition]

The liquid crystal composition is a composition in which a coating layer exhibits a liquid crystal phase in a predetermined temperature range.

The liquid crystal composition according to the embodiment of the present invention contains a reverse dispersion compound (I) represented by Formula (1) described later, at least one liquid crystal compound, and a surfactant (II) having a structure represented by Formula (2) described later in a molecule (hereinafter, also abbreviated as “specific surfactant”).

The reverse dispersion compound (I) may or may not exhibit liquid crystallinity.

In addition, in a case where the reverse dispersion compound (I) exhibits liquid crystallinity, the reverse dispersion compound (I) and the liquid crystal compound may be the same compound, but it is preferable to further contain a liquid crystal compound which does not exhibit reverse dispersibility in order to broaden a temperature range in which the liquid crystal phase is exhibited.

The liquid crystal composition according to the embodiment of the present invention is suitably used as a liquid crystal composition for forming a liquid crystal cured layer constituting the optically anisotropic layer according to the embodiment of the present invention, which will be described later.

As described above, in the present invention, by blending the specific surfactant into the liquid crystal composition for forming the liquid crystal cured layer, it is possible to form an optically anisotropic layer having reverse dispersibility and sufficient film thickness uniformity for application to a display device, in which cissing and wind marks are suppressed in a case of forming the liquid crystal cured layer.

### [Liquid Crystal Compound]

The liquid crystal compound contained in the liquid crystal composition according to the embodiment of the present invention is not particularly limited.

The type of the liquid crystal compound contained in the liquid crystal composition is not particularly limited.

Here, in general, the liquid crystal compound can be classified into a rod-like type and a disk-like type according to the shape thereof. Each of the types can further be classified into a low-molecular-weight type and a high-molecular-weight type. The “high-molecular-weight” generally refers to a compound having a degree of polymerization of 100 or more (Polymer Physics-Phase Transition Dynamics, written by Masao Doi, p. 2, published by Iwanami Shoten, 1992). In addition, a reverse dispersion liquid crystal compound including a mesogen group as a branched structure is also known.

In the present invention, any liquid crystal compound can be used, but a rod-like liquid crystal compound or a reverse dispersion liquid crystal compound is preferable. It is more preferable to use two or more kinds of liquid crystal compounds selected from the group consisting of the rod-like liquid crystal compound and the reverse dispersion liquid crystal compound.

The liquid crystal compound is preferably a polymerizable liquid crystal compound having a polymerizable group.

The polymerizable liquid crystal compound is preferably at least one polymerizable liquid crystal compound selected from the group consisting of a polymerizable rod-like liquid crystal compound and a polymerizable reverse dispersion liquid crystal compound.

Examples of the polymerizable group include an acryloyl group, a methacryloyl group, an epoxy group, and a vinyl group.

By polymerizing the liquid crystal compound having such a polymerizable group in a state of being aligned, the alignment of the liquid crystal compound can be fixed. After immobilizing the liquid crystal compound by polymerization, it is no longer necessary to exhibit liquid crystallinity.

### [Reverse Dispersion Compound (I)]

The reverse dispersion compound (I) contained in the liquid crystal composition according to the embodiment of the present invention is a reverse dispersion compound (I) represented by Formula (1), and is preferably a liquid crystal compound.

Here, the reverse dispersibility refers to “reverse wavelength dispersibility”, and the reverse dispersion compound refers to the fact that in the measurement of an in-plane retardation (Re) value at a specific wavelength (visible light range) of a retardation film produced using the reverse dispersion compound, as the measurement wavelength increases, the Re value is the same or increased.

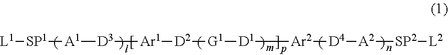

In Formula (1), D¹, D², D³, and D⁴ each independently represent a single bond, —CO—, —O—, —S—, —C(═S)—, —CR¹R²—, —CR³═CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms.

In addition, G¹ represents A^{G} or SP^{G}.

In addition, A¹, A², and A^{G} each independently represent an aromatic hydrocarbon ring which may have a substituent, an aromatic heterocyclic ring which may have a substituent, or a divalent alicyclic hydrocarbon group which may have a substituent. Here, one or more of —CH₂-'s constituting the alicyclic hydrocarbon group may be replaced with —O—, —S—, or —NH—.

In addition, SP¹, SP², and SP^{G} each independently represent a single bond or a divalent aliphatic hydrocarbon group having 1 to 20 carbon atoms. Here, one or more of —CH₂-'s constituting the aliphatic hydrocarbon group may be replaced with —O—, —S—, —NH—, —N(Q)-, or —CO—. Q represents a substituent.

In addition, L¹ and L² each independently represent a monovalent organic group, where at least one of L¹ or L² represents a polymerizable group. Here, in a case where at least one of Ar¹ or Ar² is an aromatic ring represented by Formula (Ar-4), at least one of L¹, L², or L³ or L⁴ in Formula (Ar-4) represents a polymerizable group.

In addition, m represents an integer of 0 to 2, provided that, in a case where m is 2, a plurality of G¹'s may be the same or different from each other and a plurality of D's may be the same or different from each other.

In addition, 1 and n each independently represent 0 or an integer of 1 or more, provided that, in a case where 1 is an integer of 2 or more, a plurality of A¹'s may be the same or different from each other and a plurality of D³'s may be the same or different from each other. In a case where n is an integer of 2 or more, a plurality of D⁴'s may be the same or different from each other and a plurality of A²'s may be the same or different from each other.

In addition, p represents 0 or an integer of 1 or more. In a case where p is an integer of 2 or more, a plurality of Ar¹'s may be the same or different from each other and a plurality of D²'s may be the same or different from each other. In a case where p is an integer of 2 or more and m is not 0, a plurality of G¹'s may be the same or different from each other and a plurality of D¹'s may be the same or different from each other.

Here, in Formula (1), it is preferable that an aspect in which all of G¹, D¹, and D² represent a single bond, and an aspect in which D² represents a single bond and m represents 0 are excluded.

In Formula (1), examples of the divalent linking group represented by one aspect of D¹, D², D³, and D⁴ include —CO—, —O—, —CO—O—, —C(═S)O—, —CR¹R²—, —CR¹R²—CR¹R²—, —O—CR¹R²—, —CR¹R²—O—CR¹R²—, —CO—O—CR¹R²—, —O—CO—CR¹R²—, —CR¹R²—O—CO—CR¹R²—, —CR¹R²—CO—O—CR¹R²—, —NR⁵—CR¹R²—, and —CO—NR⁵—. R¹, R², and R⁵ each independently represent a hydrogen atom, a fluorine atom, or an alkyl group having 1 to 12 carbon atoms. D¹, D², D³, and D⁴ are preferably any of a single bond, —CO—, —O—, or —CO—O—.

In Formula (1), examples of the aromatic hydrocarbon ring represented by one aspect of A¹, A², and A^{G} (A^{G} as one aspect of G¹; the same applies hereinafter) include an aromatic hydrocarbon ring having 6 to 20 carbon atoms, and specific examples thereof include a benzene ring, a naphthalene ring, an anthracene ring, and a phenanthrene ring.

In addition, examples of the aromatic heterocyclic ring represented by one aspect of A¹, A², and A^{G} include an aromatic heterocyclic ring having 5 to 20 carbon atoms; and specific examples thereof include a furan ring, a pyrrole ring, a thiophene ring, a pyridine ring, a thiazole ring, and a benzothiazole ring.

In addition, the divalent alicyclic hydrocarbon group represented by one aspect of A¹, A², and A^{G} is preferably a 5-membered ring or a 6-membered ring. In addition, the divalent alicyclic hydrocarbon group may be saturated or unsaturated, but a saturated divalent alicyclic hydrocarbon group is preferable. In addition, one or more of —CH₂-'s constituting the divalent alicyclic hydrocarbon group may be replaced with —O—, —S—, or —NH—. Examples of such a divalent alicyclic hydrocarbon group include a divalent alicyclic hydrocarbon group having 5 to 12 carbon atoms; and specific examples thereof include a monocyclic hydrocarbon group and a bridged cyclic hydrocarbon group, and more specific examples thereof include groups represented by Formulae (g-1) to (g-10).

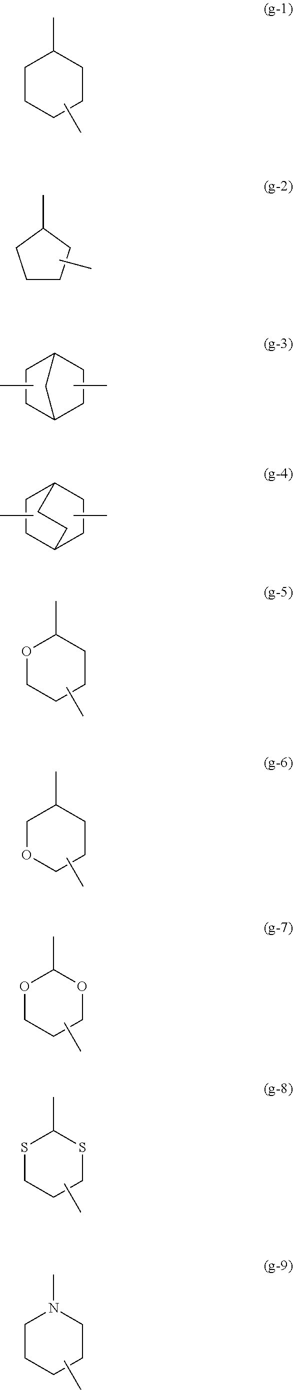

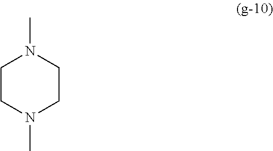

In addition, in Formula (1), examples of the substituent which may be included in the aromatic hydrocarbon ring, the aromatic heterocyclic ring, or the divalent alicyclic hydrocarbon group for A¹, A², and A^{G} include the substituents described in the substituent group A above; and among these, an alkyl group, an alkoxy group, an alkoxycarbonyl group, an alkylcarbonyloxy group, or a halogen atom is preferable.

In Formula (1), examples of the divalent aliphatic hydrocarbon group having 1 to 20 carbon atoms represented by one aspect of SP¹, SP², and SP^{G} (SP^{G} as one aspect of G¹; the same applies hereinafter) include a linear alkylene group having 1 to 20 carbon atoms or a branched alkylene group having 3 to 20 carbon atoms, a linear alkenylene group having 1 to 20 carbon atoms or a branched alkenylene group having 3 to 20 carbon atoms, and a linear alkynylene group having 1 to 20 carbon atoms or a branched alkynylene group having 3 to 20 carbon atoms.

As the linear alkylene group having 1 to 20 carbon atoms or the branched alkylene group having 3 to 20 carbon atoms, an alkylene group having 1 to 12 carbon atoms is preferable and an alkylene group having 1 to 10 carbon atoms is more preferable; and suitable examples thereof include a methylene group, an ethylene group, a propylene group, a butylene group, a pentylene group, and a hexylene group.

As the linear alkenylene group having 1 to 20 carbon atoms or the branched alkenylene group having 3 to 20 carbon atoms, an alkenylene group having 2 to 10 carbon atoms is preferable and an alkenylene group having 2 to 4 carbon atoms is more preferable; and suitable examples thereof include an ethenylene group.

As the linear alkynylene group having 1 to 20 carbon atoms or the branched alkynylene group having 3 to 20 carbon atoms, an alkynylene group having 2 to 10 carbon atoms is preferable and an alkynylene group having 2 to 4 carbon atoms is more preferable; and suitable examples thereof include an ethynylene group.

As described above, in SP¹, SP², and SP^{G}, one or more of —CH₂-'s constituting the aliphatic hydrocarbon group may be replaced with —O—, —S—, —NH—, —N(Q)-, or —CO—; and examples of the substituent represented by Q include the substituents described in the substituent group A above. Among these, an alkyl group, an alkoxy group, an alkoxycarbonyl group, an alkylcarbonyloxy group, or a halogen atom is preferable.

In the present invention, from the viewpoint of easily exhibiting liquid crystallinity, it is preferable that G¹ in Formula (1) is A^{G} among A^{G} or SP^{G} described above. In addition, from the reason that reverse wavelength dispersibility is improved and solubility is also favorable, it is preferable that G¹ in Formula (1) represents a cycloalkane ring or a cycloalkene ring.

Here, specific examples of the cycloalkane ring include a cyclohexane ring, a cycloheptane ring, a cyclooctane ring, a cyclododecane ring, and a cyclodocosane ring.

In addition, specific examples of the cycloalkene ring include a cyclobutene ring, a cyclopentene ring, a cyclohexene ring, a cycloheptene ring, a cyclooctene ring, a cyclopentadiene ring, and a cyclohexadiene ring.

In Formula (1), examples of the monovalent organic group represented by L¹ and L² include an alkyl group, an aryl group, a heteroaryl group, an alkoxy group, a cyano group, and a carboxy group. The alkyl group may be linear, branched, or cyclic, but is preferably linear. The number of carbon atoms in the alkyl group is preferably 1 to 30, more preferably 1 to 20, and still more preferably 1 to 10. In addition, the aryl group may be monocyclic or polycyclic, but is preferably monocyclic. The number of carbon atoms in the aryl group is preferably 6 to 25 and more preferably 6 to 10. In addition, the heteroaryl group may be monocyclic or polycyclic. The number of heteroatoms constituting the heteroaryl group is preferably 1 to 3. The heteroatom constituting the heteroaryl group is preferably a nitrogen atom, a sulfur atom, or an oxygen atom. The number of carbon atoms in the heteroaryl group is preferably 6 to 18 and more preferably 6 to 12. In addition, the alkyl group, the aryl group, and the heteroaryl group may be unsubstituted or may have a substituent. Examples of the substituent include the substituents described in the substituent group A above; and among these, an alkyl group, an alkoxy group, an alkoxycarbonyl group, an alkylcarbonyloxy group, or a halogen atom is preferable.

In Formula (1), the polymerizable group represented by at least one of L¹ or L² is not particularly limited, but is preferably a polymerizable group capable of radical polymerization or cationic polymerization.

A known radically polymerizable group can be used as the radically polymerizable group, and suitable examples thereof include an acryloyloxy group or a methacryloyloxy group. In this case, it is known that the acryloyloxy group generally has a high polymerization rate, and from the viewpoint of improving productivity, the acryloyloxy group is preferable. However, the methacryloyloxy group can also be used as the polymerizable group.

A known cationically polymerizable group can be used as the cationically polymerizable group, and specific examples thereof include an alicyclic ether group, a cyclic acetal group, a cyclic lactone group, a cyclic thioether group, a spiro orthoester group, and a vinyloxy group. Among these, an alicyclic ether group or a vinyloxy group is suitable, and an epoxy group, an oxetanyl group, or a vinyloxy group is particularly preferable.

Examples of particularly preferred polymerizable group include a polymerizable group represented by any one of Formulae (P-1) to (P-20). In the following formulae, Me represents a methyl group, and Et represents an ethyl group.

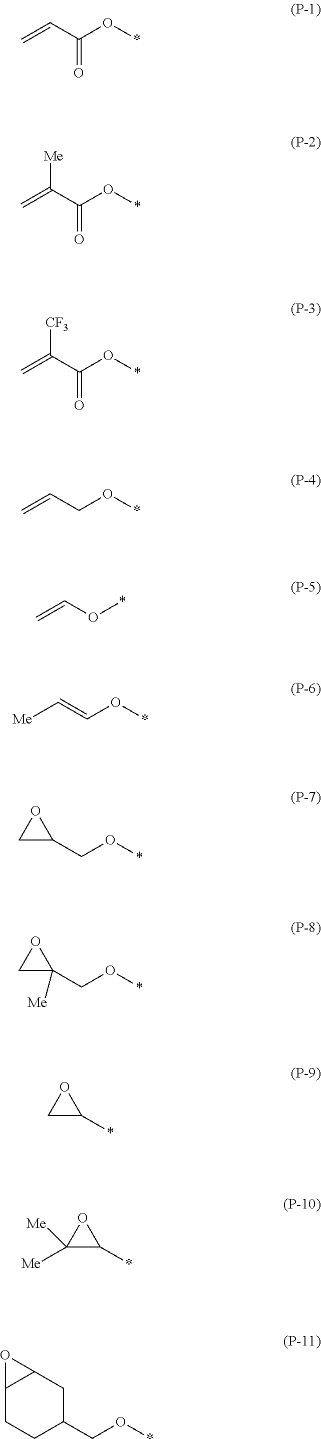

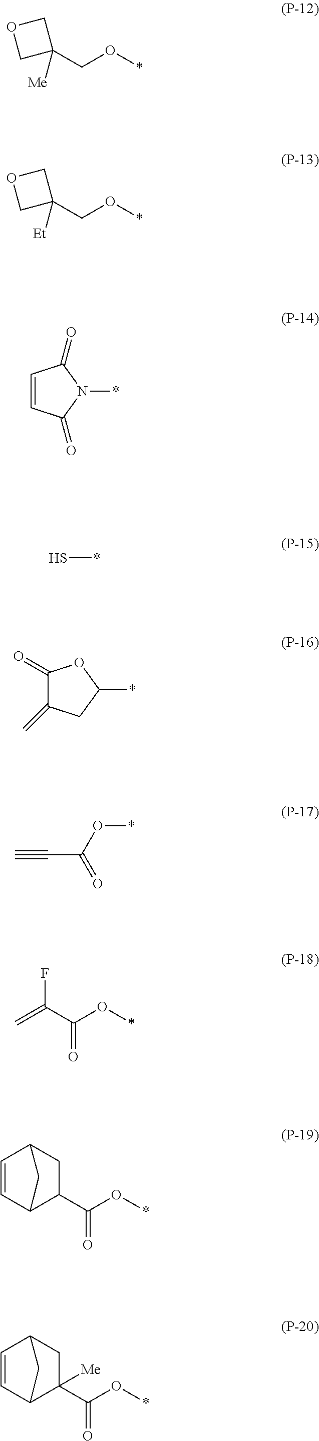

In the present invention, from the reason that durability of an optically anisotropic layer to be formed is improved, it is preferable that both of L¹ and L² in Formula (1) are polymerizable groups, and it is more preferable that L¹ and L² are an acryloyl group or a methacryloyl group.

In Formula (1), m represents an integer of 0 to 2, 1 and n each independently represent 0 or an integer of 1 or more, and p represents 0 or an integer of 1 or more.

Here, m is preferably 0 or 1, and from the viewpoint of synthesis, more preferably 1.

From the viewpoint of solubility and compatibility with other liquid crystal compounds, 1 and n are preferably an integer of 0 to 2.
p is preferably an integer of 0 to 2, and more preferably 0 or 1.

In the present invention, from the viewpoint of easily exhibiting liquid crystallinity in a wide temperature range including room temperature, and increasing birefringence (Δn), it is preferable that both of 1 and n in Formula (1) represent 1 and both of A¹ and A² represent a benzene ring.

On the other hand, in Formula (1), Ar¹ and Ar² each independently represent any aromatic ring selected from the group consisting of groups represented by Formulae (Ar-1) to (Ar-8). In Formulae (Ar-1) to (Ar-8), *1 represents a bonding position to D³ or D⁴, and *2 represents a bonding position to D¹ or D². Here, in a case where 1 is 0, the bonding position to D³ represents a bonding position to SP¹, in a case where m is 0, *2 represents the bonding position to D², and in a case where n is 0, the bonding position to D⁴ represents a bonding position to SP².

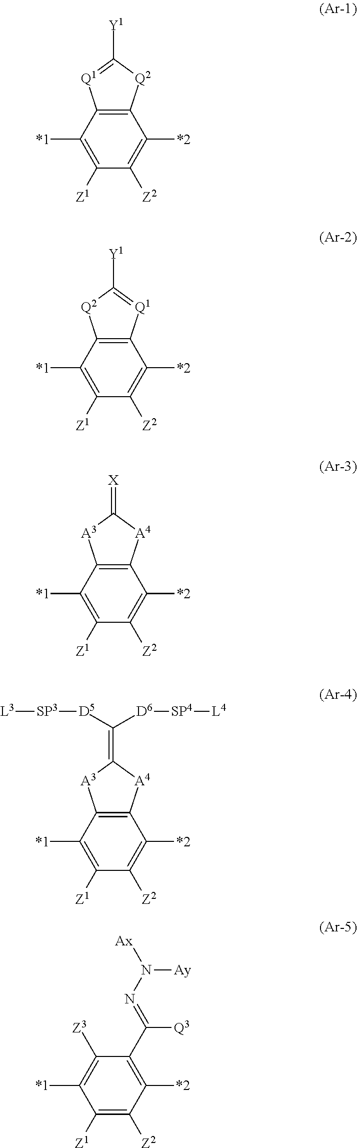

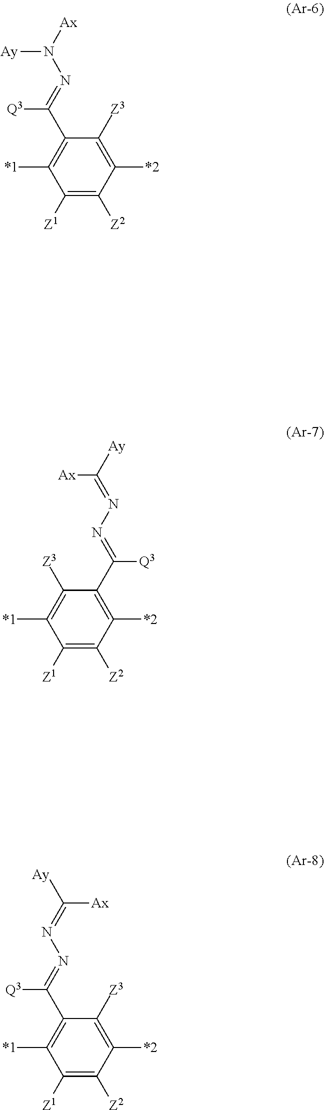

In Formulae (Ar-1) and (Ar-2), Q¹ represents N or CH, Q² represents —S—, —O—, or —N(R⁶)—, where R⁶ represents a hydrogen atom or an alkyl group having 1 to 6 carbon atoms, Y¹ represents a monovalent aromatic hydrocarbon group having 6 to 12 carbon atoms, which may have a substituent, a monovalent aromatic heterocyclic group having 3 to 12 carbon atoms, which may have a substituent, or a monovalent alicyclic hydrocarbon group having 6 to 20 carbon atoms, which may have a substituent, and one or more of —CH₂-'s constituting the alicyclic hydrocarbon group may be replaced with —O—, —S—, or —NH—.

Here, specific examples of the alkyl group having 1 to 6 carbon atoms represented by one aspect of R⁶ include a methyl group, an ethyl group, a propyl group, an isopropyl group, a n-butyl group, an isobutyl group, a sec-butyl group, a tert-butyl group, a n-pentyl group, and a n-hexyl group.

Examples of the monovalent aromatic hydrocarbon group having 6 to 12 carbon atoms, represented by one aspect of Y¹, include aryl groups such as a phenyl group, a 2,6-diethylphenyl group, and a naphthyl group.

Examples of the monovalent aromatic heterocyclic group having 3 to 12 carbon atoms, represented by one aspect of Y¹, include a heteroaryl group such as a thienyl group, a thiazolyl group, a furyl group, and a pyridyl group; and a group obtained by removing one hydrogen atom from any of an indole ring, a benzofuran ring, a benzothiophene ring, a benzimidazole ring, a benzothiazole ring, or a benzoxazole ring. Among these, as the monovalent aromatic heterocyclic group having 3 to 12 carbon atoms, represented by one aspect of Y¹, a group obtained by removing one hydrogen atom from a benzofuran ring or a benzothiazole ring is preferable.

Examples of the monovalent alicyclic hydrocarbon group having 6 to 20 carbon atoms, represented by one aspect of Y¹, include a cyclohexyl group, a cyclopentyl group, a norbornyl group, and an adamantyl group.

In addition, examples of the substituent which may be included in Y¹ include the substituents described in the substituent group A above; and among these, an alkyl group, an alkoxy group, an alkoxycarbonyl group, an alkylcarbonyloxy group, or a halogen atom is preferable.

In addition, in Formulae (Ar-1) to (Ar-8), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a monovalent aromatic heterocyclic group having 6 to 20 carbon atoms, a halogen atom, a cyano group, a nitro group, —OR⁷, —NR¹R⁹, —SR¹⁰, —COOR¹¹, or —COR¹², where R⁷ to R¹² each independently represent a hydrogen atom or an alkyl group having 1 to 6 carbon atoms and Z¹ and Z² may be bonded to each other to form an aromatic ring.

As the monovalent aliphatic hydrocarbon group having 1 to 20 carbon atoms, an alkyl group having 1 to 15 carbon atoms is preferable, an alkyl group having 1 to 8 carbon atoms is more preferable; and specifically, a methyl group, an ethyl group, an isopropyl group, a tert-pentyl group (1,1-dimethylpropyl group), a tert-butyl group, or 1,1-dimethyl-3,3-dimethyl-butyl group is still more preferable and a methyl group, an ethyl group, or a tert-butyl group is particularly preferable.

Examples of the monovalent alicyclic hydrocarbon group having 3 to 20 carbon atoms include monocyclic saturated hydrocarbon groups such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadiene group; and polycyclic saturated hydrocarbon groups such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly, a phenyl group) is preferable.

Specific examples of the monovalent aromatic heterocyclic group having 6 to 20 carbon atoms include a 4-pyridyl group, a 2-furyl group, a 2-thienyl group, a 2-pyrimidinyl group, and a 2-benzothiazolyl group.

Examples of the halogen atom include a fluorine atom, a chlorine atom, a bromine atom, and an iodine atom, and among these, a fluorine atom, a chlorine atom, or a bromine atom is preferable.

On the other hand, specific examples of the alkyl group having 1 to 6 carbon atoms represented by one aspect of R⁷ to R¹² include a methyl group, an ethyl group, a propyl group, an isopropyl group, a n-butyl group, an isobutyl group, a sec-butyl group, a tert-butyl group, a n-pentyl group, and a n-hexyl group.

As described above, Z¹ and Z² may be bonded to each other to form an aromatic ring, and examples of a structure in a case where Z¹ and Z² in Formula (Ar-1) are bonded to each other to form an aromatic ring include a group represented by Formula (Ar-1a). In Formula (Ar-1a), *1 represents a bonding position to D³ or D⁴ in Formula (1) described above, and *2 represents a bonding position to D¹ or D² in Formula (1) described above. Here, in a case where 1 is 0, the bonding position to D³ represents a bonding position to SP¹, in a case where m is 0, *2 represents the bonding position to D², and in a case where n is 0, the bonding position to D⁴ represents a bonding position to SP².

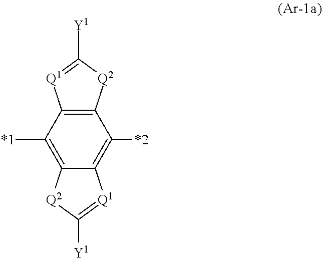

Here, in Formula (Ar-1a), examples of Q¹, Q², and Y¹ include the same as those described in Formula (Ar-1) above.

In the present invention, from the viewpoint of easily exhibiting liquid crystallinity, improving solubility, and enhancing durability of the optically anisotropic film to be formed, it is preferable that any one of Z¹ or Z² in Formulae (Ar-1) to (Ar-8) represents a monovalent aliphatic hydrocarbon group having 1 to 20 carbon atoms (particularly, a tert-butyl group).

In addition, from the viewpoint of further improving the durability of the optically anisotropic film to be formed, it is preferable that, in Formulae (Ar-1) to (Ar-8), Z¹ represents a hydrogen atom and Z² represents a monovalent aliphatic hydrocarbon group having 1 to 20 carbon atoms (particularly, a tert-butyl group).

In addition, in Formulae (Ar-3) and (Ar-4), A³ and A⁴ each independently represent a group selected from the group consisting of —O—, —N(R¹³)—, —S—, and —CO—, and R¹³ represents a hydrogen atom or a substituent.

Examples of the substituent represented by one aspect of R¹³ include the substituents described in the substituent group A above; and among these, an alkyl group, an alkoxy group, an alkoxycarbonyl group, an alkylcarbonyloxy group, or a halogen atom is preferable.

In addition, in Formula (Ar-3), X represents a non-metal atom of Group 14 to Group 16. Here, a hydrogen atom or a substituent may be bonded to the non-metal atom.

In addition, examples of the non-metal atom of Groups 14 to 16, represented by X, include an oxygen atom, a sulfur atom, a nitrogen atom to which a hydrogen atom or a substituent is bonded [═N—R^{N1}, R^{N1} represents a hydrogen atom or a substituent], and a carbon atom to which a hydrogen atom or a substituent is bonded [═C—(R^{C1})₂, R^{C1} represents a hydrogen atom or a substituent].

Examples of the substituent include the substituents described in the substituent group A above; and among these, suitable examples thereof include an alkyl group, an alkoxy group, an alkyl-substituted alkoxy group, a cyclic alkyl group, an aryl group (for example, a phenyl group, a naphthyl group, or the like), a cyano group, an amino group, a nitro group, an alkylcarbonyl group, a sulfo group, and a hydroxyl group.

In addition, in Formula (Ar-4), D⁵ and D⁶ each independently represent a single bond, —CO—, —O—, —S—, —C(═S)—, —CR¹R²—, —CR³═CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms.

Here, examples of the divalent linking group include the same as those described for D¹, D², D³, and D⁴ in Formula (1) above.

In addition, in Formula (Ar-4), SP³ and SP⁴ each independently represent a single bond or a divalent aliphatic hydrocarbon group having 1 to 20 carbon atoms. Here, one or more of —CH₂-'s constituting the aliphatic hydrocarbon group may be replaced with —O—, —S—, —NH—, —N(Q)-, or —CO—. Q represents a substituent. Examples of the substituent represented by Q include the substituents described in the substituent group A above; and among these, an alkyl group, an alkoxy group, an alkoxycarbonyl group, an alkylcarbonyloxy group, or a halogen atom is preferable.

Here, examples of the divalent aliphatic hydrocarbon group include the same as those described for SP¹, SP², and SP^{G} in Formula (1) above.

L³ and L⁴ in Formula (Ar-4) each independently represent a monovalent organic group, and at least one of L³, L⁴, or L¹ or L² in Formula (1) above represents a polymerizable group.

Here, examples of the monovalent organic group include the same as those described for L¹ and L² in Formula (1) above.

In addition, examples of the polymerizable group include the same as those described for L¹ and L² in Formula (1) above.

In addition, in Formulae (Ar-5) to (Ar-8), Ax represents an organic group having 2 to 30 carbon atoms, which has at least one aromatic ring selected from the group consisting of an aromatic hydrocarbon ring and an aromatic heterocyclic ring.

In addition, in Formulae (Ar-5) to (Ar-8), Ay represents a hydrogen atom, an alkyl group having 1 to 12 carbon atoms, which may have a substituent, or an organic group having 2 to 30 carbon atoms which has at least one aromatic ring selected from the group consisting of an aromatic hydrocarbon ring and an aromatic heterocyclic ring.

Here, the aromatic rings in Ax and Ay may have a substituent, and Ax and Ay may be bonded to each other to form a ring.

In addition, Q³ represents a hydrogen atom or an alkyl group having 1 to 20 carbon atoms, which may have a substituent.

Examples of Ax and Ay include those described in paragraphs [0039] to [0095] of WO2014/010325A.

In addition, specific examples of the alkyl group having 1 to 20 carbon atoms, represented by Q³, include a methyl group, an ethyl group, a propyl group, an isopropyl group, a n-butyl group, an isobutyl group, a sec-butyl group, a tert-butyl group, a n-pentyl group, and a n-hexyl group; and examples of the substituent include the substituents described in the substituent group A above. Among these, an alkyl group, an alkoxy group, an alkoxycarbonyl group, an alkylcarbonyloxy group, or a halogen atom is preferable.

In the present invention, from the reason that aligning properties of the liquid crystal composition are favorable, it is preferable that Ar¹ and Ar² in Formula (1) represent any aromatic ring selected from the group consisting of the groups represented by Formulae (Ar-1), (Ar-2), and (Ar-4) to (Ar-8).

Examples of the reverse dispersion compound (I) represented by Formula (1) include, as a compound in which p in Formula (1) is 0, a compound represented by General Formula (1) described in JP2010-084032A (particularly, a compound described in paragraphs [0067] to [0073]), a compound represented by General Formula (II) described in JP2016-053709A (particularly, a compound described in paragraphs [0036] to [0043]), a compound represented by General Formula (1) described in JP2016-081035A (particularly, a compound described in paragraphs [0043] to [0055]), and a compound described in paragraphs [0025] to [0056] of WO2021/060427A.

In addition, examples of the reverse dispersion compound (I) represented by Formula (1) include, as a compound in which p in Formula (1) is 1, the following compounds represented by Formulae (I) to (XII); and specific examples thereof include compounds having groups shown in Tables 1 to 8 as D¹, G¹, and D² and K in Formulae (I) to (VI), and compounds having groups shown in Table 9 as D¹, G¹, G¹, D², and K in Formulae (VII) to (XII).

In Tables 1 to 8, “*” shown in a group such as D¹ represents a bonding position.

In addition, in the following description, a compound represented by Formula (I) and having a group shown as 1-1 in Table 1 is denoted by “Compound (I-1-1)”, and compounds having other structural formulae and groups are also denoted in the same manner. For example, a compound represented by Formula (II) and having a group shown as 2-3 in Table 2 can be denoted by “Compound (II-2-3)”.

In addition, in the compound (I-1-1) and the like, a group adjacent to an acryloyloxy group represents a propylene group (a group in which a methyl group is replaced with an ethylene group), and represents a mixture of regioisomers in which positions of the methyl groups are different.

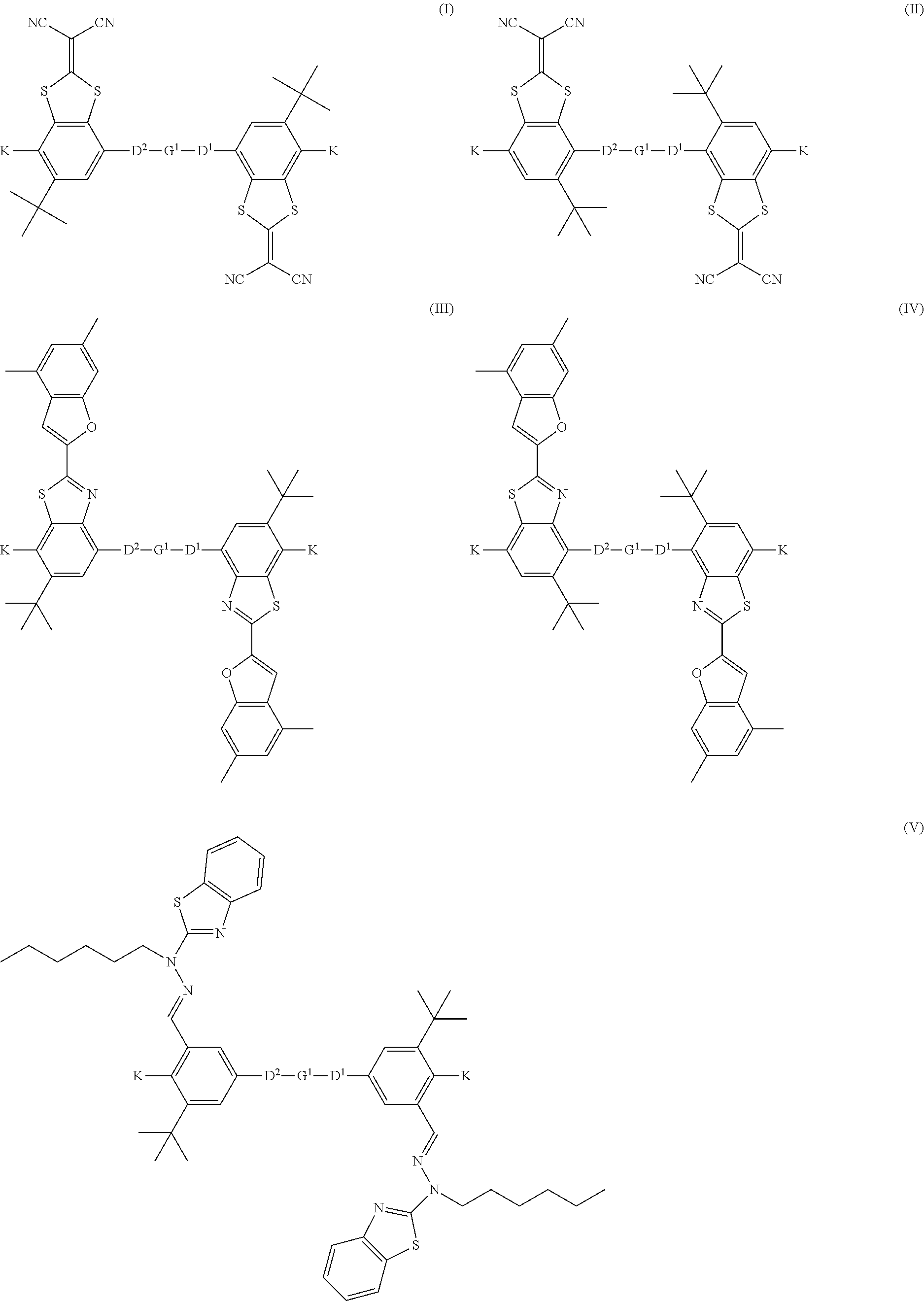

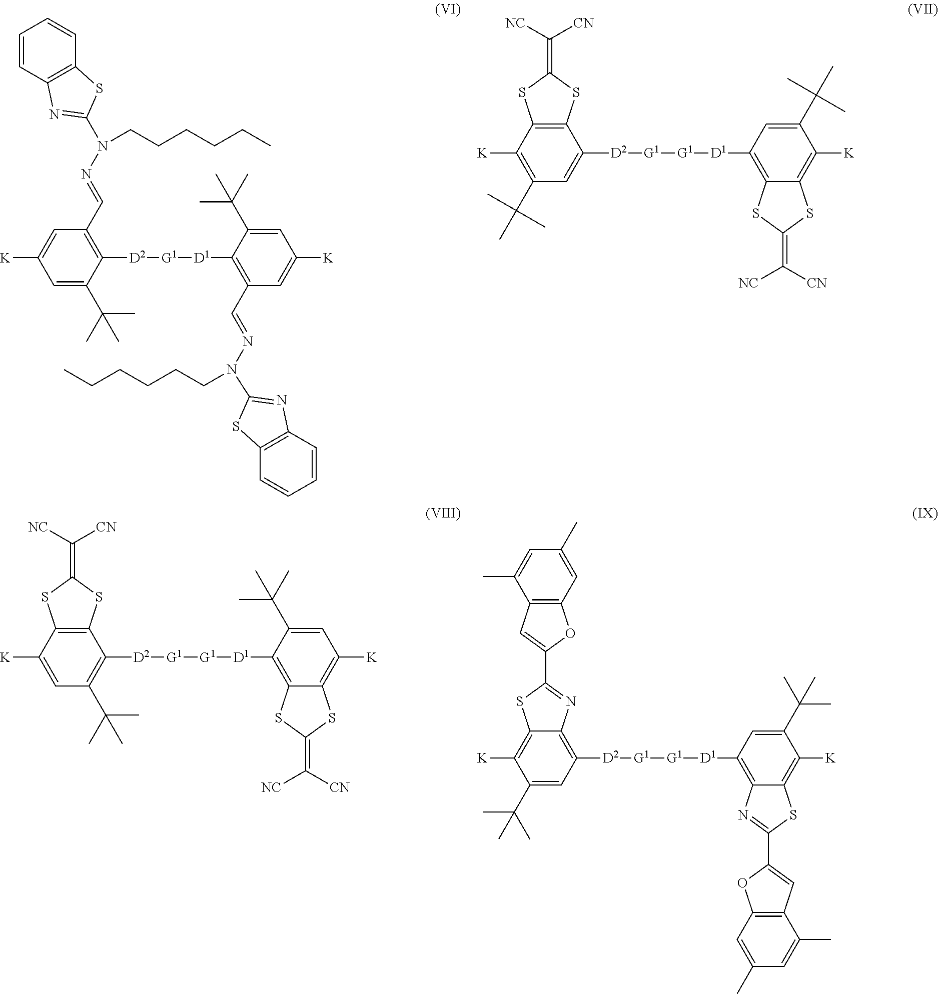

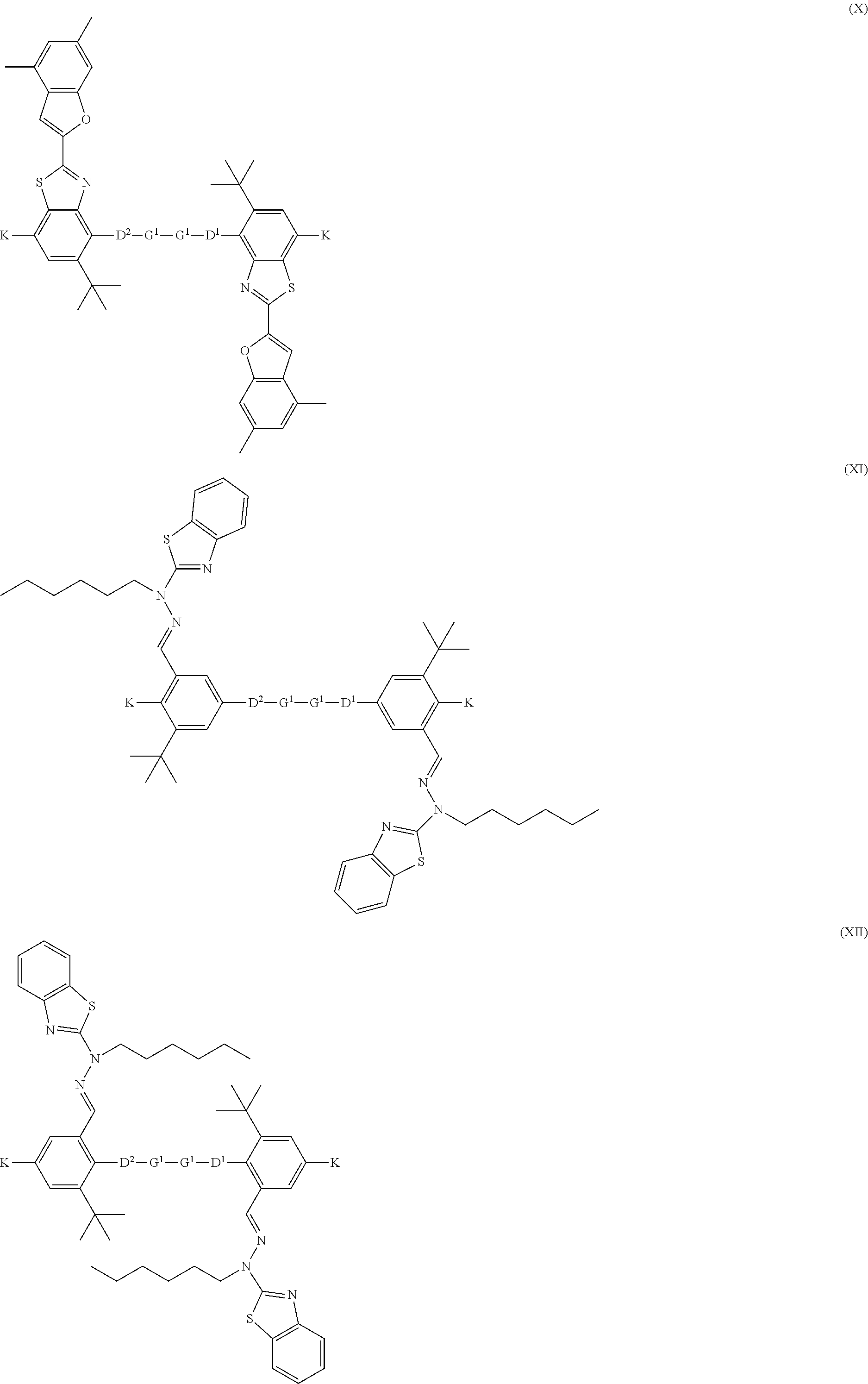

TABLE 1

| | D¹ | G¹ | D² | K |
|---|---|---|---|---|
| 1-1 | 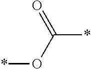 [SMILES: *OC(*)=O] | 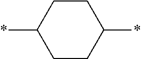 [SMILES: *C1CCC(*)CC1] | 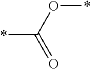 [SMILES: *OC(*)=O] | 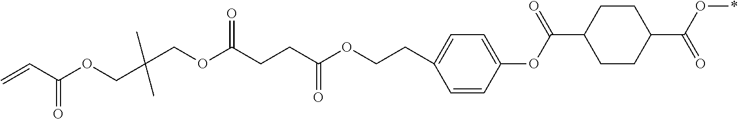 [SMILES: *OC(=O)C1CCC(C(=O)Oc2ccc(CCOC(=O)CCC(=O)OCC(C)(C)COC(=O)C=C)cc2)CC1] |
| 1-2 | 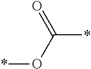 [SMILES: *OC(*)=O] | 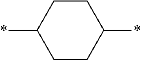 [SMILES: *C1CCC(*)CC1] | 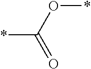 [SMILES: *OC(*)=O] | 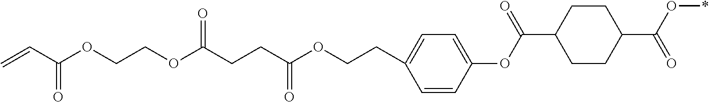 [SMILES: *OC(=O)C1CCC(C(=O)Oc2ccc(CCOC(=O)CCC(=O)OCCOC(=O)C=C)cc2)CC1] |
| 1-3 | 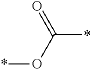 [SMILES: *OC(*)=O] | 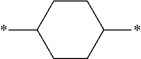 [SMILES: *C1CCC(*)CC1] | 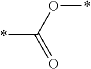 [SMILES: *OC(*)=O] | 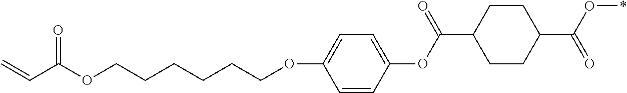 [SMILES: *OC(=O)C1CCC(C(=O)Oc2ccc(OCCCCCCOC(=O)C=C)cc2)CC1] |
| 1-4 | 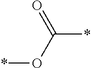 [SMILES: *OC(*)=O] | 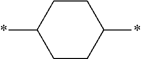 [SMILES: *C1CCC(*)CC1] | 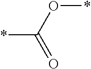 [SMILES: *OC(*)=O] | 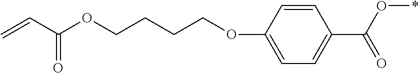 [SMILES: *OC(=O)c1ccc(OCCCCOC(=O)C=C)cc1] |
| 1-5 | 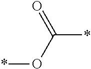 [SMILES: *OC(*)=O] | 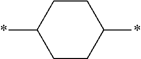 [SMILES: *C1CCC(*)CC1] | 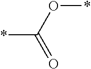 [SMILES: *OC(*)=O] | 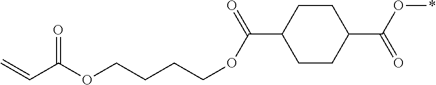 [SMILES: *OC(=O)C1CCC(C(=O)OCCCCOC(=O)C=C)CC1] |
| 1-6 | 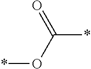 [SMILES: *OC(*)=O] | 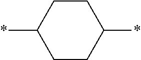 [SMILES: *C1CCC(*)CC1] | 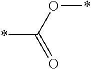 [SMILES: *OC(*)=O] | 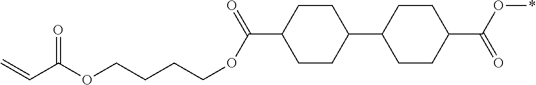 [SMILES: *OC(=O)C1CCC(C2CCC(C(=O)OCCCCOC(=O)C=C)CC2)CC1] |
| 1-7 | 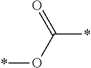 [SMILES: *OC(*)=O] | 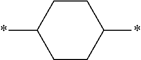 [SMILES: *C1CCC(*)CC1] | 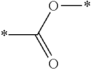 [SMILES: *OC(*)=O] | 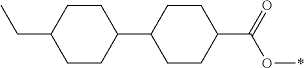 [SMILES: *OC(=O)C1CCC(C2CCC(CC)CC2)CC1] |
| 1-8 | 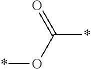 [SMILES: *OC(*)=O] | 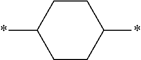 [SMILES: *C1CCC(*)CC1] | 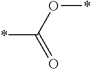 [SMILES: *OC(*)=O] | 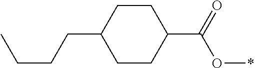 [SMILES: *OC(=O)C1CCC(CCCC)CC1] |
| 1-9 | 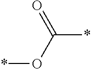 [SMILES: *OC(*)=O] | 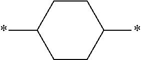 [SMILES: *C1CCC(*)CC1] | 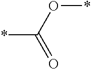 [SMILES: *OC(*)=O] | 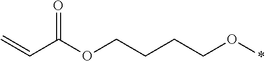 [SMILES: *OCCCCOC(=O)C=C] |
| 1-10 | 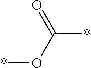 [SMILES: *OC(*)=O] | 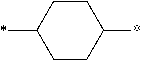 [SMILES: *C1CCC(*)CC1] | 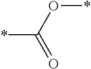 [SMILES: *OC(*)=O] | 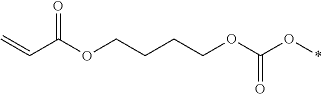 [SMILES: *OC(=O)OCCCCOC(=O)C=C] |

TABLE 2

| | D¹ | G¹ | D¹ | K |
|---|---|---|---|---|
| 2-1 | 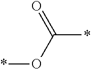 [SMILES: *OC(*)=O] | 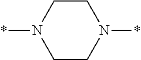 [SMILES: *N1CCN(*)CC1] | 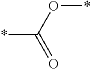 [SMILES: *OC(*)=O] | 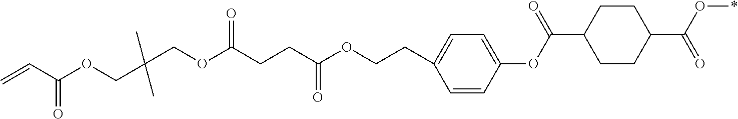 [SMILES: *OC(=O)C1CCC(C(=O)Oc2ccc(CCOC(=O)CCC(=O)OCC(C)(C)COC(=O)C=C)cc2)CC1] |
| 2-2 | 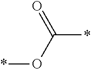 [SMILES: *OC(*)=O] | 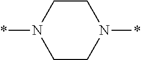 [SMILES: *N1CCN(*)CC1] | 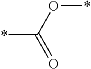 [SMILES: *OC(*)=O] | 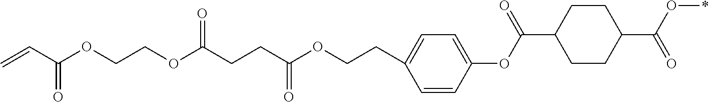 [SMILES: *OC(=O)C1CCC(C(=O)Oc2ccc(CCOC(=O)CCC(=O)OCCOC(=O)C=C)cc2)CC1] |
| 2-3 | 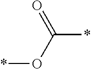 [SMILES: *OC(*)=O] | 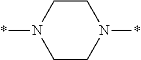 [SMILES: *N1CCN(*)CC1] | 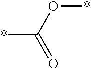 [SMILES: *OC(*)=O] | 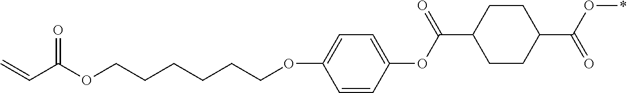 [SMILES: *OC(=O)C1CCC(C(=O)Oc2ccc(OCCCCCCOC(=O)C=C)cc2)CC1] |
| 2-4 | 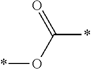 [SMILES: *OC(*)=O] | 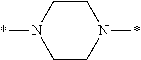 [SMILES: *N1CCN(*)CC1] | 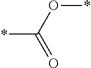 [SMILES: *OC(*)=O] | 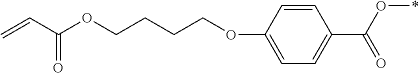 [SMILES: *OC(=O)c1ccc(OCCCCOC(=O)C=C)cc1] |
| 2-5 | 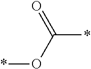 [SMILES: *OC(*)=O] | 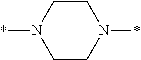 [SMILES: *N1CCN(*)CC1] | 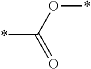 [SMILES: *OC(*)=O] | 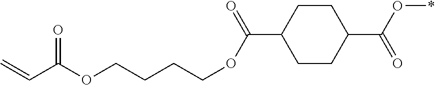 [SMILES: *OC(=O)C1CCC(C(=O)OCCCCOC(=O)C=C)CC1] |
| 2-6 | 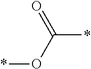 [SMILES: *OC(*)=O] | 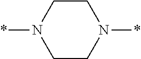 [SMILES: *N1CCN(*)CC1] | 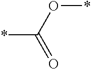 [SMILES: *OC(*)=O] | 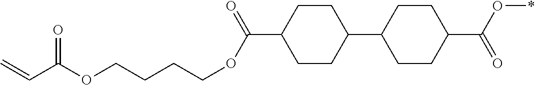 [SMILES: *OC(=O)C1CCC(C2CCC(C(=O)OCCCCOC(=O)C=C)CC2)CC1] |
| 2-7 | 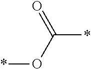 [SMILES: *OC(*)=O] | 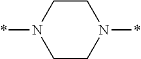 [SMILES: *N1CCN(*)CC1] | 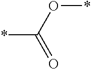 [SMILES: *OC(*)=O] | 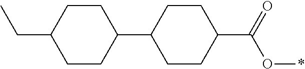 [SMILES: *OC(=O)C1CCC(C2CCC(CC)CC2)CC1] |
| 2-8 | 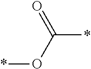 [SMILES: *OC(*)=O] | 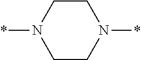 [SMILES: *N1CCN(*)CC1] | 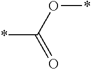 [SMILES: *OC(*)=O] | 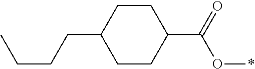 [SMILES: *OC(=O)C1CCC(CCCC)CC1] |
| 2-9 | 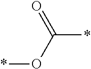 [SMILES: *OC(*)=O] | 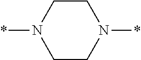 [SMILES: *N1CCN(*)CC1] | 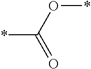 [SMILES: *OC(*)=O] | 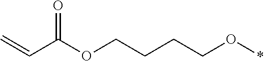 [SMILES: *OCCCCOC(=O)C=C] |
| 2-10 | 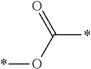 [SMILES: *OC(*)=O] | 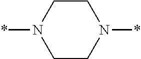 [SMILES: *N1CCN(*)CC1] | 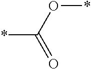 [SMILES: *OC(*)=O] | 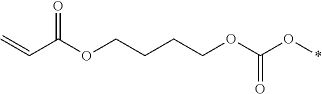 [SMILES: *OC(=O)OCCCCOC(=O)C=C] |

TABLE 3

| | D¹ | G¹ | D² | K |
|---|---|---|---|---|
| 3-1 | 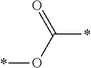 [SMILES: *OC(*)=O] | 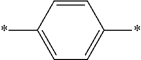 [SMILES: *c1ccc(*)cc1] | 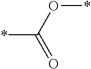 [SMILES: *OC(*)=O] | 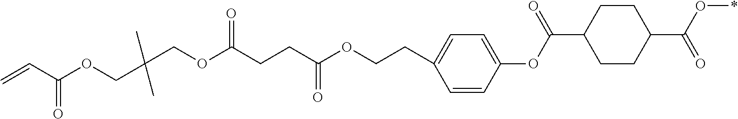 [SMILES: *OC(=O)C1CCC(C(=O)Oc2ccc(CCOC(=O)CCC(=O)OCC(C)(C)COC(=O)C=C)cc2)CC1] |
| 3-2 | 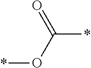 [SMILES: *OC(*)=O] | 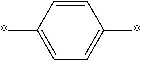 [SMILES: *c1ccc(*)cc1] | 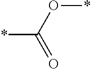 [SMILES: *OC(*)=O] | 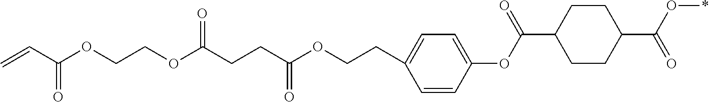 [SMILES: *OC(=O)C1CCC(C(=O)Oc2ccc(CCOC(=O)CCC(=O)OCCOC(=O)C=C)cc2)CC1] |
| 3-3 | 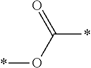 [SMILES: *OC(*)=O] | 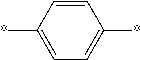 [SMILES: *c1ccc(*)cc1] | 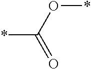 [SMILES: *OC(*)=O] | 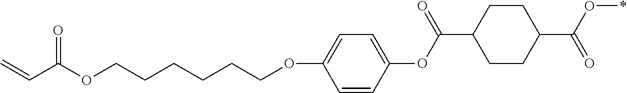 [SMILES: *OC(=O)C1CCC(C(=O)Oc2ccc(OCCCCCCOC(=O)C=C)cc2)CC1] |
| 3-4 | 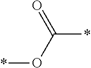 [SMILES: *OC(*)=O] | 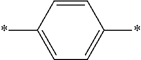 [SMILES: *c1ccc(*)cc1] | 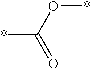 [SMILES: *OC(*)=O] | 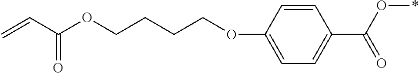 [SMILES: *OC(=O)c1ccc(OCCCCOC(=O)C=C)cc1] |
| 3-5 | 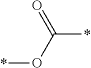 [SMILES: *OC(*)=O] | 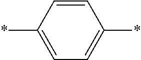 [SMILES: *c1ccc(*)cc1] | 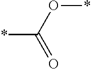 [SMILES: *OC(*)=O] | 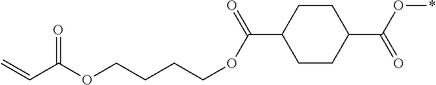 [SMILES: *OC(=O)C1CCC(C(=O)OCCCCOC(=O)C=C)CC1] |
| 3-6 | 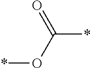 [SMILES: *OC(*)=O] | 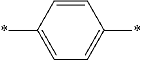 [SMILES: *c1ccc(*)cc1] | 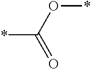 [SMILES: *OC(*)=O] | 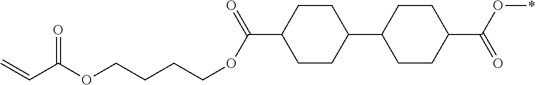 [SMILES: *OC(=O)C1CCC(C2CCC(C(=O)OCCCCOC(=O)C=C)CC2)CC1] |
| 3-7 | 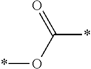 [SMILES: *OC(*)=O] | 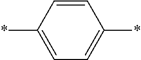 [SMILES: *c1ccc(*)cc1] | 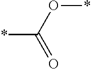 [SMILES: *OC(*)=O] | 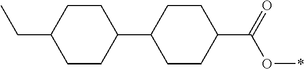 [SMILES: *OC(=O)C1CCC(C2CCC(CC)CC2)CC1] |
| 3-8 | 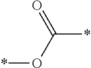 [SMILES: *OC(*)=O] | 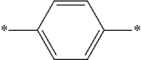 [SMILES: *c1ccc(*)cc1] | 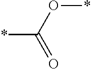 [SMILES: *OC(*)=O] | 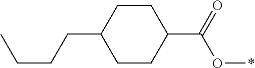 [SMILES: *OC(=O)C1CCC(CCCC)CC1] |
| 3-9 | 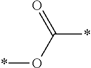 [SMILES: *OC(*)=O] | 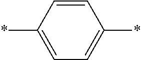 [SMILES: *c1ccc(*)cc1] | 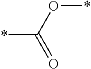 [SMILES: *OC(*)=O] | 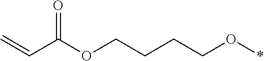 [SMILES: *OCCCCOC(=O)C=C] |
| 3-10 | 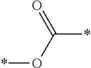 [SMILES: *OC(*)=O] | 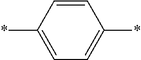 [SMILES: *c1ccc(*)cc1] | 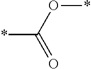 [SMILES: *OC(*)=O] | 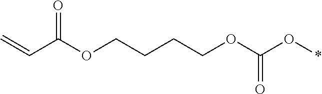 [SMILES: *OC(=O)OCCCCOC(=O)C=C] |

Table 4

| | D¹ | G¹ | D² | K |
|---|---|---|---|---|
| 4-1 | 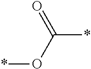 [SMILES: *OC(*)=O] | 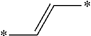 [SMILES: */C=C/*] | 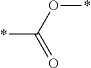 [SMILES: *OC(*)=O] | 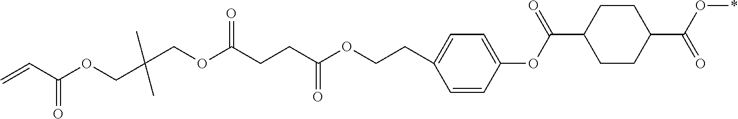 [SMILES: *OC(=O)C1CCC(C(=O)Oc2ccc(CCOC(=O)CCC(=O)OCC(C)(C)COC(=O)C=C)cc2)CC1] |
| 4-2 | 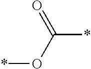 [SMILES: *OC(*)=O] | 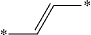 [SMILES: */C=C/*] | 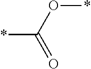 [SMILES: *OC(*)=O] | 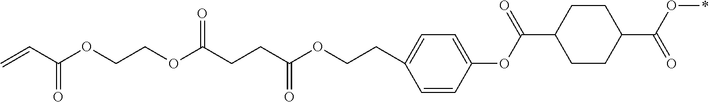 [SMILES: *OC(=O)C1CCC(C(=O)Oc2ccc(CCOC(=O)CCC(=O)OCCOC(=O)C=C)cc2)CC1] |
| 4-3 | 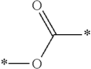 [SMILES: *OC(*)=O] | 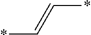 [SMILES: */C=C/*] | 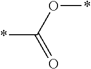 [SMILES: *OC(*)=O] | 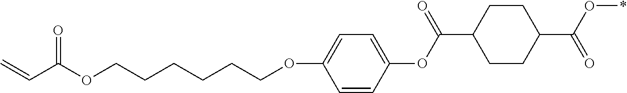 [SMILES: *OC(=O)C1CCC(C(=O)Oc2ccc(OCCCCCCOC(=O)C=C)cc2)CC1] |
| 4-4 | 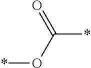 [SMILES: *OC(*)=O] | 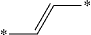 [SMILES: */C=C/*] | 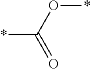 [SMILES: *OC(*)=O] | 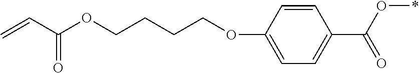 [SMILES: *OC(=O)c1ccc(OCCCCOC(=O)C=C)cc1] |
| 4-5 | 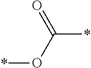 [SMILES: *OC(*)=O] | 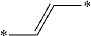 [SMILES: */C=C/*] | 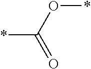 [SMILES: *OC(*)=O] | 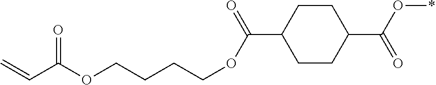 [SMILES: *OC(=O)C1CCC(C(=O)OCCCCOC(=O)C=C)CC1] |
| 4-6 | 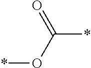 [SMILES: *OC(*)=O] | 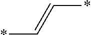 [SMILES: */C=C/*] | 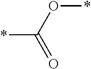 [SMILES: *OC(*)=O] | 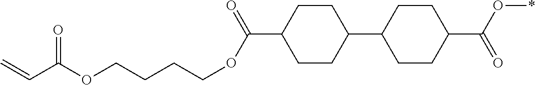 [SMILES: *OC(=O)C1CCC(C2CCC(C(=O)OCCCCOC(=O)C=C)CC2)CC1] |
| 4-7 | 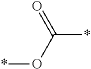 [SMILES: *OC(*)=O] | 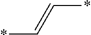 [SMILES: */C=C/*] | 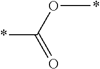 [SMILES: *OC(*)=O] | 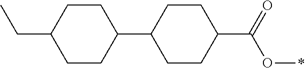 [SMILES: *OC(=O)C1CCC(C2CCC(CC)CC2)CC1] |
| 4-8 | 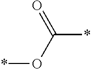 [SMILES: *OC(*)=O] | 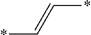 [SMILES: */C=C/*] | 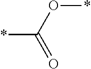 [SMILES: *OC(*)=O] | 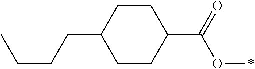 [SMILES: *OC(=O)C1CCC(CCCC)CC1] |
| 4-9 | 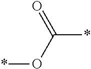 [SMILES: *OC(*)=O] | 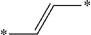 [SMILES: */C=C/*] | 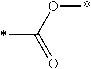 [SMILES: *OC(*)=O] | 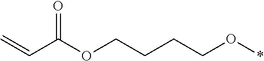 [SMILES: *OCCCCOC(=O)C=C] |
| 4-10 | 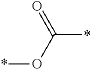 [SMILES: *OC(*)=O] | 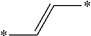 [SMILES: */C=C/*] | 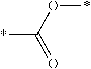 [SMILES: *OC(*)=O] | 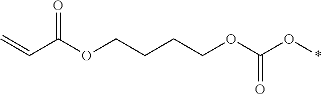 [SMILES: *OC(=O)OCCCCOC(=O)C=C] |

TABLE 5

| | D¹ | G¹ | D² | K |
|---|---|---|---|---|
| 5-1 | 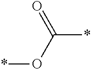 [SMILES: *OC(*)=O] | 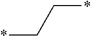 [SMILES: *CC*] | 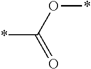 [SMILES: *OC(*)=O] | 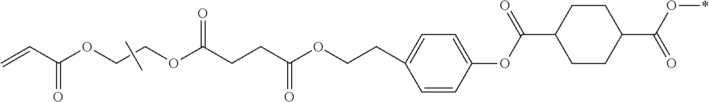 |
| 5-2 | 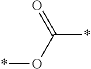 [SMILES: *OC(*)=O] | 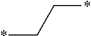 [SMILES: *CC*] | 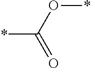 [SMILES: *OC(*)=O] | 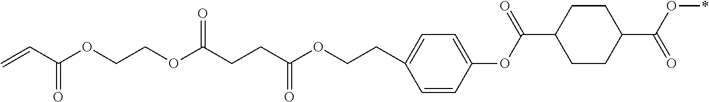 [SMILES: *OC(=O)C1CCC(C(=O)Oc2ccc(CCOC(=O)CCC(=O)OCCOC(=O)C=C)cc2)CC1] |
| 5-3 | 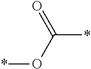 [SMILES: *OC(*)=O] | 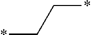 [SMILES: *CC*] | 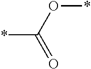 [SMILES: *OC(*)=O] | 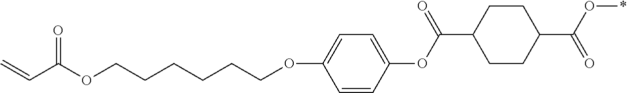 [SMILES: *OC(=O)C1CCC(C(=O)Oc2ccc(OCCCCCCOC(=O)C=C)cc2)CC1] |
| 5-4 | 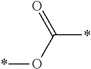 [SMILES: *OC(*)=O] | 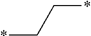 [SMILES: *CC*] | 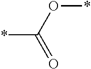 [SMILES: *OC(*)=O] | 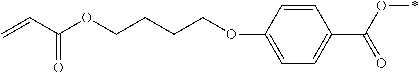 [SMILES: *OC(=O)c1ccc(OCCCCOC(=O)C=C)cc1] |
| 5-5 | 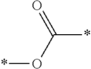 [SMILES: *OC(*)=O] | 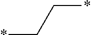 [SMILES: *CC*] | 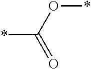 [SMILES: *OC(*)=O] | 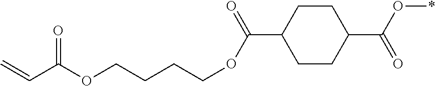 [SMILES: *OC(=O)C1CCC(C(=O)OCCCCOC(=O)C=C)CC1] |
| 5-6 | 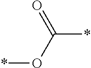 [SMILES: *OC(*)=O] | 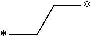 [SMILES: *CC*] | 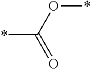 [SMILES: *OC(*)=O] | 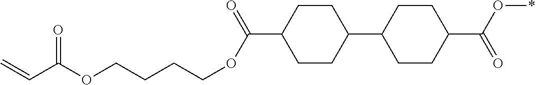 [SMILES: *OC(=O)C1CCC(C2CCC(C(=O)OCCCCOC(=O)C=C)CC2)CC1] |
| 5-7 | 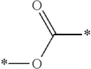 [SMILES: *OC(*)=O] | 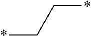 [SMILES: *CC*] | 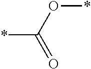 [SMILES: *OC(*)=O] | 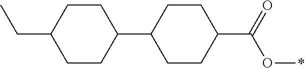 [SMILES: *OC(=O)C1CCC(C2CCC(CC)CC2)CC1] |
| 5-8 | 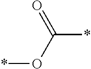 [SMILES: *OC(*)=O] | 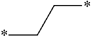 [SMILES: *CC*] | 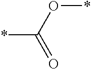 [SMILES: *OC(*)=O] | 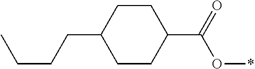 [SMILES: *OC(=O)C1CCC(CCCC)CC1] |
| 5-9 | 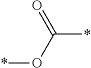 [SMILES: *OC(*)=O] | 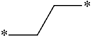 [SMILES: *CC*] | 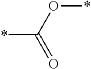 [SMILES: *OC(*)=O] | 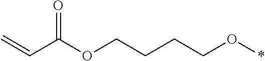 [SMILES: *OCCCCOC(=O)C=C] |
| 5-10 | 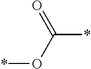 [SMILES: *OC(*)=O] | 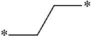 [SMILES: *CC*] | 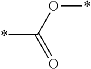 [SMILES: *OC(*)=O] | 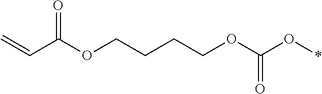 [SMILES: *OC(=O)OCCCCOC(=O)C=C] |

TABLE 6

| | D¹ | G¹ | D² | K |
|---|---|---|---|---|
| 6-1 | 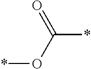 [SMILES: *OC(*)=O] | Single bond | 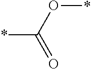 [SMILES: *OC(*)=O] | 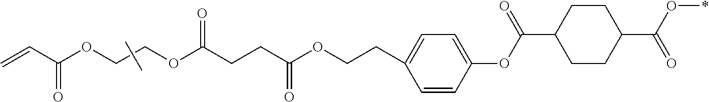 |
| 6-2 | 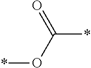 [SMILES: *OC(*)=O] | Single bond | 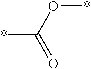 [SMILES: *OC(*)=O] | 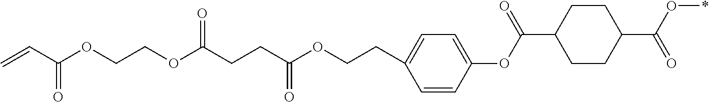 [SMILES: *OC(=O)C1CCC(C(=O)Oc2ccc(CCOC(=O)CCC(=O)OCCOC(=O)C=C)cc2)CC1] |
| 6-3 | 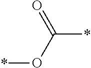 [SMILES: *OC(*)=O] | Single bond | 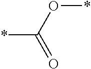 [SMILES: *OC(*)=O] | 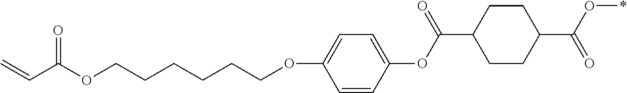 [SMILES: *OC(=O)C1CCC(C(=O)Oc2ccc(OCCCCCCOC(=O)C=C)cc2)CC1] |
| 6-4 | 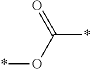 [SMILES: *OC(*)=O] | Single bond | 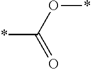 [SMILES: *OC(*)=O] | 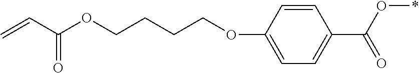 [SMILES: *OC(=O)c1ccc(OCCCCOC(=O)C=C)cc1] |
| 6-5 | 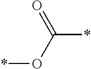 [SMILES: *OC(*)=O] | Single bond | 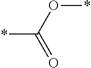 [SMILES: *OC(*)=O] | 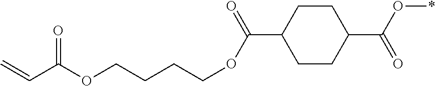 [SMILES: *OC(=O)C1CCC(C(=O)OCCCCOC(=O)C=C)CC1] |
| 6-6 | 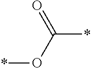 [SMILES: *OC(*)=O] | Single bond | 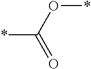 [SMILES: *OC(*)=O] | 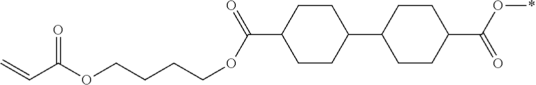 [SMILES: *OC(=O)C1CCC(C2CCC(C(=O)OCCCCOC(=O)C=C)CC2)CC1] |
| 6-7 | 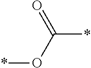 [SMILES: *OC(*)=O] | Single bond | 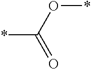 [SMILES: *OC(*)=O] | 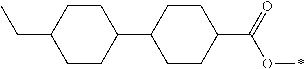 [SMILES: *OC(=O)C1CCC(C2CCC(CC)CC2)CC1] |
| 6-8 | 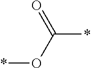 [SMILES: *OC(*)=O] | Single bond | 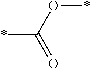 [SMILES: *OC(*)=O] | 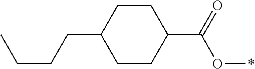 [SMILES: *OC(=O)C1CCC(CCCC)CC1] |
| 6-9 | 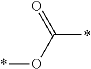 [SMILES: *OC(*)=O] | Single boad | 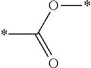 [SMILES: *OC(*)=O] | 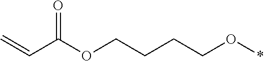 [SMILES: *OCCCCOC(=O)C=C] |
| 6-10 | 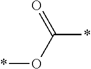 [SMILES: *OC(*)=O] | Single bond | 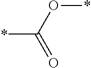 [SMILES: *OC(*)=O] | 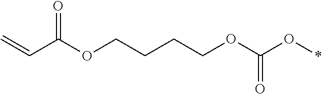 [SMILES: *OC(=O)OCCCCOC(=O)C=C] |

TABLE 7

| | D¹ | G¹ | D² | K |
|---|---|---|---|---|
| 7-1 | 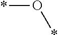 [SMILES: *O*] | 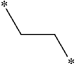 [SMILES: *CC*] | 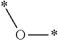 [SMILES: *O*] | 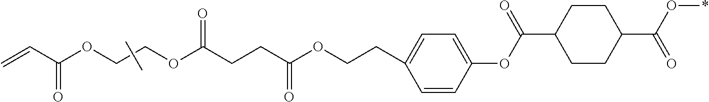 |
| 7-2 | 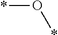 [SMILES: *O*] | 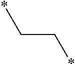 [SMILES: *CC*] | 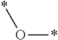 [SMILES: *O*] | 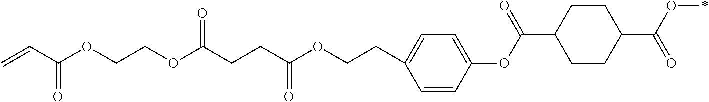 [SMILES: *OC(=O)C1CCC(C(=O)Oc2ccc(CCOC(=O)CCC(=O)OCCOC(=O)C=C)cc2)CC1] |
| 7-3 | 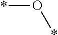 [SMILES: *O*] | 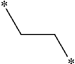 [SMILES: *CC*] | 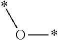 [SMILES: *O*] | 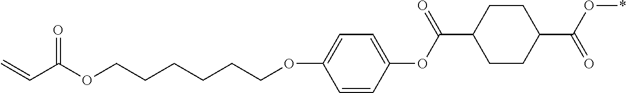 [SMILES: *OC(=O)C1CCC(C(=O)Oc2ccc(OCCCCCCOC(=O)C=C)cc2)CC1] |
| 7-4 | 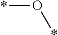 [SMILES: *O*] | 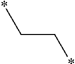 [SMILES: *CC*] | 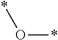 [SMILES: *O*] | 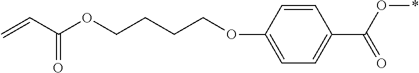 [SMILES: *OC(=O)c1ccc(OCCCCOC(=O)C=C)cc1] |
| 7-5 | 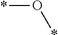 [SMILES: *O*] | 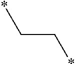 [SMILES: *CC*] | 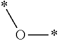 [SMILES: *O*] | 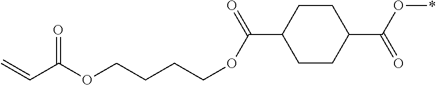 [SMILES: *OC(=O)C1CCC(C(=O)OCCCCOC(=O)C=C)CC1] |
| 7-6 | 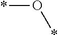 [SMILES: *O*] | 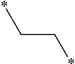 [SMILES: *CC*] | 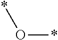 [SMILES: *O*] | 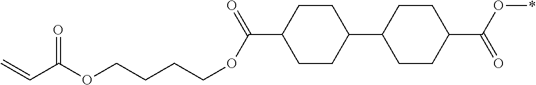 [SMILES: *OC(=O)C1CCC(C2CCC(C(=O)OCCCCOC(=O)C=C)CC2)CC1] |
| 7-7 | 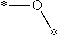 [SMILES: *O*] | 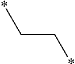 [SMILES: *CC*] | 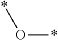 [SMILES: *O*] | 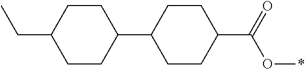 [SMILES: *OC(=O)C1CCC(C2CCC(CC)CC2)CC1] |
| 7-8 | 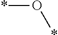 [SMILES: *O*] | 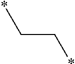 [SMILES: *CC*] | 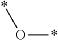 [SMILES: *O*] | 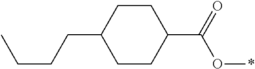 [SMILES: *OC(=O)C1CCC(CCCC)CC1] |
| 7-9 | 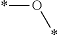 [SMILES: *O*] | 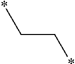 [SMILES: *CC*] | 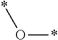 [SMILES: *O*] | 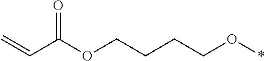 [SMILES: *OCCCCOC(=O)C=C] |
| 7-10 | 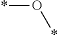 [SMILES: *O*] | 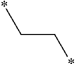 [SMILES: *CC*] | 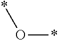 [SMILES: *O*] | 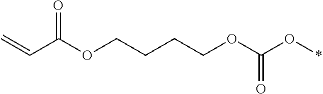 [SMILES: *OC(=O)OCCCCOC(=O)C=C] |

Table 8

| | D¹ | G¹ | D² | K |
|---|---|---|---|---|
| 8-1 | 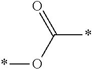 [SMILES: *OC(*)=O] | 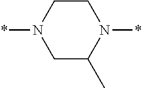 [SMILES: *N1CCN(*)C(C)C1] | 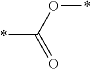 [SMILES: *OC(*)=O] | 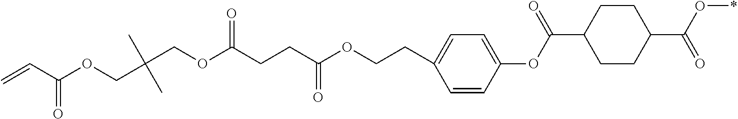 [SMILES: *OC(=O)C1CCC(C(=O)Oc2ccc(CCOC(=O)CCC(=O)OCC(C)(C)COC(=O)C=C)cc2)CC1] |
| 8-2 | 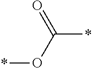 [SMILES: *OC(*)=O] | 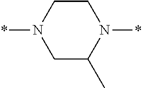 [SMILES: *N1CCN(*)C(C)C1] | 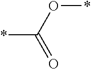 [SMILES: *OC(*)=O] | 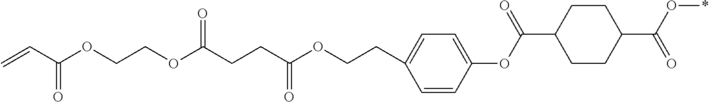 [SMILES: *OC(=O)C1CCC(C(=O)Oc2ccc(CCOC(=O)CCC(=O)OCCOC(=O)C=C)cc2)CC1] |
| 8-3 | 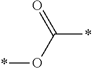 [SMILES: *OC(*)=O] | 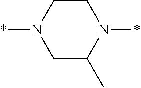 [SMILES: *N1CCN(*)C(C)C1] | 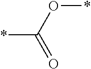 [SMILES: *OC(*)=O] | 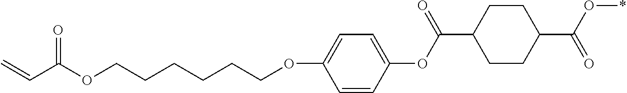 [SMILES: *OC(=O)C1CCC(C(=O)Oc2ccc(OCCCCCCOC(=O)C=C)cc2)CC1] |
| 8-4 | 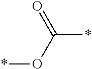 [SMILES: *OC(*)=O] | 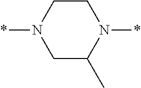 [SMILES: *N1CCN(*)C(C)C1] | 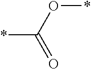 [SMILES: *OC(*)=O] | 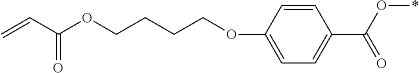 [SMILES: *OC(=O)c1ccc(OCCCCOC(=O)C=C)cc1] |
| 8-5 | 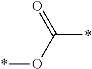 [SMILES: *OC(*)=O] | 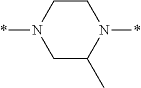 [SMILES: *N1CCN(*)C(C)C1] | 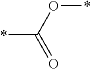 [SMILES: *OC(*)=O] | 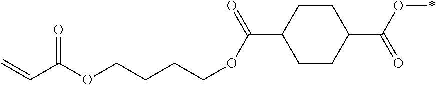 [SMILES: *OC(=O)C1CCC(C(=O)OCCCCOC(=O)C=C)CC1] |
| 8-6 | 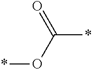 [SMILES: *OC(*)=O] | 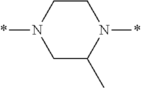 [SMILES: *N1CCN(*)C(C)C1] | 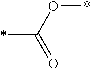 [SMILES: *OC(*)=O] | 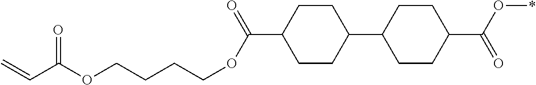 [SMILES: *OC(=O)C1CCC(C2CCC(C(=O)OCCCCOC(=O)C=C)CC2)CC1] |
| 8-7 | 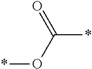 [SMILES: *OC(*)=O] | 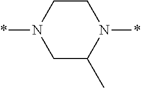 [SMILES: *N1CCN(*)C(C)C1] | 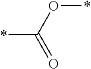 [SMILES: *OC(*)=O] | 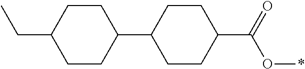 [SMILES: *OC(=O)C1CCC(C2CCC(CC)CC2)CC1] |
| 8-8 | 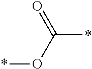 [SMILES: *OC(*)=O] | 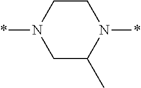 [SMILES: *N1CCN(*)C(C)C1] | 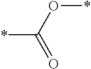 [SMILES: *OC(*)=O] | 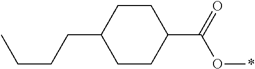 [SMILES: *OC(=O)C1CCC(CCCC)CC1] |
| 8-9 | 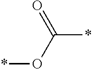 [SMILES: *OC(*)=O] | 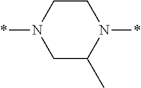 [SMILES: *N1CCN(*)C(C)C1] | 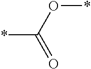 [SMILES: *OC(*)=O] | 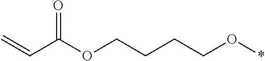 [SMILES: *OCCCCOC(=O)C=C] |
| 8-10 | 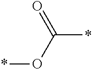 [SMILES: *OC(*)=O] | 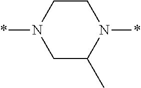 [SMILES: *N1CCN(*)C(C)C1] | 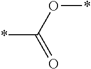 [SMILES: *OC(*)=O] | 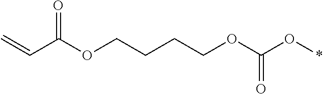 [SMILES: *OC(=O)OCCCCOC(=O)C=C] |

Table 9

| | D¹ | G¹ | G¹ | D² | K |
|---|---|---|---|---|---|
| 9-1 | 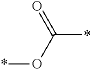 [SMILES: *OC(*)=O] | 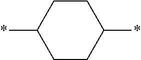 [SMILES: *C1CCC(*)CC1] | 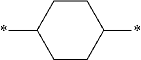 [SMILES: *C1CCC(*)CC1] | 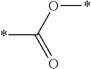 [SMILES: *OC(*)=O] | 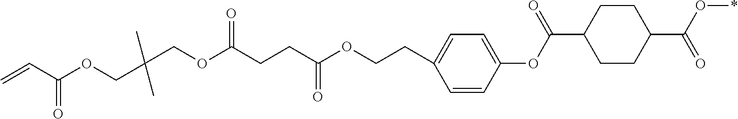 [SMILES: *OC(=O)C1CCC(C(=O)Oc2ccc(CCOC(=O)CCC(=O)OCC(C)(C)COC(=O)C=C)cc2)CC1] |
| 9-2 | 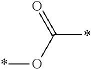 [SMILES: *OC(*)=O] | 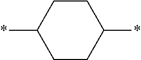 [SMILES: *C1CCC(*)CC1] | 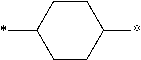 [SMILES: *C1CCC(*)CC1] | 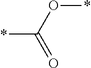 [SMILES: *OC(*)=O] | 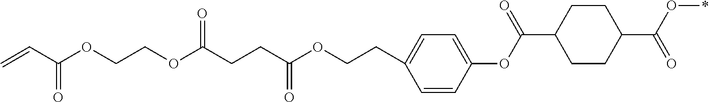 [SMILES: *OC(=O)C1CCC(C(=O)Oc2ccc(CCOC(=O)CCC(=O)OCCOC(=O)C=C)cc2)CC1] |
| 9-3 | 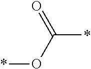 [SMILES: *OC(*)=O] | 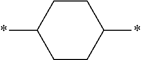 [SMILES: *C1CCC(*)CC1] | 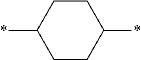 [SMILES: *C1CCC(*)CC1] | 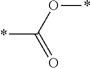 [SMILES: *OC(*)=O] | 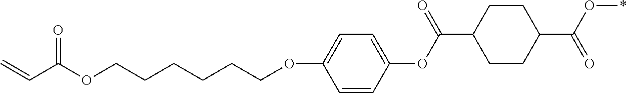 [SMILES: *OC(=O)C1CCC(C(=O)Oc2ccc(OCCCCCCOC(=O)C=C)cc2)CC1] |
| 9-4 | 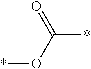 [SMILES: *OC(*)=O] | 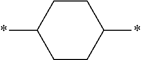 [SMILES: *C1CCC(*)CC1] | 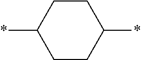 [SMILES: *C1CCC(*)CC1] | 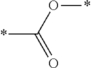 [SMILES: *OC(*)=O] | 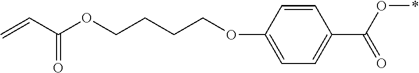 [SMILES: *OC(=O)c1ccc(OCCCCOC(=O)C=C)cc1] |
| 9-5 | 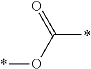 [SMILES: *OC(*)=O] | 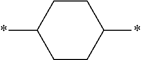 [SMILES: *C1CCC(*)CC1] | 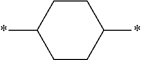 [SMILES: *C1CCC(*)CC1] | 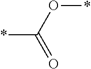 [SMILES: *OC(*)=O] | 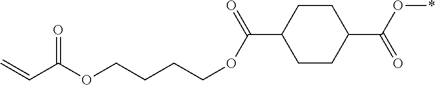 [SMILES: *OC(=O)C1CCC(C(=O)OCCCCOC(=O)C=C)CC1] |
| 9-6 | 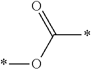 [SMILES: *OC(*)=O] | 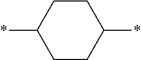 [SMILES: *C1CCC(*)CC1] | 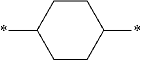 [SMILES: *C1CCC(*)CC1] | 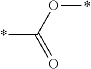 [SMILES: *OC(*)=O] | 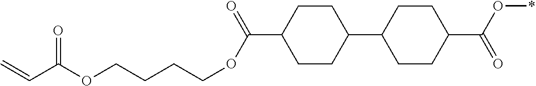 [SMILES: *OC(=O)C1CCC(C2CCC(C(=O)OCCCCOC(=O)C=C)CC2)CC1] |
| 9-7 | 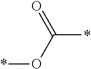 [SMILES: *OC(*)=O] | 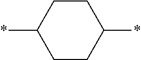 [SMILES: *C1CCC(*)CC1] | 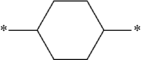 [SMILES: *C1CCC(*)CC1] | 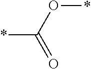 [SMILES: *OC(*)=O] | 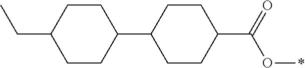 [SMILES: *OC(=O)C1CCC(C2CCC(CC)CC2)CC1] |
| 9-8 | 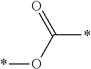 [SMILES: *OC(*)=O] | 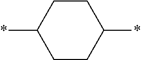 [SMILES: *C1CCC(*)CC1] | 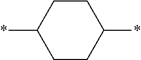 [SMILES: *C1CCC(*)CC1] | 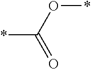 [SMILES: *OC(*)=O] | 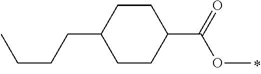 |
| 9-9 | 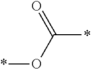 [SMILES: *OC(*)=O] | 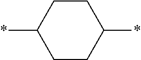 [SMILES: *C1CCC(*)CC1] | 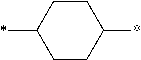 [SMILES: *C1CCC(*)CC1] | 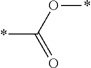 [SMILES: *OC(*)=O] | 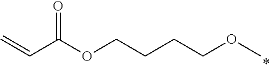 |
| 9-10 | 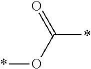 [SMILES: *OC(*)=O] | 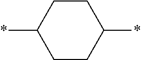 [SMILES: *C1CCC(*)CC1] | 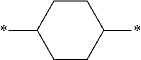 [SMILES: *C1CCC(*)CC1] | 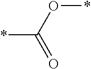 [SMILES: *OC(*)=O] | 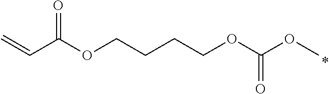 |

### [Surfactant (II) (Specific Surfactant)]

The surfactant (II) (specific surfactant) contained in the liquid crystal composition according to the embodiment of the present invention is a compound having a structure represented by Formula (2).

In addition, the surfactant (II) preferably has three or more of the structures represented by Formula (2), and more preferably has three to six of the structures represented by Formula (2).

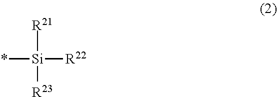

In Formula (2), * represents a bonding position.

In addition, R²¹, R²², and R²³ each independently represent an alkyl group, an alkenyl group, an aryl group, or an alkylene-aryl group.

Here, examples of the alkyl group include a linear alkyl group having 1 to 18 carbon atoms and a branched or cyclic alkyl group having 3 to 18 carbon atoms. Specific examples thereof include a methyl group, an ethyl group, a propyl group, a butyl group, an isopropyl group, a tert-butyl group, and a cyclohexyl group.

Examples of the alkenyl group include an alkenyl group having 2 to 12 carbon atoms. Specific examples thereof include a vinyl group, a 1-propenyl group, a 1-butenyl group, a 1-methyl-1-propenyl group, a 1-cyclopentenyl group, and a 1-cyclohexenyl group.

Examples of the aryl group include an aryl group having 6 to 12 carbon atoms. Specific examples thereof include a phenyl group, an α-methylphenyl group, and a naphthyl group.

Examples of the alkylene-aryl group include an alkylene-aryl group having 7 to 30 carbon atoms.

In the present invention, from the reason that a surface tension of the liquid crystal compositions decreases and wind marks can be further suppressed in the formation of the liquid crystal cured layer, all of R²¹, R²², and R²³ in Formula (2) preferably represent an alkyl group.

In the present invention, from the reason that the surface tension of the liquid crystal compositions decreases and the wind marks can be further suppressed in the formation of the liquid crystal cured layer, the surfactant (II) is preferably a compound having a structure represented by Formula (4).

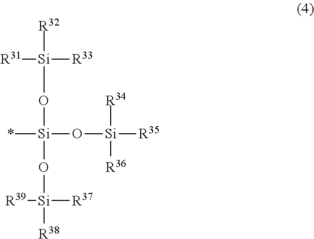

In Formula (4), * represents a bonding position.
R³¹ to R³⁹ each independently represent an alkyl group, an alkenyl group, an aryl group, or an alkylene-aryl group. Specific examples of these groups include the same groups as those described in R²¹, R²², and R²³ in Formula (2) above.

In the present invention, from the reason that the surface tension of the liquid crystal compositions decreases and the wind marks can be further suppressed in the formation of the liquid crystal cured layer, the surfactant (II) is also preferably a compound having a structure represented by Formula (5).

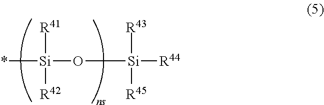

In Formula (5), * represents a bonding position.

R⁴¹ to R⁴⁵ each independently represent an alkyl group, an alkenyl group, an aryl group, or an alkylene-aryl group. Specific examples of these groups include the same groups as those described in R²¹, R²², and R²³ in Formula (2) above.

ns represents an integer of 1 to 15. In a case where ns is an integer of 2 to 15, a plurality of R⁴¹'s may be the same or different from each other and a plurality of R⁴²'s may be the same or different from each other.

### <Control of Uneven Distribution Properties of Specific Surfactant by HSP>

In the present invention, compatibility of the surfactant (II) with the above-described liquid crystal compound or a solvent described later can be controlled, and thus the wind marks and the cissing can be further suppressed.

Specifically, in the present invention, a solubility parameter (HSP) using a Hansen sphere method can be used for appropriately adjusting the compatibility.

That is, solubility parameters (δD, δP, and δH) of the solvent, the liquid crystal compound, and the surfactant are calculated using a commercially available software (HSPiP; Hansen Solubility Parameters in Practice), and a relative energy difference ΔHSP (compound 1, compound 2) between any compound 1 and any compound 2 is obtained as in Expression (H1).

### Expression (H1)

ΔHSP (compound 1, compound 2)=[{δD (compound 1)−δD (compound 2)}\hat{ }2+{δP (compound 1)−δP (compound 2)}\hat{ }2+{δH (compound 1)−δH (compound 2)}\hat{ }2]\hat{ }(1/2)
δD (compound 1): dispersion force term of the compound 1
δD (compound 2): dispersion force term of the compound 2
δP (compound 1): dipole-dipole force term of the compound 1
δP (compound 2): dipole-dipole force term of the compound 2
δH (compound 1): hydrogen bonding force term of the compound 1
δH (compound 2): hydrogen bonding force term of the compound 2

Here, in a case where two or more kinds of liquid crystal compounds (including the reverse dispersion compound (I) exhibiting liquid crystallinity) are contained in the liquid crystal composition according to the embodiment of the present invention, a value obtained by multiplying the solubility parameter of each liquid crystal compound by the content of the liquid crystal compound and performing a weighted average thereof is defined as the solubility parameter of a mixture of the liquid crystal compounds (defined as “liquid crystal mixture”). That is, the solubility parameter of the liquid crystal mixture is defined by the following expression.

$$δ D ( liquid crystal mixture ) = δ D ( liquid crystal compound 1 ) \times compositional ratio ( liquid crystal compound 1 ) + δ D ( liquid crystal compound 2 ) \times compositional ratio ( liquid crystal compound 2 ) + …$$

$$δ P ( liquid crystal mixture ) = δ P ( liquid crystal compound 1 ) \times compositional ratio ( liquid crystal compound 1 ) + δ P ( liquid crystal compound 2 ) \times compositional ratio ( liquid crystal compound 2 ) + …$$

$$δ H ( liquid crystal mixture ) = δ H ( liquid crystal compound 1 ) \times compositional ratio ( liquid crystal compound 1 ) + δ H ( liquid crystal compound 2 ) \times compositional ratio ( liquid crystal compound 2 ) + …$$

δD (liquid crystal compound i): dispersion force term of the liquid crystal compound i
δP (liquid crystal compound i): dipole-dipole force term of the liquid crystal compound i
δH (liquid crystal compound i): hydrogen bonding force term of the liquid crystal compound i

Compositional ratio (liquid crystal compound i): mass ratio of the liquid crystal compound i in a case where the liquid crystal mixture is set to 1

In the present invention, the relative energy difference between the liquid crystal mixture and the surfactant (II) is preferably 6 to 12, more preferably 6 to 11, still more preferably 6 to 9, and particularly preferably 7 to 9.

Here, the relative energy difference of the surfactant (II) with respect to the liquid crystal mixture means a distance between the solubility parameter of the surfactant (II) and the solubility parameter of the liquid crystal mixture, that is, the above-described relative energy difference ΔHSP.

### <Repeating Unit A>

In the present invention, from the reason that the surface tension of the liquid crystal compositions decreases and the wind marks can be further suppressed in the formation of the liquid crystal cured layer, it is preferable that the surfactant (II) is a polymer which contains a repeating unit A having the structure of Formula (2) described above (hereinafter, also abbreviated as “specific polymer”).

In the present invention, it is preferable that the above-described repeating unit A is a repeating unit having a structure represented by Formula (6), and it is more preferable that both the above-described repeating unit A and a repeating unit B described later are repeating units having a structure represented by Formula (6).

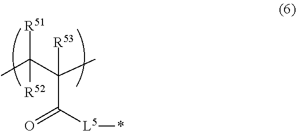

In Formula (6), * represents a bonding position.

In addition, R⁵¹ and R⁵² each independently represent a hydrogen atom or an alkyl group.

In addition, R⁵³ represents a hydrogen atom or a substituent.

In addition, L⁵ represents —O— or —NR^{Z}—. Here, R^{Z} represents a hydrogen atom or a substituent.

Here, examples of the alkyl group represented by one aspect of R⁵¹ and R⁵² include a linear alkyl group having 1 to 18 carbon atoms and a branched or cyclic alkyl group having 3 to 18 carbon atoms. Specific examples thereof include a methyl group, an ethyl group, a propyl group, a butyl group, an isopropyl group, a tert-butyl group, and a cyclohexyl group. R⁵¹ and R⁵² are preferably a hydrogen atom.

In addition, examples of the substituent represented by one aspect of R⁵³ include a substituent having an alkyl group, an alkenyl group, an aryl group, or a linking group, and having the structure of Formula (2) described above at a terminal. For example, —CH₂—CO-L¹-L²-(Si(R¹¹)(R¹²)(R¹³))m is also included. L¹ represents —O— or —NR^{Z}—. R¹¹, R¹², and R¹³ each independently represent an alkyl group, an alkenyl group, an aryl group, or an alkylene-aryl group. m represents an integer of 2 or more. L² represents an (m+1)-valent linking group.

R⁵³ is preferably an alkyl group, more preferably a linear alkyl group having 1 to 4 carbon atoms, and still more preferably a methyl group or an ethyl group. R⁵³ is preferably a hydrogen atom or a methyl group.

In addition, with regard to —NR^{Z}— represented by one aspect of L⁵, the substituent represented by one aspect of R^{Z} is preferably an alkyl group, more preferably a linear alkyl group having 1 to 4 carbon atoms, and still more preferably a methyl group or an ethyl group. L⁵ is preferably —O— or —NH—, and more preferably —O—.

In the present invention, from the reason that, while the compatibility with the liquid crystal compound is maintained, the surface tension of the liquid crystal compositions decreases and the wind marks can be further suppressed in the formation of the liquid crystal cured layer, the repeating unit A is preferably a repeating unit represented by Formula (6-1).

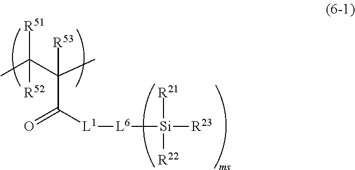

In Formula (6-1), R⁵¹, R⁵², R⁵³, and L⁵ are the same as those described in Formula (6) above.

In addition, R²¹, R²², and R²³ are the same as those described in Formula (2) above. Here, a plurality of R²¹'s may be the same or different from each other, a plurality of R²²'s may be the same or different from each other, and a plurality of R²³'s may be the same or different from each other.

In addition, ms represents an integer of 2 or more.

In addition, L⁶ represents an (ms+1)-valent linking group.

In Formula (7), ms is preferably an integer of 3 or more, more preferably an integer of 3 to 6, and still more preferably an integer of 3 to 5.

Suitable examples of the (ms+1)-valent linking group represented by L⁶ in Formula (7) include an (ms+1)-valent hydrocarbon group having 1 to 10 carbon atoms, which may have a substituent, in which a part of carbon atoms constituting the hydrocarbon group may be replaced with a heteroatom.

Here, as the substituent which may be included in the hydrocarbon group, an alkyl group is preferable, a linear alkyl group having 1 to 4 carbon atoms is more preferable, and a methyl group or an ethyl group is still more preferable.

In addition, examples of the heteroatom include a silicon atom, an oxygen atom, and a nitrogen atom.

Specific examples of the repeating unit A include repeating units corresponding to monomers represented by Formulae K-1 to K-34. Bu represents a butyl group.

In Examples described later, the monomer represented by Formula K-1 is referred to as “monomer K-1”. The same applies to other monomers.

In addition, the monomer represented by Formula K-29 is a mixture of monomers having different numbers of —(O—Si(CH₃)₂)—, and thus the average value thereof is represented as n≈10. The same applies to the monomer represented by Formula K-30.

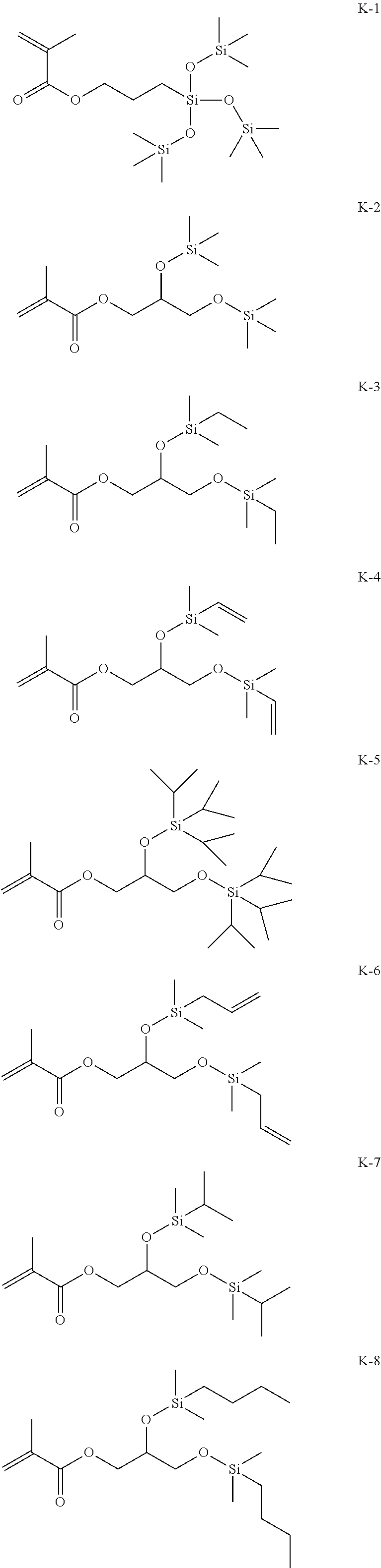

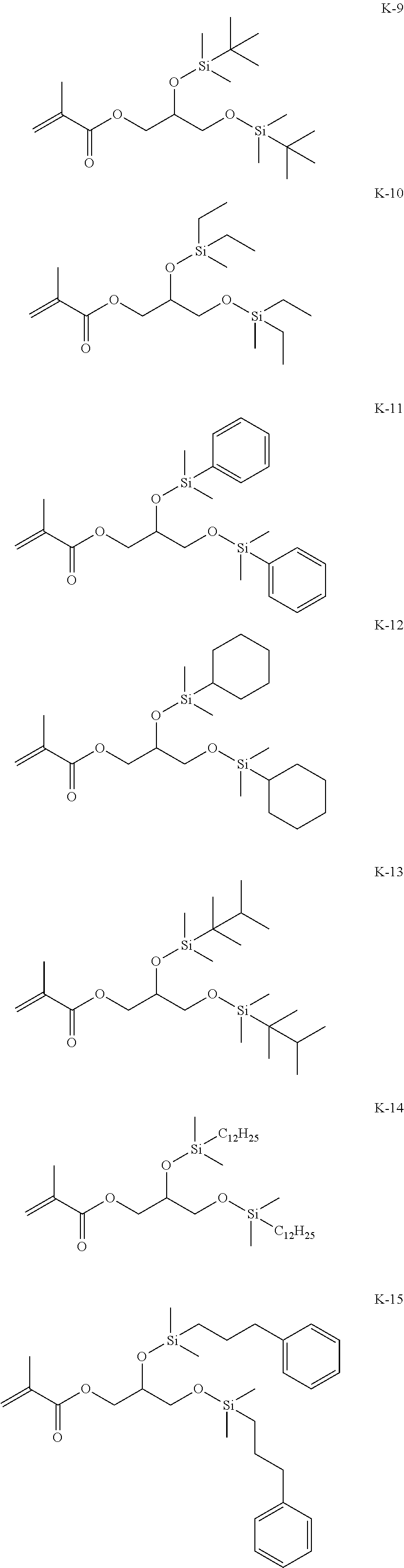

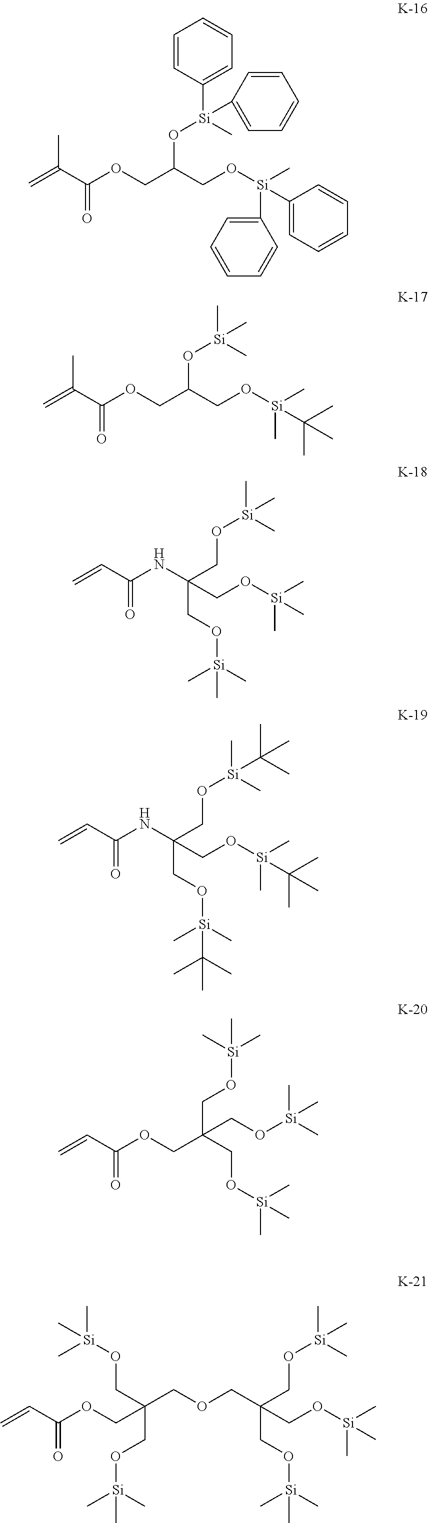

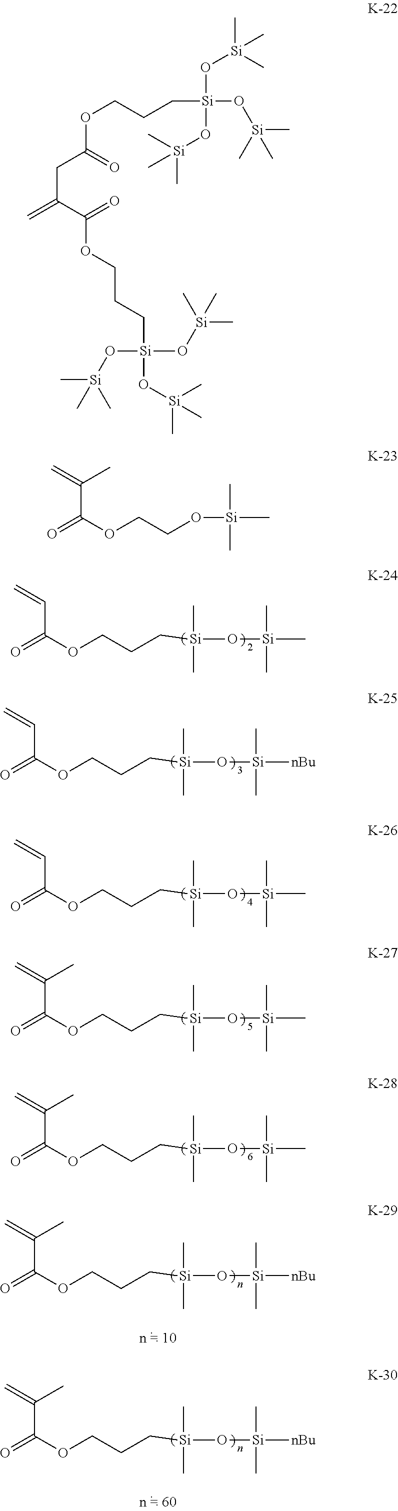

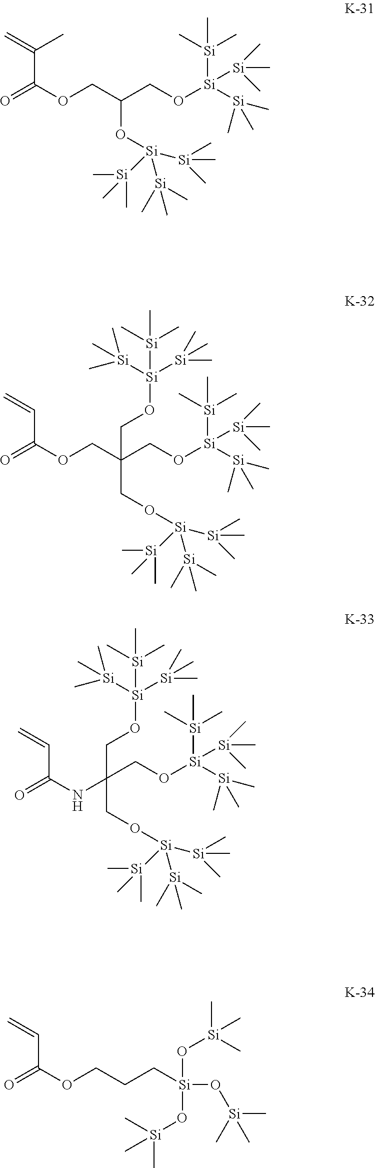

In the present invention, a content of the repeating unit A in the specific polymer (surfactant (II)) is preferably 40% by mass or more and 90% by mass or less and more preferably 50% by mass or more and 800% by mass or less with respect to the mass of the specific polymer.

Here, in a case where the content of the above-described repeating unit A is 40% by mass or more, the wind marks are further suppressed in the formation of the liquid crystal cured layer; and in a case where the content of the above-described repeating unit A is 90% by mass or less, the cissing is further suppressed in the formation of the liquid crystal cured layer, and the aligning properties of the liquid crystal cured layer are further improved.

In the present invention, since aggregation of the surfactant (II) is prevented and the cissing is suppressed, it is preferable that the surfactant (II) is a polymer containing two or more kinds of the repeating units A having different structures.

### <Repeating Unit B>

In order to control the compatibility with the above-described liquid crystal compound and the solvent described later and to adjust the surface tension during the process from coating to drying, the surfactant (II) is preferably a polymer containing one or more repeating units B not having the structure of Formula (2) described above, in addition to the repeating unit A (hereinafter, also abbreviated as “specific copolymer”).

Here, in a case where the surfactant (II) is the specific copolymer, the surfactant (II) may be a random copolymer or a block copolymer; but from the viewpoint of compatibility with other components in the liquid crystal composition, the surfactant (II) is preferably a random copolymer. The surfactant (II) (specific surfactant) used in Examples described later is a random copolymer unless otherwise specified.

A structure of a main chain of the repeating unit B is not particularly limited, and examples thereof include known structures. For example, a skeleton selected from the group consisting of a (meth)acrylic skeleton, a (meth)acrylamide-based skeleton, a styrene-based skeleton, a siloxane-based skeleton, a cycloolefin-based skeleton, a methylpentene-based skeleton, and an aromatic ester-based skeleton is preferable.

Among these, a skeleton selected from the group consisting of a (meth)acrylic skeleton, a (meth)acrylamide-based skeleton, a siloxane-based skeleton, and a cycloolefin-based skeleton is more preferable, and a (meth)acrylic skeleton or a (meth)acrylamide-based skeleton is still more preferable.

In the present invention, a relative energy difference of the monomer of the repeating unit B with respect to the liquid crystal mixture is preferably 1 to 8, more preferably 3 to 7, and still more preferably 4 to 7.

Here, the relative energy difference of the monomer of the repeating unit B with respect to the liquid crystal mixture means a distance between a solubility parameter of the monomer of the repeating unit B and the solubility parameter of the liquid crystal mixture, that is, the above-described relative energy difference ΔHSP.

In the present invention, it is preferable that the repeating unit B is a repeating unit containing a functional group which reacts with light or heat to form a crosslink.

Examples of the above-described functional group include a radically polymerizable group and a cationically polymerizable group, and a radically polymerizable group is preferable. Examples of the above-described functional group also include a functional group capable of forming a covalent complex with a hydroxyl group.

A known radically polymerizable group can be used as the radically polymerizable group; and examples thereof include a vinyl group, an allyl group, a vinyloxy group, a maleimide group, an allyloxy group, a (meth)acryloyl group, a (meth)acryloyloxy group, and a (meth)acrylamide group. Among these, a (meth)acryloyl group or a (meth)acryloyloxy group is preferable.

A known cationically polymerizable group can be used as the cationically polymerizable group; and examples thereof include an alicyclic ether group, a cyclic acetal group, a cyclic lactone group, a cyclic thioether group, a spiroorthoester group, and a vinyloxy group. Among these, an alicyclic ether group or a vinyloxy group is preferable, and an epoxy group, an oxetanyl group, or a vinyloxy group is more preferable.

As the functional group capable of forming a covalent complex with a hydroxyl group, a boronic acid group (—B(OH)₂) or a boronic acid ester group (—B(OR^{B1})₂) is preferable.

R^{B1} represents a hydrogen atom, an alkyl group which may have a substituent, an aryl group which may have a substituent, or a heteroaryl group which may have a substituent; and a hydrogen atom or an alkyl group which may have a substituent is preferable.

The number of carbon atoms in the alkyl group is preferably 1 to 10 and more preferably 1 to 5.

The number of carbon atoms in the aryl group is preferably 4 to 20 and more preferably 6 to 12. Examples of the aryl group include a phenyl group.

The number of carbon atoms in the heteroaryl group is preferably 3 to 10 and more preferably 3 to 5. Examples of a heteroatom contained in the heteroaryl group include an oxygen atom, a nitrogen atom, and a sulfur atom.

R^{B1}'s may be bonded to each other to form a ring. The number of ring members in the ring formed by bonding R^{B1}'s to each other is preferably 4 to 8 and more preferably 5 or 6.

The number of the above-described functional groups contained in the repeating unit B is preferably 1 or more, more preferably 1 to 3, and still more preferably 1 or 2.

As the repeating unit B having the above-described functional group, from the viewpoint of more excellent compatibility with the liquid crystal compound, a repeating unit represented by Formula (b1) is preferable.

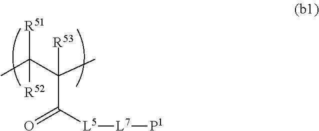

In Formula (b1), R⁵¹, R⁵², R⁵³, and L⁵ are the same as those described in Formula (6-1) above.

In Formula (b1), L⁷ represents a single bond or a divalent linking group.

Examples of the above-described divalent linking group include a divalent aliphatic hydrocarbon group having 1 to 20 carbon atoms, which may have a substituent.

As the above-described divalent aliphatic hydrocarbon group having 1 to 20 carbon atoms, an alkylene group having 1 to 15 carbon atoms is preferable, and an alkylene group having 2 to 8 carbon atoms is more preferable.

One or more of —CH₂-'s constituting the above-described divalent aliphatic hydrocarbon group may be each independently replaced with a group selected from —O—, —S—, —CO—, and —N(Q)-. Two or more of —CH₂-'s may be substituted as long as the same group is not adjacent to each other. The definition and suitable aspects of Q are as described above.

Among these, as L⁷, an alkylene group having 2 to 8 carbon atoms, which may have a substituent, or *-(L⁷¹-O)ₙ₇—* is preferable. * represents a bonding position. n7 represents an integer of 1 to 8. L⁷¹'s each independently represent an alkylene group having 1 to 6 carbon atoms, which may have a substituent; and an alkylene group having 2 to 4 carbon atoms, which may have a substituent, is preferable.

The divalent linking group represented by L⁷ may be a group including a mesogen group. As the group including a mesogen group, *—SP¹—M¹—* is preferable. * represents a bonding position. SP¹ represents a spacer group, and M¹ represents the mesogen group.

The spacer group is not particularly limited as long as it is a divalent linking group which does not have a ring structure; and examples thereof include a divalent chain-like aliphatic hydrocarbon group having 1 to 20 carbon atoms.

As the above-described divalent chain-like aliphatic hydrocarbon group having 1 to 20 carbon atoms, an alkylene group having 1 to 15 carbon atoms is preferable, and an alkylene group having 1 to 8 carbon atoms is more preferable. Specific suitable examples thereof include a methylene group, an ethylene group, a propylene group, a butylene group, a pentylene group, a hexylene group, a methylhexylene group, and a heptylene group.

One or more of —CH₂-'s constituting the above-described divalent chain-like aliphatic hydrocarbon group may be each independently replaced with a group selected from —O—, —S—, —CO—, or —N(Q)-. Two or more of —CH₂-'s may be substituted as long as the same group is not adjacent to each other. Q represents a hydrogen atom or a substituent. The substituent represented by Q is preferably an alkyl group, more preferably a linear alkyl group having 1 to 4 carbon atoms, and still more preferably a methyl group or an ethyl group.

Among these, as the above-described spacer group, *—(CH₂—CH₂—O)ₙ₁—*, *—(CH₂)ₙ₂—O—*, or *—(CH₂)ₙ₂—O—CO—* is preferable. * represents a bonding position. n1 represents an integer of 1 to 4. n2's each independently represent an integer of 1 to 6, and are preferably an integer of 2 to 4.

As the above-described mesogen group, a known mesogen group can be used, and for example, descriptions particularly on pages 7 to 16 of “Flussige Kristalle in Tabellen II” (VEB Deutsche Verlag fur Grundstoff Industrie, Leipzig, 1984) and descriptions particularly in Chapter 3 of “Liquid Crystal Handbook” (Maruzen, 2000) edited by Liquid Crystals Handbook Editing Committee can be referred to.

As the mesogen group, a group having at least one cyclic structure selected from the group consisting of an aromatic hydrocarbon group, a heterocyclic group, and an alicyclic group is preferable.

From the reason that an alignment degree of the liquid crystal compound is improved, the mesogen group is preferably a group having an aromatic hydrocarbon group which may have a substituent or a group having an alicyclic group which may have a substituent, more preferably a group having two to four aromatic hydrocarbon groups which may have a substituent, and still more preferably a group having three aromatic hydrocarbon groups which may have a substituent. The substituent is preferably an alkyl group, an alkoxy group, an alkyl ester group, or an acetyl group, and more preferably a methyl group, a tert-butyl group, a methoxy group, or a methyl ester group.

Examples of the substituent which may be contained in the above-described divalent linking group include a hydroxy group, a halogen atom, an amino group, an alkyl group, an alkoxy group, an acyl group, an aryl group, a nitro group, a cyano group, an alkylcarbonyl group, and a sulfonyl group.

In Formula (b1), P¹ represents a radically polymerizable group or a cationically polymerizable group. Suitable aspects of the radically polymerizable group or the cationically polymerizable group are as described above.

Specific examples of the repeating unit having a polymerizable group include repeating units shown below. In the following repeating units, n represents an integer of 1 or more (typically, an integer of 1 to 6).

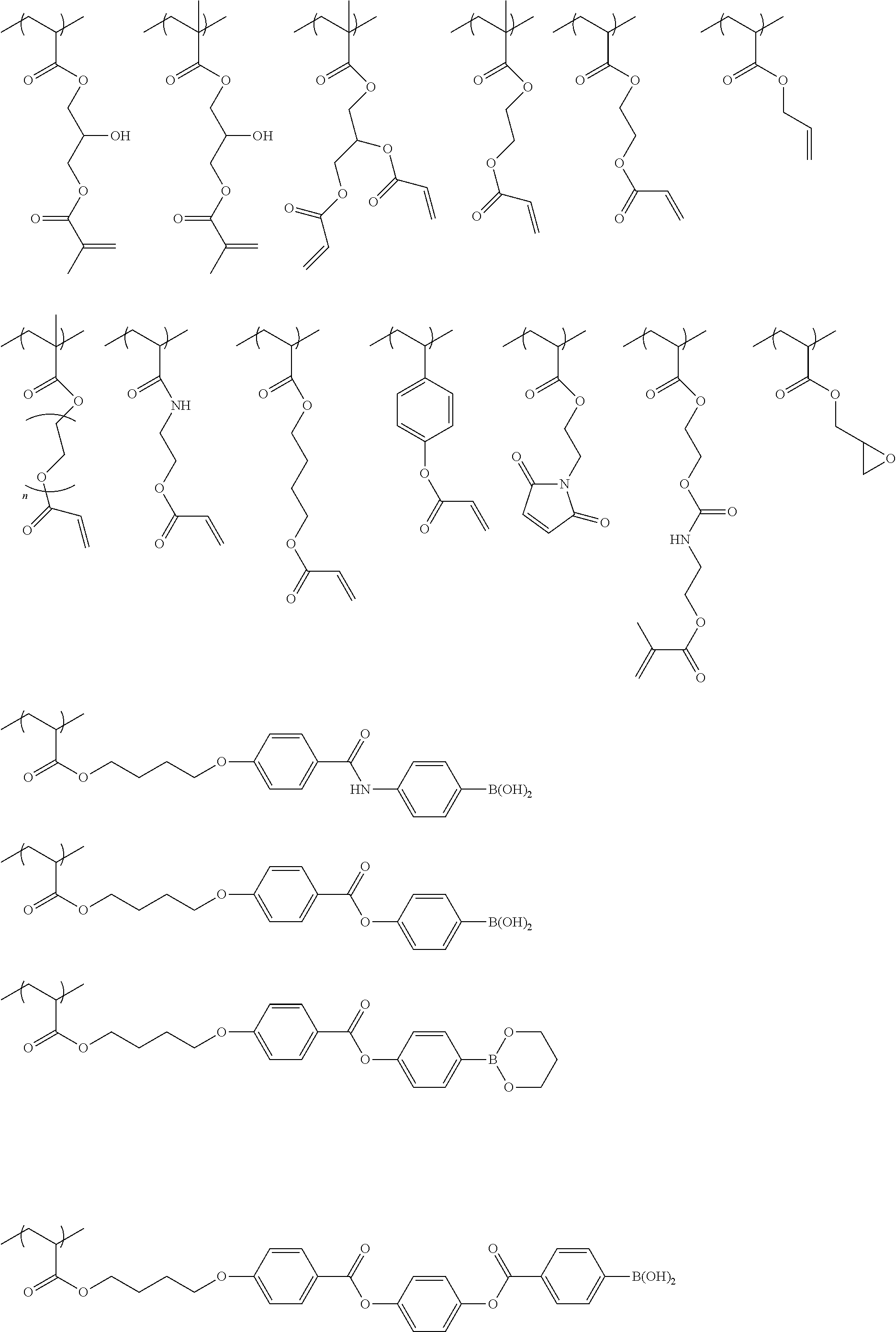

In the present invention, from the viewpoint that it is easy to synthesize and has excellent controllability of the solubility parameter by adjusting the following np and nq, the repeating unit B is preferably a repeating unit having a structure represented by Formula (7).

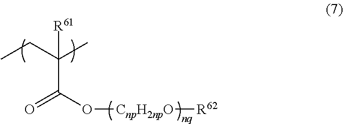

In Formula (7), R⁶¹ represents a hydrogen atom or a methyl group.

In addition, R⁶² represents a hydrogen atom or an alkyl group having 1 to 18 carbon atoms.

In addition, np represents an integer of 1 to 4 and nq represents an integer of 1 to 100.

In addition, the repeating unit B is preferably a repeating unit having any of a hydroxy group, a boronic acid group, a boronic acid ester group, a boronic acid amide group, an epoxy group, an oxetane group, a vinyl group, a styryl group, a (meth)acryloyl group (including a (meth)acrylamide group), a maleimide group, a naphthyl group, or a mesogen group.

Specific examples of the structure of the repeating unit B having a mesogen group include compounds described in WO2023/54164A.

In the present invention, a content of the repeating unit B in the specific copolymer is preferably 0% to 50% by mass and more preferably 10% to 50% by mass with respect to the mass of the specific copolymer.

In the present invention, since the aggregation of the surfactant (II) in the composition is prevented and the cissing is suppressed, in a case where a solution containing 0.08% by mass of the surfactant (II) and containing cyclopentanone and methyl ethyl ketone with a mass ratio of 4:1 is prepared, the surfactant (II) is preferably a surfactant with which a surface tension of the solution is 22 mN/m or more.

In addition, from the viewpoint that the surface tension of the composition is stabilized and the wind marks are suppressed, the surfactant (II) is preferably a surfactant in which the surface tension of the above-described solution is 30 mN/m or less, and more preferably a surfactant in which the surface tension of the above-described solution is 27 mN/m or less.

Here, the surface tension of the above-described solution is a value measured twice by a static surface tension meter (model number: CBVP—Z) manufactured by Kyowa Interface Science Co., Ltd.

Since the aggregation of the surfactant (II) is prevented and the cissing is suppressed, it is preferable that the liquid crystal composition according to the embodiment of the present invention contains two or more kinds of the surfactants (II) having different structures.

### <Content>

From the viewpoint that the effect of the present invention is more excellent, a content of the surfactant (II) is preferably 0.01% to 10% by mass, more preferably 0.02% to 1% by mass, and still more preferably 0.04% to 0.5% by mass with respect to the total solid content (100% by mass) of the liquid crystal composition.

In addition, since the aggregation of the surfactant (II) is prevented and the cissing and the wind marks are suppressed, the content of the surfactant (II) is preferably 0.1 parts by mass or less with respect to 100 parts by mass of the liquid crystal compound. Here, in a case where the reverse dispersion compound (I) is a liquid crystal compound, the “100 parts by mass of the liquid crystal compound” as a reference of the content of the surfactant (II) is 100 parts by mass of the total amount of liquid crystal compounds including the reverse dispersion compound (I).

### <Molecular Weight>

A weight-average molecular weight (Mw) of the surfactant (II) is preferably 7,000 to 40,000, more preferably 7,000 to 30,000, and still more preferably 7,000 to 15,000.

In a case where the weight-average molecular weight is 7,000 or more, the wind marks are further suppressed in the formation of the liquid crystal cured layer; and in a case where the weight-average molecular weight is 15,000 or less, the aligning properties of the liquid crystal cured layer are further improved.

Here, the weight-average molecular weight in the present invention is a value measured by gel permeation chromatography (GPC).
Solvent (eluent): tetrahydrofuran
Apparatus name: EcoSEC HLC-8320GPC (manufactured by TOSOH Corporation)
Column: three columns of TSKgel SuperHZM-H, TSKgel SuperHZ4000, and TSKgel SuperHZ200 (all manufactured by TOSOH Corporation) are connected and used.
Column temperature: 40° C.
Sample Concentration: 0.1% by mass
Flow rate: 0.35 mL/min
   Calibration curve: TSK standard polystyrene (manufactured by TOSOH Corporation), calibration curves of 6 samples with Mw of 706,000 to 1,013 (Mw/Mn=1.03 to 1.06) are used

### [Solvent]

From the viewpoint of workability and the like, it is preferable that the liquid crystal composition according to the embodiment of the present invention contains a solvent.

Examples of the solvent include organic solvents such as ketones (such as acetone, 2-butanone, methyl ethyl ketone, methyl isobutyl ketone, cyclopentanone, and cyclohexanone), ethers (such as dioxane, tetrahydrofuran, tetrahydropyran, dioxolane, tetrahydrofurfuryl alcohol, and cyclopentyl methyl ether), aliphatic hydrocarbons (such as hexane), alicyclic hydrocarbons (such as cyclohexane), aromatic hydrocarbons (such as benzene, toluene, xylene, and trimethylbenzene), halogenated carbons (such as dichloromethane, trichloromethane (chloroform), dichloroethane, dichlorobenzene, and chlorotoluene), esters (such as methyl acetate, ethyl acetate, ethyl propionate, butyl acetate, and diethyl carbonate), alcohols (such as ethanol, isopropanol, butanol, and cyclohexanol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine), and water.

These solvents may be used alone or in combination of two or more kinds thereof.

Among these solvents, from the viewpoint of further improving the aligning properties of the liquid crystal cured layer to be formed and further improving heat resistance, it is preferable to use an organic solvent, and it is more preferable to use ketones and/or esters.

In the present invention, from the reason that the aligning properties of the liquid crystal composition are favorable, it is preferable that the solvent includes a high-boiling point solvent having a boiling point of 130° C. or higher.

In addition, a content of the above-described high-boiling point solvent is preferably 150 parts by mass or more, and more preferably 150 to 1,000 parts by mass with respect to 100 parts by mass of the liquid crystal compound. Here, in a case where the reverse dispersion compound (I) is a liquid crystal compound, the “100 parts by mass of the liquid crystal compound” as a reference of the content of the high-boiling point solvent is 100 parts by mass of the total amount of liquid crystal compounds including the reverse dispersion compound (I).

### [Polymerization Initiator]

The liquid crystal composition according to the embodiment of the present invention may contain a polymerization initiator.

The polymerization initiator is not particularly limited, but a compound having photosensitivity, that is, a photopolymerization initiator is preferable.

As the photopolymerization initiator, various compounds can be used without any particular limitation.

Examples of the photopolymerization initiator include an α-carbonyl compound, acyloin ether, an α-hydrocarbon-substituted aromatic acyloin compound, a polynuclear quinone compound, a combination of a triarylimidazole dimer and p-aminophenyl ketone, an acridine and phenazine compound, an oxadiazole compound, an o-acyloxime compound, and an acylphosphine oxide compound.

Commercially available products can also be used as such a photopolymerization initiator, and examples thereof include IRGACURE-184, IRGACURE-907, IRGACURE-369, IRGACURE-651, IRGACURE-819, IRGACURE-OXE-01, and IRGACURE-OXE-02, manufactured by BASF SE.

In a case where the liquid crystal composition contains a polymerization initiator, a content of the polymerization initiator is preferably 0.01% to 30% by mass and more preferably 0.1% to 10% by mass with respect to the total solid content (100% by mass) of the liquid crystal composition.

### [Optically Anisotropic Layer]

The optically anisotropic layer according to the embodiment of the present invention is an optically anisotropic layer consisting of a liquid crystal cured layer obtained by fixing an alignment state of the above-described liquid crystal composition according to the embodiment of the present invention.

The alignment state of the liquid crystal compound in the liquid crystal cured layer according to the present invention is preferably horizontal alignment. In the present specification, the “horizontal alignment” means that a main surface of the liquid crystal cured layer (or in a case where the liquid crystal cured layer is formed on a member such as a support and an alignment film, a surface of the member) and a major axis direction of the liquid crystal compound are parallel to each other. It is not required for both the main surface of the liquid crystal cured layer and the major axis direction of the liquid crystal compound to be strictly parallel; and in the present specification, the expression means that both the main surface of the liquid crystal cured layer and the major axis direction of the liquid crystal compound are aligned at an angle formed by the major axis direction of the liquid crystal compound and the main surface of the liquid crystal cured layer of less than 10°.

The optically anisotropic layer according to the embodiment of the present invention is preferably a positive A-plate.

Here, the positive A-plate is defined as follows.

In addition, the positive A-plate satisfies a relationship of Expression (A1). In the positive A-plate, Rth indicates a positive value.

In addition, the positive A-plate is preferably used in combination with a positive C-plate.

That is, the positive C-plate satisfies a relationship of Expression (C1) in a case where a refractive index in the slow axis direction in a film plane (in a direction such that the in-plane refractive index is maximum) is defined as nx, a refractive index in the in-plane direction orthogonal to the in-plane slow axis is defined as ny, and a thickness-direction refractive index is defined as nz. In the positive C-plate, Rth exhibits a negative value.

$$n x > ny \approx nz \qquad Expression ( A 1 )$$

$$nz > nx \approx ny \qquad Expression ( C 1 )$$

The symbol “˜” encompasses not only a case where both sides are completely the same as each other but also a case where the both sides are substantially the same as each other.

With regard to the positive A-plate, the expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”. In addition, in the positive C-plate, for example, a case where (nx−ny)×d (in which d is a thickness of a film) is 0 to 10 nm, and preferably 0 to 5 nm is also included in “nx≈ny”.

In a case where the liquid crystal cured layer according to the embodiment of the present invention is the positive A-plate, from the viewpoint that the retardation layer functions as a λ/4 plate, Re(550) is preferably 100 to 180 nm, more preferably 120 to 160 nm, still more preferably 130 to 150 nm, and particularly preferably 135 to 145 nm.

Here, the “λ/4 plate” is a plate having a λ/4 function, specifically, a plate having a function of converting linearly polarized light having a specific wavelength into circularly polarized light (or converting circularly polarized light into linearly polarized light).

A thickness of the optically anisotropic layer is not particularly limited, but is preferably 0.1 to 10 μm and more preferably 0.5 to 5 μm.

The optically anisotropic layer according to the embodiment of the present invention satisfies a relationship of Expression (3).

$$Re ( 450 ) / Re ( 550 ) < 1. \qquad ( 3 )$$

Here, Re(450) represents an in-plane retardation of the optically anisotropic layer at a wavelength of 450 nm, and Re(550) represents an in-plane retardation of the optically anisotropic layer at a wavelength of 550 nm.

From the viewpoint of preventing the wind marks, the optically anisotropic layer according to the embodiment of the present invention preferably has a surface free energy of 35 mN/m or less.

In addition, for the same reason, the surface free energy is preferably 24 mN/m or more.

Here, the surface free energy can be measured by a Kaelble-Wu method.

### [Optical Film]

The optical film according to the embodiment of the present invention is an optical film including the above-described optically anisotropic layer according to the embodiment of the present invention.

A structure of the optical film will be described with reference to the figure. The figure is a schematic cross-sectional view showing an example of the optical film.

The figure is a schematic view, and the thicknesses relationship, the positional relationship, and the like of the respective layers are not necessarily consistent with actual ones; and a support and an alignment film shown in the figure are optional constitutional members.

An optical film 10 shown in the figure includes, in the following order, a support 16, an alignment film 14, and an optically anisotropic layer 12 consisting of a liquid crystal cured layer obtained by fixing an alignment state of the liquid crystal composition according to the embodiment of the present invention.

In addition, the optically anisotropic layer 12 may be a laminate of two or more different liquid crystal cured layers. For example, in a case where the polarizing plate according to the embodiment of the present invention, which will be described later, is used as a circularly polarizing plate or in a case where the optical film according to the embodiment of the present invention is used as an optical compensation film for an in-plane-switching (IPS) mode or a fringe-field-switching (FFS) mode liquid crystal display device, the optically anisotropic layer 12 is preferably a laminate of a positive A-plate and a positive C-plate.

In addition, the optically anisotropic layer may be peeled off from the support and used alone as the optical film.

Hereinafter, various members used for the optical film will be described in detail.

### [Support]

The optical film may include a support as a base material for forming the optically anisotropic layer. Such a support is preferably transparent. Specifically, a light transmittance thereof is preferably 80% or more.

Examples of such a support include a glass substrate and a polymer film. Examples of a material of the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

A thickness of the above-described support is not particularly limited, but is preferably 5 to 100 m, and more preferably 5 to 50 μm. The support may be peelable from the optical film.

### [Alignment Film]

In the optical film, it is preferable that the optically anisotropic layer is formed on a surface of the alignment film. In a case where the optical film includes any of the above-described supports, the alignment film may be interposed between the support and the optically anisotropic layer. In addition, an aspect in which the above-described support may also function as the alignment film is also adopted. The alignment film may be peelable from the optical film.

In addition, the alignment film may have optical anisotropy, and a positive C-plate having an alignment function on a surface, as described in WO2021/166619A, may be used as the alignment film.

The alignment film may be any film as long as it has a function of aligning the polymerizable liquid crystal compound contained in the composition.

The alignment film generally contains a polymer as a main component. A polymer material for the alignment film is described in many documents, and many commercially available products can be used.

As the polymer material for the alignment film, polyvinyl alcohol, polyimide, or a derivative thereof is preferable, and a modified or unmodified polyvinyl alcohol is more preferable.

Since an object does not come into contact with a surface of the alignment film in the formation of the alignment film and the deterioration of a surface condition can be prevented, it is also preferable to use a photo-alignment film as the alignment film.

The photo-alignment film is not particularly limited; but an alignment film formed by a polymer material such as a polyamide compound and a polyimide compound described in paragraphs [0024] to [0043] of WO2005/096041A, a liquid crystal alignment film formed by a liquid crystal aligning agent having a cinnamoyl group described in JP2012-155308A, trade name LPP-JP265CP manufactured by Rolic Technologies Ltd., or the like can be used.

A thickness of the alignment film is not particularly limited, but from the viewpoint of forming a liquid crystal cured layer having a uniform film thickness by relaxing the surface roughness which can be present on the support, the thickness is preferably 0.01 to 10 m, more preferably 0.01 to 1 m, and still more preferably 0.01 to 0.5 μm.

### [Other Liquid Crystal Cured Layers]

In the optical film, the optically anisotropic layer according to the embodiment of the present invention may be formed on a surface of other liquid crystal cured layers, or other liquid crystal cured layers may be formed on the surface of the optically anisotropic layer according to the embodiment of the present invention.

Here, examples of the other liquid crystal cured layers include a liquid crystal cured layer obtained by immobilizing the above-described liquid crystal composition according to the embodiment of the present invention in a desired alignment state. In addition, examples thereof include a liquid crystal cured layer (light absorption anisotropic film) obtained by fixing an alignment state of a composition containing the above-described liquid crystal compound, a polymerization initiator, a dichroic substance, a surfactant, a solvent, and the like.

### [Ultraviolet Absorber]

The optical film may contain an ultraviolet (UV) absorber, taking an effect of external light (particularly, ultraviolet rays) into consideration.

The UV absorber may be contained in the optically anisotropic layer or may be contained in a member constituting the optical film, other than the optically anisotropic layer. Suitable examples of the member other than the optically anisotropic layer include the support.

As the ultraviolet absorber, any one of ultraviolet absorbers known in the related art, which can express ultraviolet absorptivity, can be used. Among such ultraviolet absorbers, a benzotriazole-based ultraviolet absorber or a hydroxyphenyltriazine-based ultraviolet absorber is preferable from the viewpoint that it has high ultraviolet absorptivity and ultraviolet absorbing ability (ultraviolet-shielding ability) used for an image display device is obtained.

In addition, in order to broaden ultraviolet absorbing ranges, two or more kinds of ultraviolet absorbers having different maximum absorption wavelengths are also preferably used in combination.

As the ultraviolet absorber, Tinuvin 400, Tinuvin 405, Tinuvin 460, Tinuvin 477, Tinuvin 479, Tinuvin 1577, or the like (all manufactured by BASF) can be used.

### [Polarizing Plate]

The polarizing plate according to the embodiment of the present invention includes the above-described optically anisotropic layer or optical film according to the embodiment of the present invention, and a polarizer.

In addition, the polarizing plate according to the embodiment of the present invention preferably further includes a positive C-plate, and more preferably further includes a positive C-plate in which an alignment state of the liquid crystal composition containing the above-described surfactant (II) having the structure represented by Formula (2) is fixed.

In a case where the optically anisotropic layer is a positive A-plate, from the viewpoint of being suitably applied to a circularly polarizing plate or the like, an angle between a slow axis of the positive A-plate and an absorption axis of the polarizer described later is preferably 30° to 60°, more preferably 40° to 50°, still more preferably 42° to 48°, and particularly preferably 45°.

Here, the “slow axis” means a direction in which a refractive index in the plane of the liquid crystal cured layer is maximum, and the “absorption axis” of the polarizer means a direction in which an absorbance is highest.

In a case where the liquid crystal cured layer (optically anisotropic layer) of the optical film is the above-described optically anisotropic layer, from the viewpoint that the optically anisotropic layer can be suitably applied to a circularly polarizing plate or the like, an absolute value of an angle formed by an in-plane slow axis of a second region where an alignment state of a homogeneously aligned liquid crystal compound is fixed and the absorption axis of the polarizer is preferably 5° to 25° and more preferably 10° to 20°.

In addition, the polarizing plate can also be used as an optical compensation film for the IPS mode or FFS mode liquid crystal display device.

In a case where the polarizing plate is used as an optical compensation film for the IPS mode or FFS mode liquid crystal display device, it is preferable that the above-described optically anisotropic layer is used as at least one plate of a laminate of a positive A-plate or a positive C-plate, an angle formed by a slow axis of the positive A-plate layer and the absorption axis of the polarizer described later is orthogonal or parallel to each other; and specifically, it is more preferable that the angle formed by the slow axis of the positive A-plate layer and the absorption axis of the polarizer described later is 0° to 5° or 85° to 95°.

In a case where the polarizing plate according to the embodiment of the present invention is used in an image display device described later, it is preferable that the angle formed by the slow axis of the liquid crystal cured layer and the absorption axis of the polarizer described later is parallel or orthogonal to each other.

In the present specification, the term “parallel” does not require that both the angle formed by the slow axis of the liquid crystal cured layer and the absorption axis of the polarizer are strictly parallel, but means that an angle between one and the other is less than 10°. In addition, in the present specification, the term “orthogonal” does not require that both the angle formed by the slow axis of the liquid crystal cured layer and the absorption axis of the polarizer are strictly orthogonal, but means that an angle between one and the other is more than 800 and less than 100°.

### [Polarizer]

The polarizer is not particularly limited as long as the polarizer is a member having a function of converting light into specific linearly polarized light, and a known absorptive type polarizer, reflective type polarizer, and coating type polarizer in the related art can be used.

An iodine-based polarizer, a dye-based polarizer using a dichroic dye, a polyene-based polarizer, or the like is used as the absorptive type polarizer. The iodine-based polarizer and the dye-based polarizer include a coating type polarizer and a stretching type polarizer, and any one of these polarizers can be applied. However, a polarizer which is produced by allowing polyvinyl alcohol to adsorb iodine or a dichroic dye and performing stretching is preferable.

Examples of the coating type polarizer include a polarizer containing a cured product of a liquid crystal compound and a dichroic coloring agent.

A polarizer in which thin films having different birefringence are laminated, a wire grid type polarizer, a polarizer in which a cholesteric liquid crystal having a selective reflection range and a ¼ wavelength plate are combined, or the like is used as the reflective type polarizer.

A thickness of the polarizer is not particularly limited, but is preferably 3 to 60 m, more preferably 3 to 30 m, and still more preferably 3 to 10 μm.

### [Pressure Sensitive Adhesive Layer]

The polarizing plate according to the embodiment of the present invention may include a pressure sensitive adhesive layer disposed between the optically anisotropic layer in the optical film and the polarizer.

Examples of a material forming the pressure sensitive adhesive layer used for laminating the cured product and the polarizer include a member formed of a substance in which a ratio (tan δ=G⁴¹/G′) between a storage elastic modulus G′ and a loss elastic modulus G″, each measured with a dynamic viscoelasticity measurement device, is 0.001 to 1.5, in which a so-called pressure sensitive adhesive and a readily creepable substance are contained. Examples of the pressure sensitive adhesive include a polyvinyl alcohol-based pressure sensitive adhesive, but the pressure sensitive adhesive is not limited thereto.

### [Adhesive Layer]

The polarizing plate according to the embodiment of the present invention may include an adhesive layer disposed between the optically anisotropic layer in the optical film and the polarizer.

As the adhesive layer used for laminating the cured product and the polarizer, a curable adhesive composition which is cured by irradiation with active energy rays or heating is preferable.

Examples of the curable adhesive composition include a curable adhesive composition containing a cationically polymerizable compound and a curable adhesive composition containing a radically polymerizable compound.

A thickness of the adhesive layer is preferably 0.01 to 20 μm, more preferably 0.01 to 10 μm, and still more preferably 0.05 to 5 μm. In a case where the thickness of the adhesive layer is within the range, floating or peeling does not occur between the protective layer or liquid crystal cured layer and the polarizer, which are laminated, and thus a practically acceptable adhesive force can be obtained. In addition, the thickness of the adhesive layer is preferably 0.4 μm or more from the viewpoint that generation of air bubbles can be suppressed.

With regard to the adhesive layer, reference can be made to, for example, the description in paragraphs [0062] to [0080] of JP2016-35579A, the contents of which are incorporated herein by reference.

### [Easy Adhesion Layer]

The polarizing plate according to the embodiment of the present invention may include an easy adhesion layer disposed between the optically anisotropic layer in the optical film and the polarizer. From the viewpoint of excellent adhesiveness between the optically anisotropic layer and the polarizer and further suppressing the occurrence of cracks in the polarizer, a storage elastic modulus of the easy adhesion layer at 85° C. is preferably 1.0×10⁶ Pa to 1.0×10⁷ Pa. Examples of a constituent material of the easy adhesion layer include a polyolefin-based component and a polyvinyl alcohol-based component. A thickness of the easy adhesion layer is preferably 500 nm to 1 μm.

With regard to the easy adhesion layer, reference can be made to, for example, the description in paragraphs [0048] to [0053] of JP2018-36345A, the contents of which are incorporated herein by reference.

### [Image Display Device]

The image display device according to the embodiment of the present invention is an image display device including the optical film according to the embodiment of the present invention or the polarizing plate according to the embodiment of the present invention.

A display element used in the image display device is not particularly limited, and examples thereof include a liquid crystal cell, an organic electroluminescent (hereinafter, simply referred to as “EL”) display panel, and a plasma display panel. Among these, a liquid crystal cell or an organic EL display panel is preferable.

### [Liquid Crystal Display Device]

A liquid crystal display device as an example of the image display device is a liquid crystal display device including the above-described polarizing plate and a liquid crystal cell.

Among polarizing plates provided on both sides of the liquid crystal cell, it is preferable that the above-described polarizing plate is used as a polarizing plate on the front side, and it is more preferable that the above-described polarizing plate is used as polarizing plates on the front and rear sides.

### <Liquid Crystal Cell>

It is preferable that the liquid crystal cell used in the liquid crystal display device is in a vertical alignment (VA) mode, an optically compensated bend (OCB) mode, an in-plane-switching (IPS) mode, a fringe-field-switching (FFS) mode, or a twisted nematic (TN) mode, but is not limited thereto.

### [Organic EL Display Device]

Examples of the organic EL display device which is an example of the image display device include an aspect which includes, from a viewing side, a polarizer, a λ/4 plate including the above-described liquid crystal cured layer (optically anisotropic layer), and an organic EL display panel in this order.

In addition, the organic EL display panel is a display panel formed of an organic EL element obtained by sandwiching an organic light emitting layer (organic electroluminescence layer) between electrodes (between a cathode and an anode). The configuration of the organic EL display panel is not particularly limited, and a known configuration is employed.

### EXAMPLES

Hereinafter, the present invention will be described in more detail with reference to Examples. The materials, amounts used, proportions, treatment contents, treatment procedures, and the like shown in the following examples can be modified as appropriate in the range of not departing from the spirit of the present invention. Therefore, the scope of the present invention should not be construed as being limited to Examples.

### Comparative Example 1-1

An optically anisotropic layer containing the reverse dispersion compound, the liquid crystal compound, and the specific surfactant; a positive C-plate; a circularly polarizing plate including the optically anisotropic layer and the positive C-plate; and a display device were produced as follows.

### [Production of Support (Cellulose Acylate Film A1)]

The following composition was put into a mixing tank, stirred, and heated at 90° C. for 10 minutes. Thereafter, the obtained composition was filtered through a filter paper having an average hole diameter of 34 μm and a sintered metal filter having an average hole diameter of 10 μm to prepare a dope. The concentration of solid contents of the dope was 23.5% by mass, the amount of the plasticizer added was a proportion to cellulose acylate, and the solvent of the dope was methylene chloride/methanol/butanol=81/18/1 (mass ratio).

Cellulose acylate dope

| | |
|---|---|
| Cellulose acylate (acetyl substitution degree: 2.86, viscosity average degree of | 100 parts by mass |
| polymerization: 310) | |
| Sugar ester compound 1 (Formula (S4) shown below) | 6.0 parts by mass |
| Sugar ester compound 2 (Formula (S5) shown below) | 2.0 parts by mass |
| Silica particle dispersion (AEROSIL R972, manufactured by Nippon Aerosil Co., Ltd.) | 0.1 parts by mass |
| Solvent (methylene chloride/methanol/butanol) | 351.9 parts by mass |

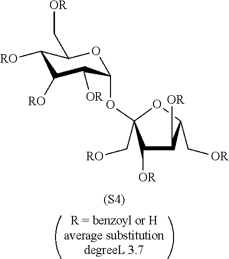

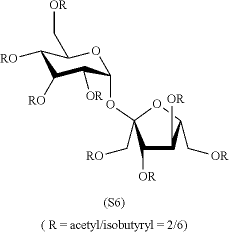

The dope produced above was cast using a drum film forming machine. The dope was cast from a die such that it was in contact with a metal support cooled to 0° C., and then the obtained web (film) was stripped from the drum. The drum was made of stainless steel (SUS).

The web (film) obtained by casting was peeled off from the drum, and then dried in a tenter device for 20 minutes at 30° C. to 40° C. during film transport, and the tenter device transported the web by clipping both ends of the web. Subsequently, the web was post-dried by zone heating while being rolled. The obtained web was subjected to knurling and then wound to obtain a cellulose acylate film A¹.

In the obtained cellulose acylate film A¹, a film thickness was 40 m, an in-plane retardation Re(550) at a wavelength of 550 nm was 1 nm, and a thickness-direction retardation Rth(550) at a wavelength of 550 nm was 25 nm.

### [Production of Optical Film F1-1]

The above-described cellulose acylate film A1 was continuously coated with a coating liquid E1 for forming a photo-alignment film, having the following formulation, with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film E1 having a thickness of 0.7 m, thereby obtaining a TAC film with the photo-alignment film.

Coating liquid El for forming photo-alignment film

| | |
|---|---|
| Polymer PA-2 shown below | 100.00 parts by mass |
| Thermal cationic polymerization initiator PAG-1 shown below | 5.00 parts by mass |
| Acid generator CPI-110TF shown below | 0.005 parts by mass |
| Isopropyl alcohol | 16.50 parts by mass |
| Butyl acetate | 1072.00 parts by |
| Methyl ethyl ketone | 268.00 parts by mass |

Thermal cationic polymerization initiator PAG-1 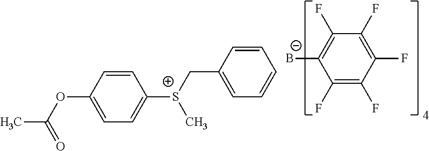
Polymer PA-2 [weight-average molecular weight: 45,000; in the formula, the numerical value described in each repeating unit denotes the content (% by mass) of each repeating unit with respect to all repeating units] 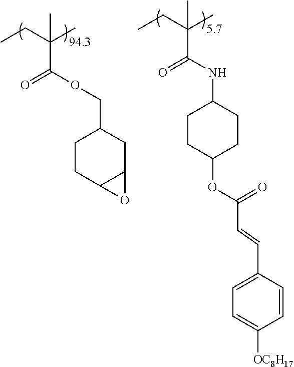
Acid generator CPI-110TF

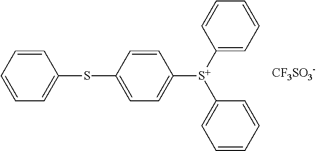

The above-described photo-alignment film E1 was coated with a composition F1-1 having the following formulation with a bar coater. The coating film formed on the photo-alignment film E1 was heated to 120° C. with hot air, cooled to 60° C., irradiated with ultraviolet rays having a wavelength of 365 nm with an illuminance of 100 mJ/cm² using a high-pressure mercury lamp in a nitrogen atmosphere, and continuously irradiated with ultraviolet rays with an illuminance of 500 mJ/cm² while being heated at 120° C., so that the alignment of the liquid crystal compound was fixed, thereby producing an optical film F1-1 including an optically anisotropic layer F1-1.

A thickness of the optically anisotropic layer F1-1 was 2.9 m, and Re(550) was 142 nm. In addition, the optically anisotropic layer F1-1 satisfied a relationship of Re(450)≤Re(550)≤Re(650). Re(450)/Re(550) was 0.82. The optically anisotropic layer corresponded to a so-called λ/4 plate.

A mixture of reverse dispersion compounds LA-1 to LA-3 and polymerizable liquid crystal compounds LC-1 to LC-4, contained in the following composition F1-1, is defined as a liquid crystal mixture A.

Composition F1-1

| | |
|---|---|
| Reverse dispersion compound LA-1 shown below | 30.00 parts by mass |
| Reverse dispersion compound LA-2 shown below | 30.00 parts by mass |
| Reverse dispersion compound LA-3 shown below | 27.00 parts by mass |
| Polymerizable liquid crystal compound LC-1 shown below | 6.64 parts by mass |
| Polymerizable liquid crystal compound LC-2 shown below | 1.20 parts by mass |
| Polymerizable liquid crystal compound LC-3 shown below | 0.16 parts by mass |
| Polymerizable liquid crystal compound LC-4 shown below | 5.00 parts by mass |
| Polymerization initiator PI-1 shown below | 0.50 parts by mass |
| Surfactant containing polyacrylate compound as main component (BYK-361N, | 0.09 parts by mass |
| manufactured by BYK Chemie Japan Co., Ltd.) | |
| Cyclopentanone | 181.00 parts by mass |
| Methyl ethyl ketone | 54.00 parts by mass |

Reverse dispersion compound LA-1 (tBu represents a tertiary butyl group) 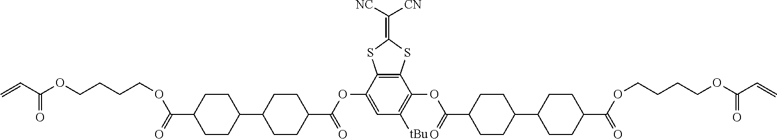 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]
Reverse dispersion compound LA-2 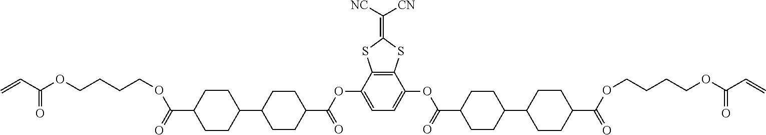 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]
Reverse dispersion compound LA-3 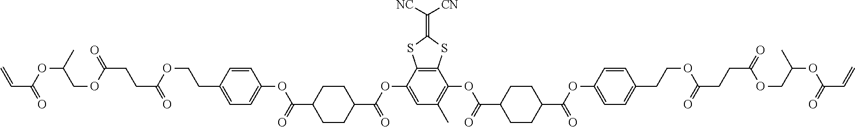 [SMILES: C=CC(=O)OC(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)OC(=O)C=C)cc5)CC4)c4c3SC(=C(C#N)C#N)S4)CC2)cc1]
Polymerizable liquid crystal compound LC-1 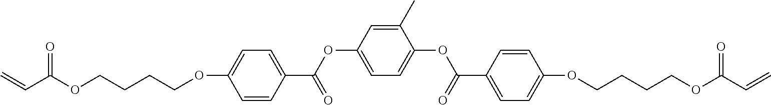 [SMILES: C=CC(=O)OCCCCOc1ccc(C(=O)Oc2ccc(OC(=O)c3ccc(OCCCCOC(=O)C=C)cc3)c(C)c2)cc1]
Polymerizable liquid crystal compound LC-2 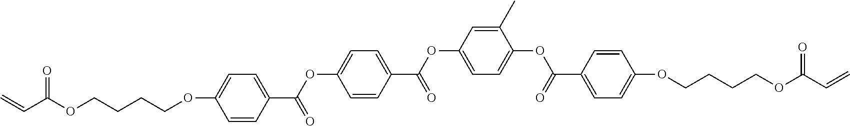 [SMILES: C=CC(=O)OCCCCOc1ccc(C(=O)Oc2ccc(C(=O)Oc3ccc(OC(=O)c4ccc(OCCCCOC(=O)C=C)cc4)c(C)c3)cc2)cc1]
Polymerizable liquid crystal compound LC-3 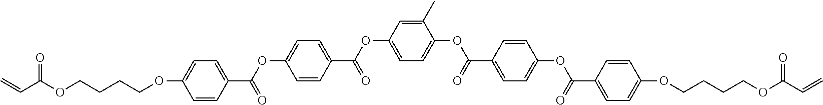 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Polymerizable liquid crystal compound LC-4 (Me represents a methyl group) 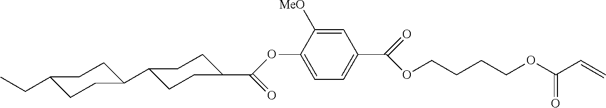 [SMILES: C=CC(=O)OCCCCOC(=O)c1ccc(OC(=O)C2CCC(C3CCC(CC)CC3)CC2)c(OC)c1]
Polymerization initiator PI-1

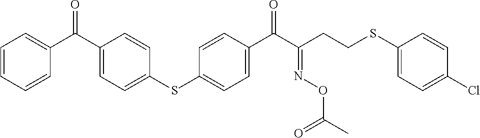 [SMILES: CC(=O)O/N=C(\CCSc1ccc(Cl)cc1)C(=O)c1ccc(Sc2ccc(C(=O)c3ccccc3)cc2)cc1]

### [Production of Positive C-Plate]

The above-described cellulose acylate film A1 was coated with a coating liquid FC-1 for forming a positive C-plate, having the following formulation, the obtained coating film was aged at 60° C. for 60 seconds and irradiated with ultraviolet rays at an illuminance of 1000 mJ/cm² in the air using an air-cooled metal halide lamp at an illuminance of 70 mW/cm² (manufactured by Eye Graphics Co., Ltd.), and the alignment state thereof was fixed to vertically align the liquid crystal compound, thereby producing a positive C-plate FC-1 having a thickness of 0.5 μm.

Rth(550) of the obtained positive C-plate was −60 nm.

Coating liquid FC-1 for forming positive C-plate

| | |
|---|---|
| Liquid crystal compound LC-1 shown above | 83 parts by mass |
| Liquid crystal compound LC-2 shown above | 15 parts by mass |
| Liquid crystal compound LC-3 shown above | 2 parts by mass |
| Polymerizable monomer (UA-601I, manufactured by Kyoeisha Chemical Co., Ltd.) | 5 parts by mass |
| Polymerization initiator (Irgacure OXE01, manufactured by BASF) | 4 parts by mass |
| Specific surfactant SC-1 shown below | 0.4 parts by mass |
| Vertical alignment agent S01 shown below | 1.2 parts by mass |
| Polymer M shown below | 1.14 parts by mass |
| Methyl isobutyl ketone | 494.9 parts by mass |
| Ethyl propionate | 95.0 parts by mass |
| 2-Butanone | 43.3 parts by mass |

Vertical alignment agent S01 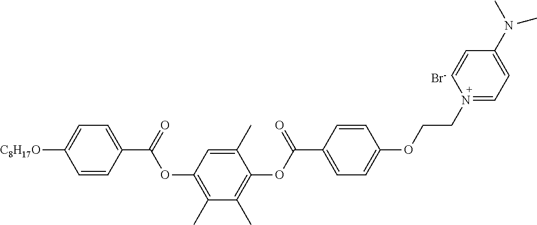
Polymer M [weight-average molecular weight: 60,000; numerical value in each
repeating unit represents a content with respect to all repeating units] 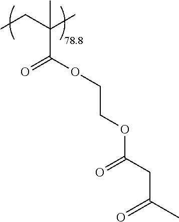 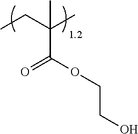 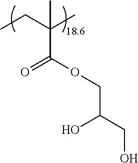 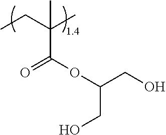
Specific surfactant SC-1 (weight-average molecular weight: 25,000)

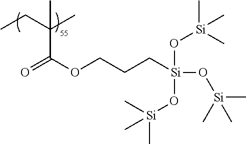

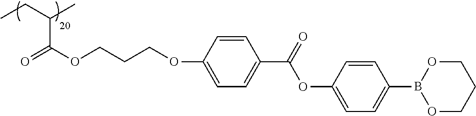

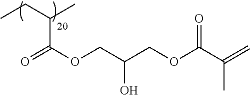

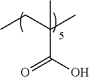

### [Production of Circularly Polarizing Plate and Display Device]

<Production of Polarizer 1 with Protective Film>

A surface of a support of a cellulose triacetate film TJ25 “Z-TAC” (manufactured by FUJIFILM Corporation; thickness: 25 μm) was subjected to an alkali saponification treatment. Specifically, the support was immersed in a 1.5 N sodium hydroxide aqueous solution at 55° C. for 2 minutes, washed in a water bath at room temperature, and further neutralized with a 0.1 N sulfuric acid at 30° C. After neutralization, the support was washed in a water bath at room temperature and further dried with hot air at 100° C. to obtain a polarizer protective film.

A roll-shaped polyvinyl alcohol film was stretched in a machine direction (MD) in an iodine aqueous solution, and dried to obtain a polarizer 1 having a thickness of 14 μm.

The polarizer protective film was bonded to both surfaces of the above-described polarizer 1 with a PVA adhesive to produce a polarizer 1 with a protective film.

### <Preparation of UV Adhesive 1>

A UV adhesive 1 having the following formulation was prepared.

UV adhesive 1

| | |
|---|---|
| CEL2021P (manufactured by Daicel Corporation) | 70 parts by mass |
| 1,4-Butanediol diglycidyl ether | 20 parts by mass |
| 2-Ethylhexyl glycidyl ether | 10 parts by mass |
| CPI-100P | 2.25 parts by mass |

CPI-100P

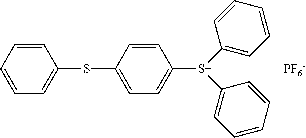

### <Production of Pressure-Sensitive Adhesive Sheet N1>

95 parts by mass of butyl acrylate and 5 parts by mass of acrylic acid were polymerized by a solution polymerization method to obtain an acrylic copolymer 1 having an average molecular weight of 2,000,000 and a molecular weight distribution (Mw/Mn) of 3.0.

Next, a solution (pressure sensitive adhesive composition N1) was prepared by mixing 10 parts by mass of a polyfunctional acrylate-based monomer (ARONIX M-315, manufactured by Toagosei Co., Ltd.), 1 part by mass of a photopolymerization initiator (Irgacure 500, manufactured by BASF), 1 part by mass of trimethylolpropane triisocyanate (CORONATE L, manufactured by Nippon Polyurethane Industry Co., Ltd.), and 0.2 parts by mass of a silane coupling agent (KBM-403, manufactured by Shin-Etsu Chemical Co., Ltd.) with respect to 100 parts by mass of solid contents of the acrylic-based copolymer 1.

Next, the prepared pressure sensitive adhesive composition N1 was applied onto a PET film (peeling film) coated with a silicone resin, and dried at 90° C. to remove a solvent. Thereafter, the film was irradiated with ultraviolet rays (UV) under the following conditions to produce a pressure-sensitive adhesive sheet N1 having a pressure-sensitive adhesive layer N1 with a thickness of 20 μm. A storage elastic modulus of the pressure-sensitive adhesive layer N1 was 0.6 MPa.

### (UV Irradiation Conditions)

Electrodeless lamp H bulb (Fusion Co., Ltd.)
Illuminance: 600 mW/cm²
Light intensity: 150 mJ/cm²

The UV illuminance and the light intensity were measured using “UVPF-36” (manufactured by Eye Graphics Co., Ltd.).

### <Production of Circularly Polarizing Plate>

The retardation layer (positive C-plate) side of the positive C-plate FC-1 produced above was bonded to the optically anisotropic layer F1-1 (positive A-plate) side of the above-described optical film F1-1 using the above-described UV adhesive 1, and the photo-alignment film and the cellulose acylate film A1 on the positive A-plate side were removed to obtain a film 1 with an optically anisotropic layer.

The polarizer 1 with a protective film, which was produced above, was bonded to the optically anisotropic layer (positive A-plate) side of the above-described film 1 with an optically anisotropic layer using the above-described pressure-sensitive adhesive sheet N1, and the cellulose acylate film A1 on the positive C-plate side was removed to complete a circularly polarizing plate.

In this case, the polarizer 1 with a protective film and the film 1 with an optically anisotropic layer were bonded to each other such that an angle between an absorption axis of the polarizer included in the polarizer 1 with a protective film and a slow axis of the positive A-plate F1-1 included in the film 1 with an optically anisotropic layer was 45°.

### <Production of Organic EL Display Device>

GALAXY S4 (manufactured by Samsung Electronics Co., Ltd.) equipped with an organic EL panel (organic EL display element) was disassembled, a touch panel provided with a circularly polarizing plate was peeled off from the organic EL display device, and a circularly polarizing plate was further peeled off from the touch panel, so that the organic EL display element, the touch panel, and the circularly polarizing plate were isolated from each other. Next, the isolated touch panel was bonded to the organic EL display element again, and the circularly polarizing plate produced as described above was bonded to the touch panel through a pressure sensitive adhesive SK2057 (manufactured by Soken Chemical & Engineering Co., Ltd.) such that the optically anisotropic layer side (positive C-plate side) faced the panel side, thereby producing an organic EL display device.

### [Evaluation]

### [Wind Marks]

Each of the optical films produced in Comparative Example 1-1 and each of Examples and Comparative Examples described later was sandwiched between two polarizing plates disposed in a cross-nicols configuration; and light was passed from the bottom to the top (side facing the observer), and brightness unevenness was observed. The observed unevenness was evaluated according to the following standard in a case of being incorporated into the organic EL display device. The results are shown in each table described later.
A: no unevenness was observed on the entire surface of the optical film.
B: weak unevenness was visually recognized in a part of the optical film, but was not observed in a state of being incorporated into the organic EL panel.
C: unevenness was observed in a part of the optical film, and was visually recognized in a state of being incorporated into the organic EL panel, where it was acceptable.
D: unevenness was observed in a part of the optical film, and was strongly visually recognized in a state of being incorporated into the organic EL panel, where it was not acceptable.

### [Cissing]

The number of cissing in the liquid crystal cured layer (optically anisotropic layer) of each of the optical films produced in Comparative Example 1-1 and each of Examples and Comparative Examples described later was counted. The cissing refers to a region where the liquid crystal cured layer was not formed. The cissing refers to a portion which remains dark even in a case where a sample is rotated, in a case where the sample in which an optical film including the liquid crystal cured layer and a support not including the liquid crystal cured layer are laminated while being shifted by 90° is observed in a cross-nicols configuration using a transmission mode of a polarizing microscope.

Based on the results, evaluation was performed according to the following standard. The results are shown in each table described later.
A: number of cissing was less than 5 pieces/m².
B: number of cissing was 5 pieces/m² or more and less than 30 pieces/m².
C: number of cissing was 30 pieces/m² or more, where it was not acceptable.

### [Measurement of Surface Free Energy]

A surface free energy 7 of the liquid crystal cured layer (optically anisotropic layer) of each of the optical films produced in Comparative Example 1-1 and each of Examples and Comparative Examples described later was calculated by a Kaelble-Wu method. The results are shown in each table described later.

### Comparative Examples 1-2 to 1-4 and Examples 1-1 to 1-16

Circularly polarizing plates and organic EL display devices of Comparative Examples 1-2 to 1-4 and Examples 1-1 to 1-16 were produced by the same method as in Comparative Example 1-1, except that optical films F1-2 to F1-20 produced by the following method were used instead of the optical film F1-1.

### [Production of Optical Films F1-2 to F1-21]

<Specific surfactants SA-1 to SA-14>

Specific surfactants SA-1 to SA-14 (all of which are surfactants corresponding to the surfactant (II)) shown in Table 10 were prepared.

TABLE 10

| | Repeating unit A | | Repeating unit B | | | | Weight-average | | | | |
|---|---|---|---|---|---|---|---|---|---|---|---|
| | | Content | | Content | | Content | molecular | Surface | Solubility | | |
| Specific | | (% by | | (% by | | (% by | weight | tension | parameter | | |
| surfactant | Structure | mass) | Structure | mass) | Structure | mass) | (Mw) | (mN/m) | δD | δP | δH |
| SA-1 | A-1 | 60 | B-1 | 40 | — | — | 30000 | 26.8 | 15.8 | 3.2 | 2.3 |
| SA-2 | | 70 | | 30 | | | 30000 | 26.3 | 15.1 | 2.8 | 1.9 |
| SA-3 | | 70 | | 30 | | | 10000 | 26.6 | 15.1 | 2.8 | 1.9 |
| SA-4 | | 50 | | 50 | | | 30000 | 27.2 | 16.5 | 3.7 | 2.6 |
| SA-5 | | 80 | | 20 | | | 30000 | 25.4 | 14.5 | 2.3 | 1.6 |
| SA-6 | | 80 | | 20 | | | 3000 | 25.7 | 14.5 | 2.3 | 1.6 |
| SA-7 | | 55 | | 40 | B-5 | 5 | 30000 | 27.6 | 16.0 | 3.5 | 2.6 |
| SA-8 | | 60 | B-2 | 40 | — | — | 30000 | 25.6 | 15.1 | 2.5 | 2.7 |
| SA-9 | | 76 | B-3 | 26 | | | 13000 | | 14.3 | 2.1 | 2.0 |
| SA-10 | | 70 | B-4 | 30 | | | 30000 | 26.3 | 14.0 | 2.3 | 2.3 |
| SA-11 | | 50 | | 50 | | | 30000 | 27.2 | 16.5 | 2.5 | 2.9 |
| SA-12 | A-2 | 60 | B-2 | 40 | — | — | 30000 | 26.8 | 15.6 | 3.2 | 1.4 |
| SA-13 | A-1 | 30 | B-4 | 40 | — | — | 30000 | 26.2 | 15.2 | 3.4 | 1.6 |
| | A-2 | 30 | | | | | | | | | |
| SA-14 | A-1 | 100 | — | — | — | — | 10000 | 22.3 | 13.1 | 1.4 | 0.9 |

Repeating unit A-1 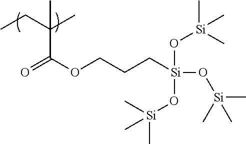
Repeating unit A-2 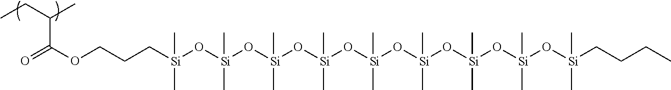
Repeating unit B-1 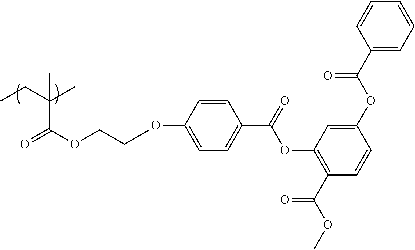
Repeating unit B-2 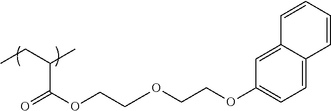
Repeating unit B-3 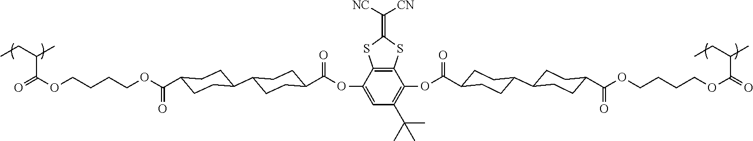
Repeating unit B-4 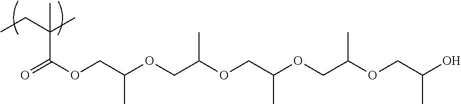
Repeating unit B-5

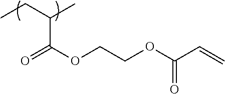

### <Production of Optical Films F1-2 to F1-20>

Optical films F1-2 to F1-20 were produced by the same method as in Comparative Example 1-1, except that the blending amount of the surfactant BYK-361N (manufactured by BYK Chemie Japan Co., Ltd.) (that is, a surfactant not corresponding to the surfactant (II)) used for producing the optical film F1-1 in Comparative Example 1-1 was changed as shown in Table 11, or the surfactant BYK-361N was changed to specific surfactants SA-1 to SA-14 corresponding to the surfactants (II) shown in Table 11.

TABLE 11

| | | | | | Solvent having boiling | | |
|---|---|---|---|---|---|---|---|
| | | | | | point of 130° C. or higher | | Presence or |
| | | | | | | Part by mass | absence of |
| | | | | | | with respect to | Formula (Ar-3) |
| | | | | Liquid | | 100 parts by | in reverse |
| | Optical | Surfactant | | crystal | | mass of liquid | dispersion |
| | film | Type | Content | mixture | Type of solvent | crystal compound | compound (I) |
| Comparative | F1-1 | BYK-361N | 0.09 | A | Cyclopentanone | 181 | Including |
| Example 1-1 | | | | | | | |
| Comparative | F1-2 | — | 0 | A | Cyclopentanone | 181 | Including |
| Example 1-2 | | | | | | | |
| Comparative | F1-3 | BYK-361N | 0.3 | A | Cyclopentanone | 181 | Including |
| Example 1-3 | | | | | | | |
| Comparative | F1-4 | BYK-361N | 1.00 | A | Cyclopentanone | 181 | Including |
| Example 1-4 | | | | | | | |
| Example 1-1 | F1-5 | SA-1 | 0.06 | A | Cyclopentanone | 181 | Including |
| Example 1-2 | F1-6 | SA-2 | 0.06 | A | Cyclopentanone | 181 | Including |
| Example 1-3 | F1-7 | SA-3 | 0.06 | A | Cyclopentanone | 181 | Including |
| Example 1-4 | F1-8 | SA-4 | 0.06 | A | Cyclopentanone | 181 | Including |
| Example 1-5 | F1-9 | SA-4 | 0.09 | A | Cyclopentanone | 181 | Including |
| Example 1-6 | F1-10 | SA-5 | 0.06 | A | Cyclopentanone | 181 | Including |
| Example 1-7 | F1-11 | SA-6 | 0.06 | A | Cyclopentanone | 181 | Including |
| Example 1-8 | F1-12 | SA-7 | 0.06 | A | Cyclopentanone | 181 | Including |
| Example 1-9 | F1-13 | SA-8 | 0.09 | A | Cyclopentanone | 181 | Including |
| Example 1-10 | F1-14 | SA-9 | 0.06 | A | Cyclopentanone | 181 | Including |
| Example 1-11 | F1-15 | SA-10 | 0.06 | A | Cyclopentanone | 181 | Including |
| Example 1-12 | F1-16 | SA-11 | 0.06 | A | Cyclopentanone | 181 | Including |
| Example 1-13 | F1-17 | SA-12 | 0.06 | A | Cyclopentanone | 181 | Including |
| Example 1-14 | F1-18 | SA-13 | 0.06 | A | Cyclopentanone | 181 | Including |
| Example 1-15 | F1-19 | SA-1 | 0.06 | A | Cyclopentanone | 181 | Including |
| | | SA-14 | 0.01 | A | Cyclopentanone | 181 | Including |
| Example 1-16 | F1-20 | SA-1 | 0.03 | A | Cyclopentanone | 181 | Including |
| | | SA-11 | 0.03 | A | Cyclopentanone | 181 | Including |

| | ΔHSP | ΔHSP | Film performance | | | |
|---|---|---|---|---|---|---|
| | (liquid crystal | (liquid crystal | | | | Surface |
| | mixture and | mixture and | Re(450)/ | Wind | | free energy |
| | surfactant) | repeating unit B) | Re(550) | marks | Cissing | (mN/m) |
| Comparative | ND | ND | 0.82 | D | A | 38 |
| Example 1-1 | | | | | | |
| Comparative | — | — | 0.82 | D | C | 45 |
| Example 1-2 | | | | | | |
| Comparative | ND | ND | 0.82 | D | A | |
| Example 1-3 | | | | | | |
| Comparative | ND | ND | 0.82 | — | A | |
| Example 1-4 | | | | | | |
| Example 1-1 | 7.2 | 4.2 | 0.82 | A | A | 28 |
| Example 1-2 | 7.9 | 4.2 | 0.82 | A | A | 28 |
| Example 1-3 | 7.9 | 4.2 | 0.82 | A | A | 28 |
| Example 1-4 | 6.5 | 4.2 | 0.82 | B | A | 28 |
| Example 1-5 | 6.5 | 4.2 | 0.82 | C | A | 26 |
| Example 1-6 | 8.7 | 4.2 | 0.82 | A | B | 28 |
| Example 1-7 | 8.7 | 4.2 | 0.82 | B | B | 28 |
| Example 1-8 | 6.7 | 4.2 | 0.82 | A | A | 26 |
| Example 1-9 | 7.4 | 3.2 | 0.82 | B | A | 25 |
| Example 1-10 | 8.6 | 3.1 | 0.82 | B | A | 32 |
| Example 1-11 | 8.4 | 4.2 | 0.82 | A | A | 34 |
| Example 1-12 | 6.6 | 4.2 | 0.82 | C | A | 34 |
| Example 1-13 | 8.0 | 3.2 | 0.82 | A | A | 26 |
| Example 1-14 | 8.0 | 4.2 | 0.82 | A | A | 28 |
| Example 1-15 | 7.2 | 4.2 | 0.82 | A | B | 26 |
| | 10.3 | — | | | | |
| Example 1-16 | 7.2 | 4.2 | 0.82 | B | A | 26 |
| | 8.0 | 3.2 | | | | |

### Comparative Example 2-1

### [Production of Optical Film F2-1]

An optical film F2-1 including an optically anisotropic layer F2-1 was produced by the same method as in Comparative Example 1 of JP2021-81651A ([0160] to [0179]). A liquid crystal mixture (1) shown in JP2021-81651A is defined as a liquid crystal mixture B.

### [Production of Circularly Polarizing Plate and Display Device]

A circularly polarizing plate and an organic EL display device of Comparative Example 1 were produced by the same method as in Comparative Example 1-1, except that the optical film F2-1 was used instead of the optical film F1-1.

### Comparative Example 2-2 and Examples 2-1 to 2-16

Circularly polarizing plates and organic EL display devices of Comparative Example 2-2 and Examples 2-1 to 2-16 were produced by the same method as in Comparative Example 2-1, except that optical films F2-2 and F2-5 to F2-20 produced by the following method were used instead of the optical film F2-1.

### [Production of Optical Films F2-2 and F2-5 to F2-20]

Optical films F2-2 and F2-5 to F2-20 were produced by the same method as in Comparative Example 2-1, except that the blending amount of the surfactant BYK-361N (manufactured by BYK Chemie Japan Co., Ltd.) (that is, a surfactant not corresponding to the surfactant (II)) used for producing the optical film F2-1 in Comparative Example 2-1 was changed as shown in Table 12, or the surfactant BYK-361N was changed to specific surfactants SA-1 to SA-14 corresponding to the surfactants (II) shown in Table 12.

TABLE 12

| | | | | | Solvent having boiling | | |
|---|---|---|---|---|---|---|---|
| | | | | | point of 130° C. or higher | | Presence or |
| | | | | | | Part by mass | absence of |
| | | | | | | with respect to | Formula (Ar-3) |
| | | | | Liquid | | 100 parts by | in reverse |
| | Optical | Surfactant | | crystal | | mass of liquid | dispersion |
| | film | Type | Content | mixture | Type of solvent | crystal compound | compound (I) |
| Comparative | F2-1 | BYK-361N | 0.1 | B | N-methylpyrrolidone | 900 | Not including |
| Example 2-1 | | | | | | | |
| Comparative | F2-2 | — | 0 | B | N-methylpyrrolidone | 900 | Not including |
| Example 2-2 | | | | | | | |
| Example 2-1 | F2-5 | SA-1 | 0.06 | B | N-methylpyrrolidone | 900 | Not including |
| Example 2-2 | F2-6 | SA-2 | 0.06 | B | N-methylpyrrolidone | 900 | Not including |
| Example 2-3 | F2-7 | SA-3 | 0.06 | B | N-methylpyrrolidone | 900 | Not including |
| Example 2-4 | F2-8 | SA-4 | 0.06 | B | N-methylpyrrolidone | 900 | Not including |
| Example 2-5 | F2-9 | SA-4 | 0.09 | B | N-methylpyrrolidone | 900 | Not including |
| Example 2-6 | F2-10 | SA-5 | 0.06 | B | N-methylpyrrolidone | 900 | Not including |
| Example 2-7 | F2-11 | SA-6 | 0.06 | B | N-methylpyrrolidone | 900 | Not including |
| Example 2-8 | F2-12 | SA-7 | 0.06 | B | N-methylpyrrolidone | 900 | Not including |
| Example 2-9 | F2-13 | SA-8 | 0.09 | B | N-methylpyrrolidone | 900 | Not including |
| Example 2-10 | F2-14 | SA-9 | 0.06 | B | N-methylpyrrolidone | 900 | Not including |
| Example 2-11 | F2-15 | SA-10 | 0.06 | B | N-methylpyrrolidone | 900 | Not including |
| Example 2-12 | F2-16 | SA-11 | 0.06 | B | N-methylpyrrolidone | 900 | Not including |
| Example 2-13 | F2-17 | SA-12 | 0.06 | B | N-methylpyrrolidone | 900 | Not including |
| Example 2-14 | F2-18 | SA-13 | 0.06 | B | N-methylpyrrolidone | 900 | Not including |
| Example 2-15 | F2-19 | SA-1 | 0.05 | B | N-methylpyrrolidone | 900 | Not including |
| | | SA-14 | 0.01 | B | N-methylpyrrolidone | 900 | Not including |
| Example 2-16 | F2-20 | SA-1 | 0.06 | B | N-methylpyrrolidone | 900 | Not including |
| | | SA-11 | 0.03 | B | N-methylpyrrolidone | 900 | Not including |

| | ΔHSP | ΔHSP | Film performance | | | |
|---|---|---|---|---|---|---|
| | (liquid crystal | (liquid crystal | | | | Surface |
| | mixture and | mixture and | Re(450)/ | Wind | | free energy |
| | surfactant) | repeating unit B) | Re(550) | marks | Cissing | (mN/m) |
| Comparative | ND | ND | 0.85 | D | A | |
| Example 2-1 | | | | | | |
| Comparative | — | — | 0.85 | D | C | 45 |
| Example 2-2 | | | | | | |
| Example 2-1 | 9.0 | 4.0 | 0.85 | A | A | 28 |
| Example 2-2 | 9.8 | 4.0 | 0.85 | A | B | 28 |
| Example 2-3 | 9.8 | 4.0 | 0.85 | A | B | 28 |
| Example 2-4 | 8.1 | 4.0 | 0.85 | A | A | 28 |
| Example 2-5 | 8.1 | 4.0 | 0.85 | B | A | 26 |
| Example 2-6 | 10.5 | 4.0 | 0.85 | A | B | 28 |
| Example 2-7 | 10.5 | 4.0 | 0.85 | A | B | 28 |
| Example 2-8 | 8.5 | 4.0 | 0.85 | A | A | 26 |
| Example 2-9 | 9.7 | 5.9 | 0.85 | A | B | 25 |
| Example 2-10 | 10.8 | 5.4 | 0.85 | A | B | 32 |
| Example 2-11 | 10.7 | 6.9 | 0.85 | A | B | 34 |
| Example 2-12 | 8.9 | 6.9 | 0.85 | A | B | 34 |
| Example 2-13 | 9.5 | 5.9 | 0.85 | A | B | 26 |
| Example 2-14 | 9.6 | 6.9 | 0.85 | A | B | 28 |
| Example 2-15 | 9.0 | 4.0 | 0.85 | A | B | 26 |
| | 12.4 | — | | | | |
| Example 2-16 | 9.0 | 4.0 | 0.85 | A | A | 26 |
| | 9.5 | 5.9 | | | | |

### Examples 3-1 to 3-3

Circularly polarizing plates and organic EL display devices of Examples 3-1 to 3-3 as shown in Table 13 were produced by the same method as in Comparative Example 1-1, except that optical films F3-1 to F3-3 produced by the following method were used instead of the optical film F1-1.

### [Production of Optical Film F3-1]

An optical film F3-1 including an optically anisotropic layer F3-1 was produced by the same method as the optical film F1-1, except that the above-described composition F1-1 used for the production of the optical film F1-1 was changed to the following composition F3-1.

A mixture of the reverse dispersion compounds LA-1 and LA-4 to LA-7, and the polymerizable liquid crystal compound LC-4 shown in the following composition F3-1 is defined as a liquid crystal mixture C.

Composition F3-1

| | |
|---|---|
| Reverse dispersion compound LA-1 shown above | 26.0 parts by mass |
| Reverse dispersion compound LA-4 shown below | 20.0 parts by mass |
| Reverse dispersion compound LA-5 shown below | 24.0 parts by mass |
| Reverse dispersion compound LA-6 shown below | 5.0 parts by mass |
| Reverse dispersion compound LA-7 shown below | 12.0 parts by mass |
| Polymerizable liquid crystal compound LC-4 shown above | 13.0 parts by mass |
| Polymerization initiator PI-1 shown above | 0.5 parts by mass |
| Surfactant SA-1 shown above | 0.06 parts by mass |
| Tetrahydrofuran | 240.0 parts by mass |
| Cyclopentanone | 60.0 parts by mass |

Reverse dispersion compound LA-4 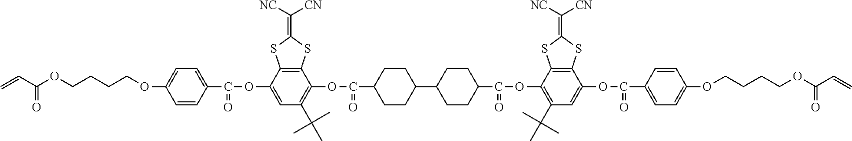 [SMILES: C=CC(=O)OCCCCOc1ccc(C(=O)Oc2cc(C(C)(C)C)c(OC(=O)C3CCC(C4CCC(C(=O)Oc5c(C(C)(C)C)cc(OC(=O)c6ccc(OCCCCOC(=O)C=C)cc6)c6c5SC(=C(C#N)C#N)S6)CC4)CC3)c3c2SC(=C(C#N)C#N)S3)cc1]
Reverse dispersion compound LA-5 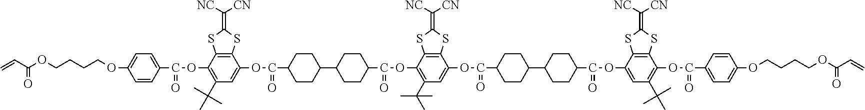 [SMILES: C=CC(=O)OCCCCOc1ccc(C(=O)Oc2c(C(C)(C)C)cc(OC(=O)C3CCC(C4CCC(C(=O)Oc5cc(C(C)(C)C)c(OC(=O)C6CCC(C7CCC(C(=O)Oc8cc(C(C)(C)C)c(OC(=O)c9ccc(OCCCCOC(=O)C=C)cc9)c9c8SC(=C(C#N)C#N)S9)CC7)CC6)c6c5SC(=C(C#N)C#N)S6)CC4)CC3)c3c2SC(=C(C#N)C#N)S3)cc1]
Reverse dispersion compound LA-6 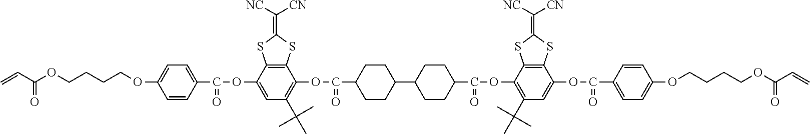 [SMILES: C=CC(=O)OCCCCOc1ccc(C(=O)Oc2cc(C(C)(C)C)c(OC(=O)C3CCC(C4CCC(C(=O)Oc5c(C(C)(C)C)cc(OC(=O)c6ccc(OCCCCOC(=O)C=C)cc6)c6c5SC(=C(C#N)C#N)S6)CC4)CC3)c3c2SC(=C(C#N)C#N)S3)cc1]
Reverse dispersion compound LA-7

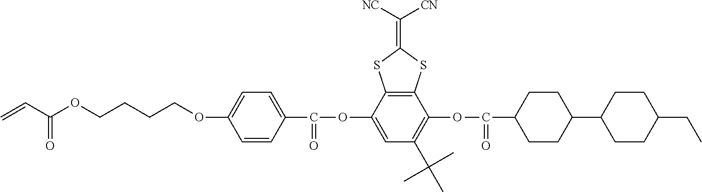 [SMILES: C=CC(=O)OCCCCOc1ccc(C(=O)Oc2cc(C(C)(C)C)c(OC(=O)C3CCC(C4CCC(CC)CC4)CC3)c3c2SC(=C(C#N)C#N)S3)cc1]

### [Production of Optical Film F3-2]

An optical film F3-2 including an optically anisotropic layer F3-2 was produced according to a method described in paragraphs [0224] to [0228] of JP6700468B, except that BYK-361N blended as a leveling agent was changed to the above-described specific surfactant SA-1 (0.06 parts by mass). A liquid crystal mixture shown in JP6700468B is defined as a liquid crystal mixture D.

### [Production of Optical Film F3-3]

An optical film F3-3 including an optically anisotropic layer F3-3 was produced according to a method described in Example 1 of JP2020-531615A, except that FluorN 561 as a surfactant contained in a composition M-1 was changed to the above-described specific surfactant SA-8 (0.06 parts by mass). A mixture of compounds other than Irganox 1076, Darocure TPO, and FluorN 561, contained in the composition M-1 in JP2020-531615A, is defined as a liquid crystal mixture E.

TABLE 13

| | | | | | Solvent having boiling | | |
|---|---|---|---|---|---|---|---|
| | | | | | point of 130° C. or higher | | Presence or |
| | | | | | | Part by mass | absence of |
| | | | | | | with respect to | Formula (Ar-3) |
| | | | | Liquid | | 100 parts by | in reverse |
| | Optical | Surfactant | | crystal | | mass of liquid | dispersion |
| | film | Type | Content | mixture | Type of solvent | crystal compound | compound (I) |
| Example 3-1 | F3-1 | SA-1 | 0.06 | C | Cyclopentanone | 60 | Including |
| Example 3-2 | F3-2 | SA-8 | 0.06 | D | N-methylpyrrolidone | 710 | Not including |
| Example 3-3 | F3-3 | SA-1 | 0.06 | E | — | 0 | Not including |

| | ΔHSP | ΔHSP | Film performance | | | |
|---|---|---|---|---|---|---|
| | (liquid crystal | (liquid crystal | | | | Surface |
| | mixture and | mixture and | Re(450)/ | Wind | | free energy |
| | surfactant) | repeating unit B) | Re(550) | marks | Cissing | (mN/m) |
| Example 3-1 | 7.4 | 4.2 | 0.85 | A | A | 28 |
| Example 3-2 | 8.7 | 3.9 | 0.81 | A | A | 25 |
| Example 3-3 | 6.2 | 1.2 | 0.85 | C | A | 28 |

### Examples 4-1 to 4-11

Circularly polarizing plates and organic EL display devices of Examples 4-1 to 4-11 were produced by the same method as in Comparative Example 1-1, except that optical films F4-1 to F4-11 produced by the following method were used instead of the optical film F1-1.

### [Production of Optical Films F4-1 to F4-11]

### <Specific Surfactant SA-15 and the Like>

Specific surfactants SA-15 and the like (all of which are surfactants corresponding to the surfactant (II)) shown in Table 14 were prepared.

TABLE 14

| | Repeating unit A | | Repeating unit B | | | | Weight-average | | | | |
|---|---|---|---|---|---|---|---|---|---|---|---|
| | | Content | | Content | | Content | molecular | Surface | Solubility | | |
| Specific | | (% by | | (% by | | (% by | weight | tension | parameter | | |
| surfactant | Structure | mass) | Structure | mass) | Structure | mass) | (Mw) | (mN/m) | δD | δP | δH |
| SA-15 | A-3 | 6 | B-6 | 94 | — | — | 30000 | 26.8 | 18.8 | 2.7 | 3.5 |

| | | | | | |
|---|---|---|---|---|---|
| SA-16 | Compound shown below | 31.2 | 15.7 | 0.1 | 1.8 |
| BYK-UV3500 | Polyether-modified polydimethylsiloxane having acrylic functional group | 27.1 | — | — | — |
| BYK-307 | Polyether-modified polydimethylsiloxane | 26.9 | — | — | — |
| BYK-345 | Polyether-modified siloxane | 31.6 | — | — | — |

Repeating unit A-3 (Me represents a methyl group) 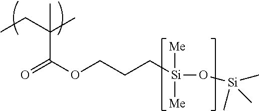
Repeating unit B-6 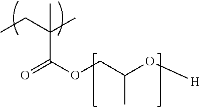
Surfactant SA-16

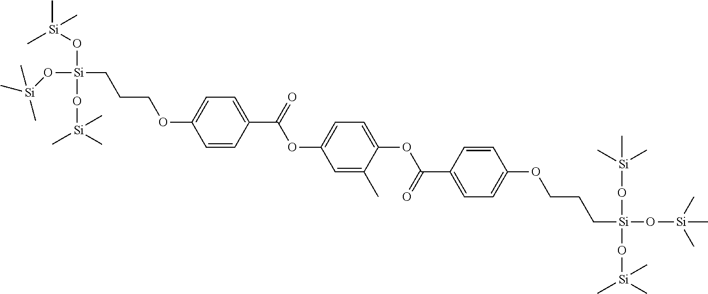

### [Production of Optical Film F4-1]

An optical film F4-1 including an optically anisotropic layer F4-1 was produced by the same method as the optical film F1-1, except that the above-described composition F1-1 used for the production of the optical film F1-1 was changed to the following composition F4-1.

A mixture of reverse dispersion compounds LA-8 and LA-9 and a polymerizable liquid crystal compound LC-5 shown in the following composition F4-1 is defined as a liquid crystal mixture F.

Composition F4-1

| | |
|---|---|
| Reverse dispersion compound LA-8 shown below | 83.00 parts by mass |
| Reverse dispersion compound LA-9 shown below | 14.00 parts by mass |
| Polymerizable liquid crystal compound LC-5 shown below | 3.00 parts by mass |
| Polymerization initiator PI-1 shown above | 0.50 parts by mass |
| Surfactant SA-7 shown above | 0.06 parts by mass |
| Cyclopentanone | 181.00 parts by mass |
| Methyl ethyl ketone | 54.00 parts by mass |

Reverse dispersion compound LA-8 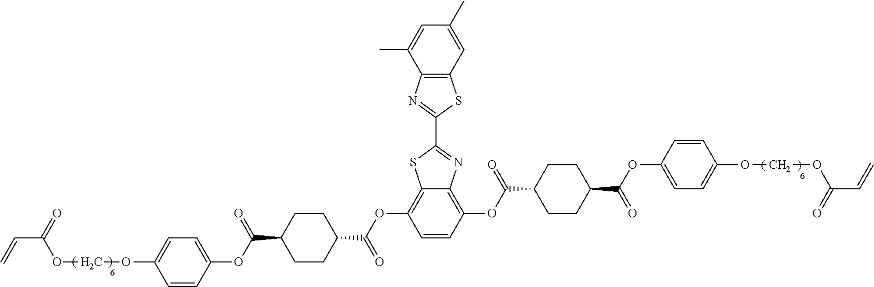 [SMILES: C=CC(=O)OCOc1ccc(OC(=O)[C@H]2CC[C@H](C(=O)Oc3ccc(OC(=O)[C@H]4CC[C@H](C(=O)Oc5ccc(OCOC(=O)C=C)cc5)CC4)c4sc(-c5nc6c(C)cc(C)cc6s5)nc34)CC2)cc1]
Reverse dispersion compound LA-9 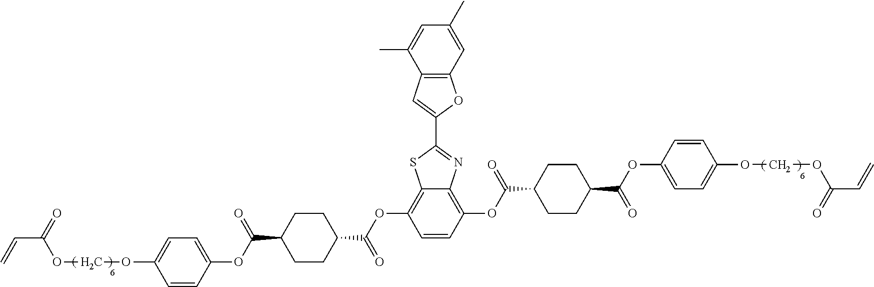 [SMILES: C=CC(=O)OCOc1ccc(OC(=O)[C@H]2CC[C@H](C(=O)Oc3ccc(OC(=O)[C@H]4CC[C@H](C(=O)Oc5ccc(OCOC(=O)C=C)cc5)CC4)c4sc(-c5cc6c(C)cc(C)cc6o5)nc34)CC2)cc1]
Polymerizable liquid crystal compound LC-5

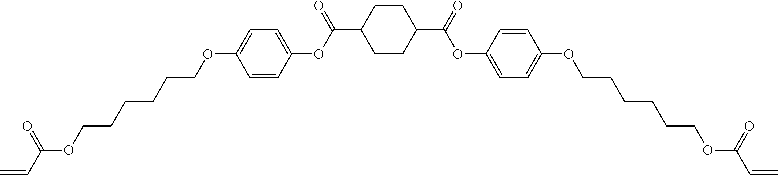 [SMILES: C=CC(=O)OCCCCCCOc1ccc(OC(=O)C2CCC(C(=O)Oc3ccc(OCCCCCCOC(=O)C=C)cc3)CC2)cc1]

### [Production of Optical Films F4-2 to F4-9]

Optical films F4-2 to F4-9 were produced by the same method as the optical film F4-1, except that the specific surfactant SA-7 was changed to a type of a surfactant shown in Table 15.

### [Production of Optical Film F4-10]

An optical film F4-10 was produced by the same method as the optical film F4-1, except that the composition F4-1 was changed to the following composition F4-10.

A mixture of the reverse dispersion compounds LA-8 and LA-9 and the polymerizable liquid crystal compound LC-5 shown in the following composition F4-10 is defined as a liquid crystal mixture F, as in the above-described composition F4-1.

Composition F4-10

| | | |
|---|---|---|
| Reverse dispersion compound LA-8 shown | 83.00 | parts by mass |
| above | | |
| Reverse dispersion compound LA-9 shown | 14.00 | parts by mass |
| above | | |
| Polymerizable liquid crystal compound | 3.00 | parts by mass |
| LC-5 shown above | | |
| Polymerization initiator PI-1 shown above | 0.50 | parts by mass |
| Surfactant SA-7 shown above | 0.06 | parts by mass |
| Cyclopentanone | 70.00 | parts by mass |
| Methyl ethyl ketone | 230.00 | parts by mass |

### [Production of Optical Film F4-11]

An optical film F4-11 was produced by the same method as the optical film F4-1, except that the composition F4-1 was changed to the following composition F4-11.

A mixture of reverse dispersion compounds LA-10 and LA-11 shown in the following composition F4-11 is defined as a liquid crystal mixture G.

Composition F4-11

| | |
|---|---|
| Reverse dispersion compound LA-10 shown below | 99.97 parts by mass |
| Reverse dispersion compound LA-11 shown below | 0.03 parts by mass |
| Polymerization initiator PI-1 shown above | 0.50 parts by mass |
| Surfactant SA-7 shown above | 0.06 parts by mass |
| Cyclopentanone | 181.00 parts by mass |
| Methyl ethyl ketone | 54.00 parts by mass |

Reverse dispersion compound LA-10 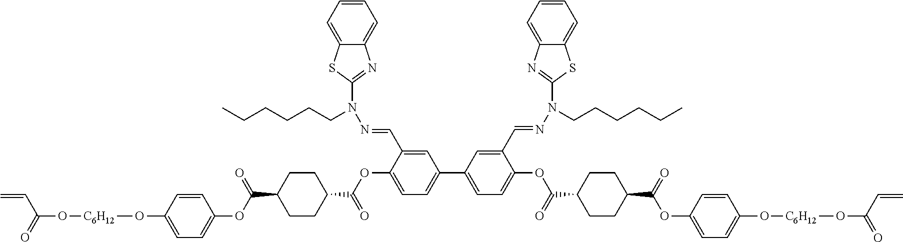
Reverse dispersion compound LA-11

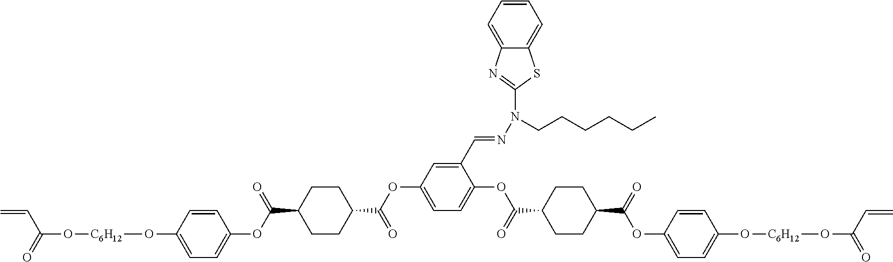

### [Evaluation of Aligning Properties]

The optical films produced in Examples 4-1 to 4-11 and Examples 1-8, 1-12, 2-8, and 2-12 described above were sandwiched between two polarizing plates disposed in a cross-nicols configuration; and aligning properties were evaluated according to the following standard. The results are shown in Table 15.
A: number of defects having a size of 100 μm or more was 1 or less per square meter.
B: number of defects having a size of 100 μm or more was more than 1 and 10 or less per square meter.
C: number of defects having a size of 100 μm or more was 10 or more per square meter.
D: poor overall alignment

TABLE 15

| | | | | | Solvent having boiling | | |
|---|---|---|---|---|---|---|---|
| | | | | | point of 130° C. or higher | | Presence or |
| | | | | | | Part by mass | absence of |
| | | | | | | with respect to | Formula (Ar-3) |
| | | | | Liquid | | 100 parts by | in reverse |
| | Optical | Surfactant | | crystal | | mass of liquid | dispersion |
| | film | Type | Content | mixture | Type of solvent | crystal compound | compound (I) |
| Example 1-8 | F1-12 | SA-7 | 0.06 | A | Cyclopentanone | 181 | Including |
| Example 1-12 | F1-16 | SA-11 | 0.06 | A | Cyclopentanone | 181 | Including |
| Example 2-8 | F2-12 | SA-7 | 0.06 | B | N-methylpyrrolidone | 900 | Not including |
| Example 2-12 | F2-16 | SA-11 | 0.06 | B | N-methylpyrrolidone | 900 | Not including |
| Example 4-1 | F4-1 | SA-7 | 0.06 | F | Cyclopentanone | 181 | Not including |
| Example 4-2 | F4-2 | SA-11 | 0.06 | F | Cyclopentanone | 181 | Not including |
| Example 4-3 | F4-3 | SA-15 | 0.06 | F | Cyclopentanone | 181 | Not including |
| Example 4-4 | F4-4 | SA-15 | 0.25 | F | Cyclopentanone | 181 | Not including |
| Example 4-5 | F4-5 | SA-16 | 0.1 | F | Cyclopentanone | 181 | Not including |
| Example 4-6 | F4-6 | BYK-UV3500 | 0.06 | F | Cyclopentanone | 181 | Not including |
| Example 4-7 | F4-7 | BYK-UV3500 | 0.25 | F | Cyclopentanone | 181 | Not including |
| Example 4-8 | F4-8 | BYK-307 | 0.25 | F | Cyclopentanone | 181 | Not including |
| Example 4-9 | F4-9 | BYK-345 | 0.25 | F | Cyclopentanone | 181 | Not including |
| Example 4-10 | F4-10 | SA-15 | 0.06 | F | Cyclopentanone | 70 | Not including |
| Example 4-11 | F4-11 | SA-15 | 0.06 | G | Cyclopentanone | 181 | Not including |

| | ΔHSP | ΔHSP | Film performance | | | | |
|---|---|---|---|---|---|---|---|
| | (liquid crystal | (liquid crystal | | | | Surface | |
| | mixture and | mixture and | Re(450)/ | Wind | | free energy | |
| | surfactant) | repeating unit B) | Re(550) | marks | Cissing | (mN/m) | Alignment |
| Example 1-8 | 6.7 | 4.2 | 0.82 | A | A | 26 | B |
| Example 1-12 | 6.6 | 4.2 | 0.82 | C | A | 34 | B |
| Example 2-8 | 8.5 | 4.0 | 0.85 | A | A | 26 | A |
| Example 2-12 | 8.9 | 6.9 | 0.85 | A | B | 34 | A |
| Example 4-1 | 8.5 | 4.0 | 0.85 | A | A | 26 | A |
| Example 4-2 | 8.9 | 6.9 | 0.85 | A | A | 34 | A |
| Example 4-3 | 7.5 | 7.2 | 0.85 | A | A | 31 | A |
| Example 4-4 | 7.5 | 7.2 | 0.85 | B | B | 27 | A |
| Example 4-5 | 11.5 | — | 0.85 | B | B | 35 | A |
| Example 4-6 | — | — | 0.85 | B | A | 34 | B |
| Example 4-7 | — | — | 0.85 | C | B | 30 | B |
| Example 4-8 | — | — | 0.85 | C | C | 32 | B |
| Example 4-9 | — | — | 0.85 | B | C | 52 | B |
| Example 4-10 | 7.5 | 7.2 | 0.85 | A | B | 31 | C |
| Example 4-11 | 7.5 | 7.2 | 0.85 | A | A | 31 | A |

From the results shown in Tables 10 to 15 above, it was found that, in a case where the liquid crystal composition containing the surfactant (II) was used, the cissing and the wind marks in the formation of the liquid crystal cured layer having reverse dispersibility could be suppressed (see Examples in each of the tables).

In addition, from the results shown in Table 15, it was found that, in a case where 150 parts by mass or more of the high-boiling point solvent having a boiling point of 130° C. or higher was contained with respect to 100 parts by mass of the liquid crystal compound, the aligning properties were favorable. It is presumed that this is because fluidity of the coating liquid (liquid crystal composition) was maintained for a longer period after the coating, which promoted uneven distribution of the surfactant (II).

In addition, it was found that the optical film including the optically anisotropic layer obtained by fixing the alignment state of the liquid crystal composition containing the reverse dispersion compound having the group (aromatic ring) represented by Formula (Ar-3) described above had deteriorated alignment properties. It is presumed that this is because the group (aromatic ring) represented by Formula (Ar-3) described above had a large interaction such as 7L-7L interaction, so that the liquid crystal had low fluidity and the alignment was slow.

### EXPLANATION OF REFERENCES

10: optical film
12: liquid crystal cured layer (optically anisotropic layer)
14: alignment film
16: support

What is claimed is:

1. An optically anisotropic layer consisting of a liquid crystal cured layer obtained by fixing an alignment state of a liquid crystal composition which contains a reverse dispersion compound (I) represented by Formula (1), at least one liquid crystal compound, and a surfactant (II) having a structure represented by Formula (2) in a molecule,
wherein the optically anisotropic layer satisfies a relationship of Expression (3), 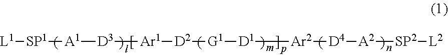
in Formula (1),
D¹, D², D³, and D⁴ each independently represent a single bond, —CO—, —O—, —S—, —C(═S)—, —CR¹R²—, —CR³═CR⁴—, —NR^{S}—, or a divalent linking group consisting of a combination of two or more of these groups, where R¹ to R⁵ each independently represent a hydrogen atom, a fluorine atom, or an alkyl group having 1 to 12 carbon atoms,
G¹ represents A^{G} or SP^{G},
A¹, A², and A^{G} each independently represent an aromatic hydrocarbon ring which may have a substituent, an aromatic heterocyclic ring which may have a substituent, or a divalent alicyclic hydrocarbon group which may have a substituent, provided that one or more of —CH₂-'s constituting the alicyclic hydrocarbon group may be replaced with —O—, —S—, or —NH—,
SP¹, SP², and SP^{G} each independently represent a single bond or a divalent aliphatic hydrocarbon group having 1 to 20 carbon atoms, provided that one or more of —CH₂-'s constituting the aliphatic hydrocarbon group may be replaced with —O—, —S—, —NH—, —N(Q)-, or —CO—, where Q represents a substituent,
L¹ and L² each independently represent a monovalent organic group, where at least one of L¹ or L² represents a polymerizable group, provided that, in a case where at least one of Ar¹ or Ar² is an aromatic ring represented by Formula (Ar-4), at least one of L¹, L², or L³ or L⁴ in Formula (Ar-4) represents a polymerizable group,
m represents an integer of 0 to 2, provided that, in a case where m is 2, a plurality of G¹'s may be the same or different from each other and a plurality of D¹'s may be the same or different from each other,
1 and n each independently represent 0 or an integer of 1 or more, provided that, in a case where 1 is an integer of 2 or more, a plurality of A¹'s may be the same or different from each other and a plurality of D³'s may be the same or different from each other, and in a case where n is an integer of 2 or more, a plurality of D⁴'s may be the same or different from each other and a plurality of A²'s may be the same or different from each other,
p represents 0 or an integer of 1 or more, provided that, in a case where p is an integer of 2 or more, a plurality of Ar¹'s may be the same or different from each other and a plurality of D²'s may be the same or different from each other, and in a case where p is an integer of 2 or more and m is not 0, a plurality of G¹'s may be the same or different from each other and a plurality of D¹'s may be the same or different from each other, and
Ar¹ and Ar² each independently represent any aromatic ring selected from the group consisting of groups represented by Formulae (Ar-1) to (Ar-8), 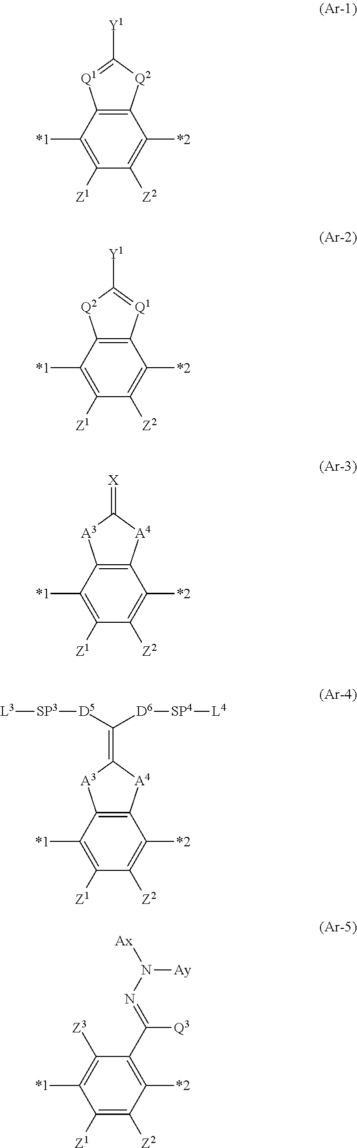 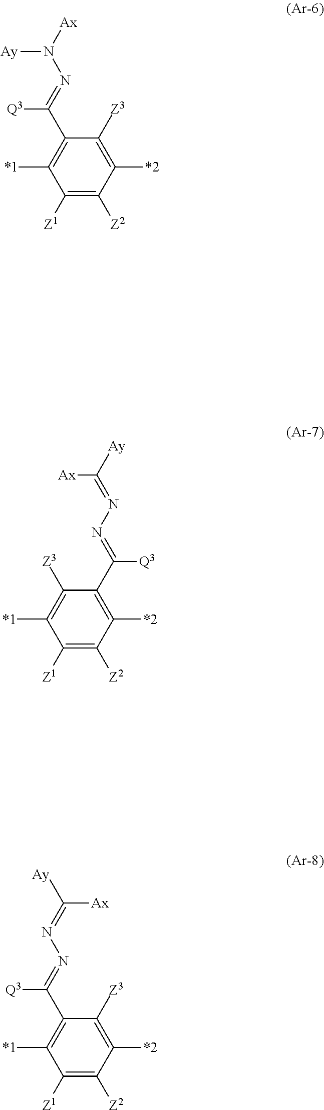
in Formulae (Ar-1) to (Ar-8),
*1 represents a bonding position to D³ or D⁴ and *2 represents a bonding position to D¹ or D², provided that, in a case where 1 is 0, the bonding position to D³ represents a bonding position to SP¹, in a case where m is 0, *2 represents the bonding position to D², and in a case where n is 0, the bonding position to D⁴ represents a bonding position to SP²,
Q¹ represents N or CH,
Q² represents —S—, —O—, or —N(R⁶)—, where R⁶ represents a hydrogen atom or an alkyl group having 1 to 6 carbon atoms,
Y¹ represents a monovalent aromatic hydrocarbon group having 6 to 12 carbon atoms, which may have a substituent, a monovalent aromatic heterocyclic group having 3 to 12 carbon atoms, which may have a substituent, or a monovalent alicyclic hydrocarbon group having 6 to 20 carbon atoms, which may have a substituent, provided that one or more of —CH₂-'s constituting the alicyclic hydrocarbon group may be replaced with —O—, —S—, or —NH—,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a monovalent aromatic heterocyclic group having 6 to 20 carbon atoms, a halogen atom, a cyano group, a nitro group, —OR⁷, —NR⁸R⁹, —SR¹⁰, —COOR¹¹, or —COR¹², where R⁷ to R¹² each independently represent a hydrogen atom or an alkyl group having 1 to 6 carbon atoms and Z¹ and Z² may be bonded to each other to form an aromatic ring,
A³ and A⁴ each independently represent a group selected from the group consisting of —O—, —N(R¹³)—, —S—, and —CO—, where R¹³ represents a hydrogen atom or a substituent,
X represents a non-metal atom of Groups 14 to 16, provided that a hydrogen atom or a substituent may be bonded to the non-metal atom,
D⁵ and D⁶ each independently represent a single bond, —CO—, —O—, —S—, —C(═S)—, —CR¹R²—, —CR³═CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms,
SP³ and SP⁴ each independently represent a single bond or a divalent aliphatic hydrocarbon group having 1 to 20 carbon atoms, provided that one or more of —CH₂-'s constituting the aliphatic hydrocarbon group may be replaced with —O—, —S—, —NH—, —N(Q)-, or —CO—, where Q represents a substituent,
L³ and L⁴ each independently represent a monovalent organic group, where at least one of L³, L⁴, or L¹ or L² in Formula (1) represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
where the aromatic rings in Ax and Ay may have a substituent, and Ax and Ay may be bonded to each other to form a ring, and
Q³ represents a hydrogen atom or an alkyl group having 1 to 20 carbon atoms, which may have a substituent, 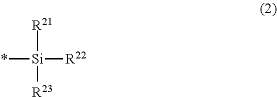
in Formula (2),
* represents a bonding position, and
R²¹, R²², and R²³ each independently represent an alkyl group, an alkenyl group, an aryl group, or an alkylene-aryl group,
$$Re ( 450 ) / Re ( 550 ) < 1. \qquad ( 3 )$$
in Expression (3),
Re(450) represents an in-plane retardation of the optically anisotropic layer at a wavelength of 450 nm, and Re(550) represents an in-plane retardation of the optically anisotropic layer at a wavelength of 550 nm.

2. The optically anisotropic layer according to claim 1,
wherein the reverse dispersion compound (I) is a liquid crystal compound.

3. The optically anisotropic layer according to claim 1,
wherein a surface free energy is 35 mN/m or less.

4. The optically anisotropic layer according to claim 1,
wherein a surface free energy is 24 mN/m or more.

5. The optically anisotropic layer according to claim 1,
wherein, in a case where a solution containing 0.08% by mass of the surfactant (II) and containing cyclopentanone and methyl ethyl ketone with a mass ratio of 4:1 is prepared, the surfactant (II) is a surfactant with which a surface tension of the solution is 22 mN/m or more.

6. The optically anisotropic layer according to claim 5,
wherein the surfactant (II) is a surfactant with which the surface tension of the solution is 30 mN/m or less.

7. The optically anisotropic layer according to claim 6,
wherein the surfactant (II) is a surfactant with which the surface tension of the solution is 27 mN/m or less.

8. The optically anisotropic layer according to claim 1,
wherein the surfactant (II) has a structure represented by Formula (4), 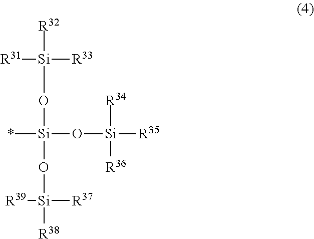
in Formula (4),
* represents a bonding position, and
R³¹ to R³⁹ each independently represent an alkyl group, an alkenyl group, an aryl group, or an alkylene-aryl group.

9. The optically anisotropic layer according to claim 1,
wherein the surfactant (II) has a structure represented by Formula (5), 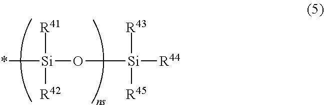
in Formula (5),
* represents a bonding position,
R⁴¹ to R⁴⁵ each independently represent an alkyl group, an alkenyl group, an aryl group, or an alkylene-aryl group, and
ns represents an integer of 1 to 15, provided that, in a case where ns is an integer of 2 to 15, a plurality of R⁴¹'s may be the same or different from each other and a plurality of R⁴²'s may be the same or different from each other.

10. The optically anisotropic layer according to claim 1,
wherein, in a case where a value obtained by multiplying a solubility parameter of each liquid crystal compound by a content of each liquid crystal compound, and performing a weighted average of all liquid crystal compounds contained in the liquid crystal composition is defined as a solubility parameter of a liquid crystal mixture,
a relative energy difference of a solubility parameter of the surfactant (II) with respect to the solubility parameter of the liquid crystal mixture is 6 or more and 12 or less,
here, the relative energy difference means a distance between the solubility parameter of the surfactant (II) and the solubility parameter of the liquid crystal mixture.

11. The optically anisotropic layer according to claim 1,
wherein the surfactant (II) is a polymer which contains a repeating unit A having the structure of Formula (2).

12. The optically anisotropic layer according to claim 11,
wherein the repeating unit A is a repeating unit having a structure represented by Formula (6), 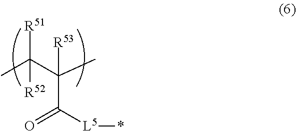
in Formula (6),
* represents a bonding position,
R⁵¹ and R¹² each independently represent a hydrogen atom or an alkyl group,
R⁵³ represents a hydrogen atom or a substituent, and
L⁵ represents —O— or —NR^{Z}—, where R^{Z} represents a hydrogen atom or a substituent.

13. The optically anisotropic layer according to claim 11,
wherein the surfactant (II) is a polymer which contains the repeating unit A at a proportion of 40% by mass or more and 90% by mass or less.

14. The optically anisotropic layer according to claim 11,
wherein the surfactant (II) is a polymer having a weight-average molecular weight of 15,000 or less.

15. The optically anisotropic layer according to claim 10,
wherein the surfactant (II) is a polymer which contains a repeating unit A having the structure of Formula (2) and a repeating unit B not having the structure of Formula (2), and
a relative energy difference of a solubility parameter of a monomer of the repeating unit B with respect to the solubility parameter of the liquid crystal mixture is 3 or more and 7 or less,
here, the relative energy difference means a distance between the solubility parameter of the monomer of the repeating unit B and the solubility parameter of the liquid crystal mixture.

16. The optically anisotropic layer according to claim 11,
wherein the surfactant (II) is a polymer which contains the repeating unit A and a repeating unit B not having the structure of Formula (2), and the repeating unit B is a repeating unit containing a functional group which reacts with light or heat to form a crosslink.

17. The optically anisotropic layer according to claim 11,
wherein the surfactant (II) is a polymer containing two or more kinds of the repeating units A having different structures.

18. The optically anisotropic layer according to claim 1,
wherein the optically anisotropic layer contains two or more kinds of the surfactants (II) having different structures.

19. The optically anisotropic layer according to claim 1,
wherein a content of the surfactant (II) is 0.1 parts by mass or less with respect to 100 parts by mass of the liquid crystal compound,
here, in a case where the reverse dispersion compound (I) is a liquid crystal compound, the “100 parts by mass of the liquid crystal compound” as a reference of the content of the surfactant (II) is 100 parts by mass of a total amount of liquid crystal compounds including the reverse dispersion compound (I).

20. The optically anisotropic layer according to claim 1,
wherein Ar¹ and Ar² in Formula (1) each independently represent any aromatic ring selected from the group consisting of the groups represented by Formulae (Ar-1), (Ar-2), and (Ar-4) to (Ar-8).

21. The optically anisotropic layer according to claim 11,
wherein Ar¹ and Ar² in Formula (1) each independently represent any aromatic ring selected from the group consisting of the groups represented by Formulae (Ar-1), (Ar-2), and (Ar-4) to (Ar-8).

22. The optically anisotropic layer according to claim 11,
wherein the surfactant (II) is a polymer which contains the repeating unit A and a repeating unit B not having the structure of Formula (2), and
the repeating unit B is a repeating unit having a structure represented by Formula (7), 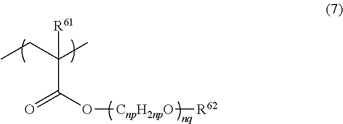
in Formula (7),
R⁶¹ represents a hydrogen atom or a methyl group,
R⁶² represents a hydrogen atom or an alkyl group having 1 to 18 carbon atoms, and
np represents an integer of 1 to 4 and nq represents an integer of 1 to 100.

23. The optically anisotropic layer according to claim 1,
wherein the liquid crystal composition further contains a solvent,
the solvent includes a high-boiling point solvent having a boiling point of 130° C. or higher, and
a content of the high-boiling point solvent is 150 parts by mass or more with respect to 100 parts by mass of the liquid crystal compound,
here, in a case where the reverse dispersion compound (I) is a liquid crystal compound, the “100 parts by mass of the liquid crystal compound” as a reference of the content of the high-boiling point solvent is 100 parts by mass of a total amount of liquid crystal compounds including the reverse dispersion compound (I).

24. The optically anisotropic layer according to claim 11,
wherein the liquid crystal composition further contains a solvent,
the solvent includes a high-boiling point solvent having a boiling point of 130° C. or higher, and
a content of the high-boiling point solvent is 150 parts by mass or more with respect to 100 parts by mass of the liquid crystal compound,
here, in a case where the reverse dispersion compound (I) is a liquid crystal compound, the “100 parts by mass of the liquid crystal compound” as a reference of the content of the high-boiling point solvent is 100 parts by mass of a total amount of liquid crystal compounds including the reverse dispersion compound (I).

25. An optical film comprising:
the optically anisotropic layer according to claim 1.

26. A polarizing plate comprising:
the optically anisotropic layer according to claim 1; and
a polarizer.

27. The polarizing plate according to claim 26, further comprising:
a positive C-plate.

28. An image display device comprising:
the optically anisotropic layer according to claim 1.

29. A liquid crystal composition comprising:
a reverse dispersion compound (I) represented by Formula (1);
at least one liquid crystal compound; and
a surfactant (II) having a structure represented by Formula (2) in a molecule, 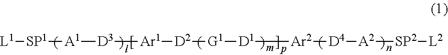
in Formula (1),
D¹, D², D³, and D⁴ each independently represent a single bond, —CO—, —O—, —S—, —C(═S)—, —CR¹R²—, —CR³═CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms,
G¹ represents A^{G} or SP^{G},
A¹, A², and A^{G} each independently represent an aromatic hydrocarbon ring which may have a substituent, an aromatic heterocyclic ring which may have a substituent, or a divalent alicyclic hydrocarbon group which may have a substituent, provided that one or more of —CH₂-'s constituting the alicyclic hydrocarbon group may be replaced with —O—, —S—, or —NH—,
SP¹, SP², and SP^{G} each independently represent a single bond or a divalent aliphatic hydrocarbon group having 1 to 20 carbon atoms, provided that one or more of —CH₂-'s constituting the aliphatic hydrocarbon group may be replaced with —O—, —S—, —NH—, —N(Q)-, or —CO—, where Q represents a substituent,
L¹ and L² each independently represent a monovalent organic group, where at least one of L¹ or L² represents a polymerizable group, provided that, in a case where at least one of Ar¹ or Ar² is an aromatic ring represented by Formula (Ar-4), at least one of L¹, L², or L³ or L⁴ in Formula (Ar-4) represents a polymerizable group,
m represents an integer of 0 to 2, provided that, in a case where m is 2, a plurality of G¹'s may be the same or different from each other and a plurality of D's may be the same or different from each other,
1 and n each independently represent 0 or an integer of 1 or more, provided that, in a case where 1 is an integer of 2 or more, a plurality of A¹'s may be the same or different from each other and a plurality of D³'s may be the same or different from each other, and in a case where n is an integer of 2 or more, a plurality of D⁴'s may be the same or different from each other and a plurality of A²'s may be the same or different from each other,
p represents 0 or an integer of 1 or more, provided that, in a case where p is an integer of 2 or more, a plurality of Ar¹'s may be the same or different from each other and a plurality of D²'s may be the same or different from each other, and in a case where p is an integer of 2 or more and m is not 0, a plurality of G's may be the same or different from each other and a plurality of D¹'s may be the same or different from each other, and
Ar¹ and Ar² each independently represent any aromatic ring selected from the group consisting of groups represented by Formulae (Ar-1) to (Ar-8), 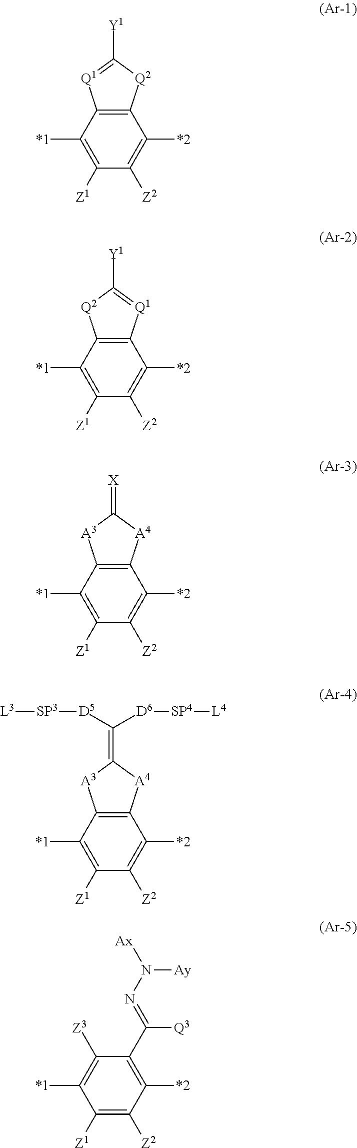 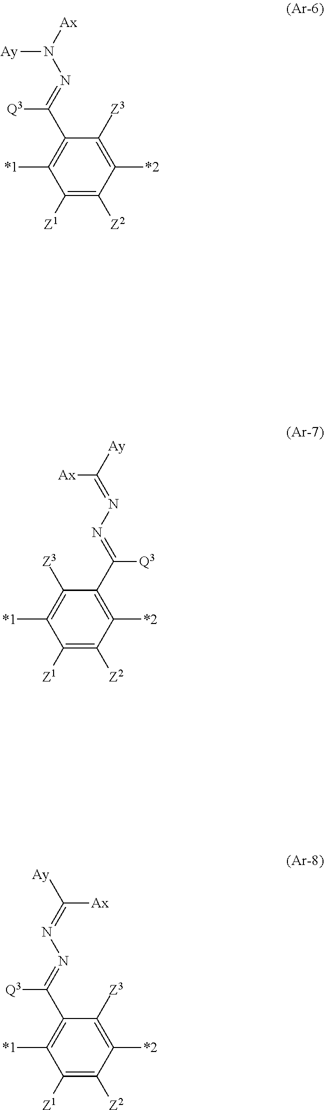
in Formulae (Ar-1) to (Ar-8),
*1 represents a bonding position to D³ or D⁴ and *2 represents a bonding position to D¹ or D², provided that, in a case where 1 is 0, the bonding position to D³ represents a bonding position to SP¹, in a case where m is 0, *2 represents the bonding position to D², and in a case where n is 0, the bonding position to D⁴ represents a bonding position to SP²,
Q¹ represents N or CH,
Q² represents —S—, —O—, or —N(R⁶)—, where R⁶ represents a hydrogen atom or an alkyl group having 1 to 6 carbon atoms,
Y¹ represents a monovalent aromatic hydrocarbon group having 6 to 12 carbon atoms, which may have a substituent, a monovalent aromatic heterocyclic group having 3 to 12 carbon atoms, which may have a substituent, or a monovalent alicyclic hydrocarbon group having 6 to 20 carbon atoms, which may have a substituent, provided that one or more of —CH₂-'s constituting the alicyclic hydrocarbon group may be replaced with —O—, —S—, or —NH—,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a monovalent aromatic heterocyclic group having 6 to 20 carbon atoms, a halogen atom, a cyano group, a nitro group, —OR⁷, —NR⁸R⁹, —SR¹⁰, —COOR¹¹, or —COR¹², where R⁷ to R¹² each independently represent a hydrogen atom or an alkyl group having 1 to 6 carbon atoms and Z¹ and Z² may be bonded to each other to form an aromatic ring,
A³ and A⁴ each independently represent a group selected from the group consisting of —O—, —N(R¹³)—, —S—, and —CO—, where R¹³ represents a hydrogen atom or a substituent,
X represents a non-metal atom of Groups 14 to 16, provided that a hydrogen atom or a substituent may be bonded to the non-metal atom,
D⁵ and D⁶ each independently represent a single bond, —CO—, —O—, —S—, —C(═S)—, —CR¹R²—, —CR³=CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms,
SP³ and SP⁴ each independently represent a single bond or a divalent aliphatic hydrocarbon group having 1 to 20 carbon atoms, provided that one or more of —CH₂-'s constituting the aliphatic hydrocarbon group may be replaced with —O—, —S—, —NH—, —N(Q)-, or —CO—, where Q represents a substituent,
L³ and L⁴ each independently represent a monovalent organic group, where at least one of L³, L⁴, or L¹ or L² in Formula (1) represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
where the aromatic rings in Ax and Ay may have a substituent, and Ax and Ay may be bonded to each other to form a ring, and
Q³ represents a hydrogen atom or an alkyl group having 1 to 20 carbon atoms, which may have a substituent, 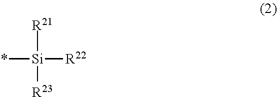
in Formula (2),
* represents a bonding position, and
R²¹, R²², and R²³ each independently represent an alkyl group, an alkenyl group, an aryl group, or an alkylene-aryl group.

30. The liquid crystal composition according to claim 29,
wherein a content of the surfactant (II) is 0.1 parts by mass or less with respect to 100 parts by mass of the liquid crystal compound,
here, in a case where the reverse dispersion compound (I) is a liquid crystal compound, the “100 parts by mass of the liquid crystal compound” as a reference of the content of the surfactant (II) is 100 parts by mass of a total amount of liquid crystal compounds including the reverse dispersion compound (I).

31. The liquid crystal composition according to claim 29,
wherein Ar¹ and Ar² in Formula (1) each independently represent any aromatic ring selected from the group consisting of the groups represented by Formulae (Ar-1), (Ar-2), and (Ar-4) to (Ar-8).

32. The liquid crystal composition according to claim 29,
wherein the surfactant (II) is a polymer which contains the repeating unit A and a repeating unit B not having the structure of Formula (2), and
the repeating unit B is a repeating unit having a structure represented by Formula (7), 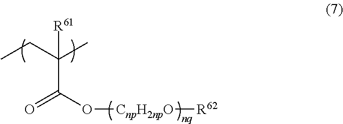
in Formula (7),
R⁶¹ represents a hydrogen atom or a methyl group,
R⁶² represents a hydrogen atom or an alkyl group having 1 to 18 carbon atoms, and
np represents an integer of 1 to 4 and nq represents an integer of 1 to 100.

33. The liquid crystal composition according to claim 29, further comprising:
a solvent,
wherein the solvent includes a high-boiling point solvent having a boiling point of 130° C. or higher, and
a content of the high-boiling point solvent is 150 parts by mass or more with respect to 100 parts by mass of the liquid crystal compound,
here, in a case where the reverse dispersion compound (I) is a liquid crystal compound, the “100 parts by mass of the liquid crystal compound” as a reference of the content of the high-boiling point solvent is 100 parts by mass of a total amount of liquid crystal compounds including the reverse dispersion compound (I).
